(19) United States
(12) Patent Application Publication
(10) Pub. No.: US 2004/0039555 A1
(43) Pub. Date: Feb. 26, 2004

(54) System and method for stochastic simulation of nonlinear dynamic systems with a high degree of freedom for soft computing applications

(76) Inventors: Sergei V. Ulyanov, Crema (IT); Sergei Panfilov, Crema (IT)

Correspondence Address: KNOBBE MARTENS OLSON & BEAR LLP, 2040 MAIN STREET, FOURTEENTH FLOOR, IRVINE, CA, 92614, US

(21) Appl. No.: 10/209,636

(22) Filed: Jul. 30, 2002

(51) Int. Cl. G06F 17/10

(52) U.S. Cl. 703/2

(57) ABSTRACT

A system and method for efficient stochastic simulation of dynamic systems is described. Since analytic solutions cannot usually be found for stochastic differential equations, complete analysis requires numerical simulations. These simulations are most commonly done with first-order Euler-type algorithm. The efficiency of these algorithms is improved by removing algebraic loops in the simulation. An algebraic loop occurs when an output variable of the system of equations is also in an input variable to one or more of the equations describing the system. In one embodiment, the algebraic loops are removed by formulating a simulation wherein an output variable that gives rise to an algebraic loop is integrated to produce an integrated output. The integrated output is later provided to a differentiator to reconstruct the output variable as needed.

### BACKGROUND

1. Field of the Invention

The disclosed invention is relates generally to stochastic simulation of nonlinear dynamic systems with variable stochastic structure.

2. Description of the Related Art

Numerical evaluation and simulation of nonlinear dynamic systems of differential equations are typically based on the method of Euler or on Runge-Kutta methods. These methods use local algebraic loops, and in practice they require additional time for integration. The temporal complexity of such integrations depends greatly on the following factors: 1) number of degrees of freedom in the dynamic system; 2) the types of non-linearity exhibited by the dynamic system and the structure of the non-linearities; and 3) the type of stochastic excitation. The accuracy of the calculated results depends on the order of the integration routine and on the settings of integration error tolerances.

The first two factors listed above define the strategy used for numerical simulations of real nonlinear dynamic systems. The standard method of decreasing the order of these nonlinear equations usually exhibits high temporal complexity, and additional requirements for integration constraints. Necessary conditions for integration accuracy also typically add additional temporal complexity and thus additional computing resources.

Since analytic solutions usually cannot be found for stochastic differential equations, complete analysis requires numerical simulations. These numerical simulations are most commonly done with a first-order Euler-type algorithm.

Feedback control systems are widely used to maintain the output of a nonlinear dynamic system at a desired value in spite of external disturbances that would displace the dynamic system from the desired value. For example, a household space-heating furnace, controlled by a thermostat, is an example of a feedback control system. The thermostat continuously measures the air temperature inside the house, and when the temperature falls below a desired minimum temperature the thermostat turns the furnace on. When the interior temperature reaches the desired minimum temperature, the thermostat turns the furnace off. The thermostat-furnace system maintains the household temperature at a substantially constant value in spite of external disturbances such as a drop in the outside temperature. Similar types of feedback controls are used in many applications.

A central component in a feedback control system is a controlled object, a machine, or a process that can be defined as a “plant”, having an output variable or performance characteristic to be controlled. In the above example, the “plant” is the house, the output variable is the interior air temperature in the house and the disturbance is the flow of heat (dispersion) through the walls of the house. The plant is controlled by a control system. In the above example, the control system is the thermostat in combination with the furnace. The thermostat-furnace system uses simple on-off feedback control system to maintain the temperature of the house. In many control environments, such as motor shaft position or motor speed control systems, simple on-off feedback control is insufficient. More advanced control systems rely on combinations of proportional feedback control, integral feedback control, and derivative feedback control. A feedback control based on a sum of proportional feedback, plus integral feedback, plus derivative feedback, is often referred as PID control.

A PID control system is a linear control system that is based on a dynamic model of the plant. In classical control systems, a linear dynamic model is obtained in the form of dynamic equations, usually ordinary differential equations. The plant is assumed to be relatively linear, time invariant, and stable. However, many real-world plants are time-varying, highly non-linear, and unstable. For example, the dynamic model may contain parameters (e.g., masses, inductance, aerodynamics coefficients, etc.), which are either only approximately known or depend on a changing environment. If the parameter variation is small and the dynamic model is stable, then the PID controller may be satisfactory. However, if the parameter variation is large or if the dynamic model is unstable, then it is common to add adaptive or intelligent (AI) control functions to the PID control system.

AI control systems use an optimizer, typically a non-linear optimizer, to program the operation of the PID controller and thereby improve the overall operation of the control system.

Classical advanced control theory is based on the assumption that near of equilibrium points all controlled “plants” can be approximated as linear systems. Unfortunately, this assumption is rarely true in the real world. Most plants are highly nonlinear, and often do not have simple control algorithms. In order to meet these needs for a nonlinear control, systems have been developed that use soft computing concepts such as genetic algorithms, fuzzy neural networks, fuzzy controllers and the like. By these techniques, the control system evolves (changes) over time to adapt itself to changes that may occur in the controlled “plant” and/or in the operating environment.

As discussed above, the existence of algebraic loops in the simulation of dynamic systems increases the temporal complexity of the simulation and thus the computing resources needed for the simulation.

### SUMMARY

The present invention solves these and other problems by removing algebraic loops from the simulation of dynamic systems. An algebraic loop occurs when an output variable of the system of equations describing the system is also in an input variable to one or more of the equations in the system of equations. In one embodiment, the algebraic loops are removed by formulating a simulation wherein an output variable that gives rise to an algebraic loop is integrated to produce an integrated output. The integrated output is later provided to a differentiator to reconstruct the output variable as needed. Thus, the output variable that would otherwise give rise to an algebraic loop is not fed back directly into the system of equtions, but, rather, is first integrated and then differentiated before being fed back into the system of euqations. The process of integration followed by differentiation removes the algebraic loop and thereby speeds up the simulation. When more than one output variable gives rise to an algebraic loop, each output variable giving rise to an algebraic loop is first integrated and then differentiated before being fed back into the system of equations, thereby removing all potential algebraic loops from the simulation.

### BRIEF DESCRIPTION OF THE FIGURES

The above and other aspects, features, and advantages of the present invention will be more apparent from the following description thereof presented in connection with the following drawings.

FIG. 1 illustrates a general structure of a self-organizing intelligent control system based on soft computing.

FIG. 2A is a block diagram of a simulation system, with algebraic loops, for solving a system of non-linear differential equations.

FIG. 2B is a block diagram of a simulation system, without algebraic loops, for solving a system of non-linear differential equations.

FIG. 3A is a block diagram of a system with an algebraic loop for simulating a dynamic system.

FIG. 3B shows the algebraic loop of the system shown in FIG. 3A.

FIG. 4 is a block diagram of the system in FIG. 3A with the algebraic loop removed.

FIG. 5 is a plot showing computer runtimes for the simulations of FIGS. 3A and 4 for free, exited, and controlled simulations, and showing the improvement obtained by removing the algebraic loop.

FIG. 6 is a block diagram of a dynamic simulation system with an algebraic loop and a control feedback loop.

FIG. 7 is a block diagram of the dynamic simulation system in FIG. 6 with the algebraic loop removed.

FIG. 8 shows a full car model of a suspension system.

FIG. 9A is a plot showing computer runtimes and improvement of the simulation speed for the suspension system model with fixed damping.

FIG. 9B is a plot showing computer runtimes and improvement of the simulation speed for the suspension system model with variable damping.

FIG. 10 shows the components and coordinate systems of a unicycle model.

FIG. 11 is a representative plot showing comparison of the alpha angle for a simulation based on the above unicycle equations of motion for simulations with and without algebraic loops.

FIG. 12 is a representative plot showing comparison of the beta angle for a simulation based on the above unicycle equations of motion for simulations with and without algebraic loops.

FIG. 13 is a representative plot showing comparison of the gamma angle for a simulation based on the above unicycle equations of motion for simulations with and without algebraic loops.

FIG. 14 shows results of non-gaussian colored stochastic process generation using a filter with algebraic loops.

FIG. 15 shows results of non-gaussian colored stochastic process generation using a filter without algebraic loops.

FIG. 16 shows phase portraits of generated stochastic processes and the relation between outputs of different filters.

FIG. 17 shows temporal complexity estimation of the stochastic process generation.

In the drawings, the first digit of any three-digit element reference number generally indicates the number of the figure in which the referenced element first appears and the first two digits of any four-digit element reference number generally indicates the number of the figure in which the referenced element first appears.

### DESCRIPTION

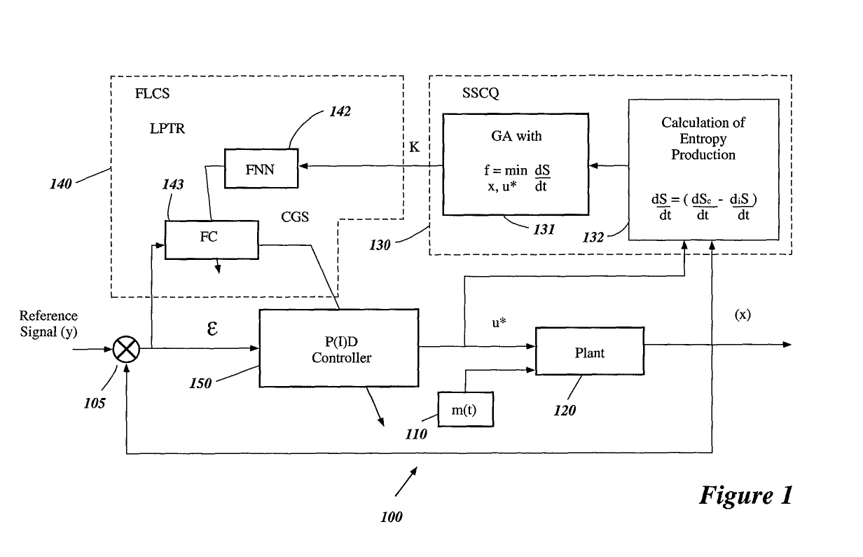

FIG. 1 is a block diagram of a control system 100 for controlling a plant based on soft computing. In the controller 100, a reference signal y is provided to a first input of an adder 105. An output of the adder 105 is an error signal ε, which is provided to an input of a Fuzzy Controller (FC) 143 and to an input of a Proportional-Integral-Differential (PID) controller 150. An output of the PID controller 150 is a control signal u*, which is provided to a control input of a plant 120 and to a first input of an entropy-calculation module 132. A disturbance m(t) 110 is also provided to an input of the plant 120. An output of the plant 120 is a response x, which is provided to a second input the entropy-calculation module 132 and to a second input of the adder 105. The second input of the adder 105 is negated such that the output of the adder 105 (the error signal c) is the value of the first input minus the value of the second input.

An output of the entropy-calculation module 132 is provided as a fitness function to a Genetic Analyzer (GA) 131. An output solution from the GA 131 is provided to an input of a FNN 142. An output of the FNN 132 is provided as a knowledge base to the FC 143. An output of the FC 143 is provided as a gain schedule to the PID controller 150.

The GA 131 and the entropy calculation module 132 are part of a Simulation System of Control Quality (SSCQ) 130. The FNN 142 and the FC 143 are part of a Fuzzy Logic Classifier System (FLCS) 140.

Using a set of inputs, and the fitness function 132, the genetic algorithm 131 works in a manner similar to a biological evolutionary process to arrive at a solution which is, hopefully, optimal. The genetic algorithm 131 generates sets of “chromosomes” (that is, possible solutions) and then sorts the chromosomes by evaluating each solution using the fitness function 132. The fitness function 132 determines where each solution ranks on a fitness scale. Chromosomes (solutions) that are relatively more fit are those chromosomes that correspond to solutions that rate high on the fitness scale. Chromosomes that are relatively less fit are those chromosomes that correspond to solutions that rate low on the fitness scale.

Chromosomes that are more fit are kept (survive) and chromosomes that are less fit are discarded (die). New chromosomes are created to replace the discarded chromosomes. The new chromosomes are created by crossing pieces of existing chromosomes and by introducing mutations.

The PID controller 150 has a linear transfer function and thus is based upon a linearized equation of motion for the controlled “plant” 120. Prior art genetic algorithms used to program PID controllers typically use simple fitness and thus do not solve the problem of poor controllability typically seen in linearization models. As is the case with most optimizers, the success or failure of the optimization often ultimately depends on the selection of the performance (fitness) function.

Evaluating the motion characteristics of a nonlinear plant is often difficult, in part due to the lack of a general analysis method. Conventionally, when controlling a plant with nonlinear motion characteristics, it is common to find certain equilibrium points of the plant and the motion characteristics of the plant are linearized in a vicinity near an equilibrium point. Control is then based on evaluating the pseudo (linearized) motion characteristics near the equilibrium point. This technique is scarcely, if at all, effective for plants described by models that are unstable or dissipative.

Computation of optimal control based on soft computing includes the GA 131 as the first step of a global search for an optimal solution from a space of positive solutions. The GA searches for a set of control weights for the plant. Firstly the weight vector K={k₁, . . . , kₙ,} is used by a conventional proportional-integral-differential (PID) controller 150 in the generation of a signal u*=δ(K)which is applied to the plant. The entropy S(δ(K)) associated with the behavior of the plant 120 on this signal is used as a fitness function by the GA 131 to produce a solution that reduces entropy production. The GA 131 is repeated several times at regular time intervals in order to produce a set of weight vectors K. The vectors K generated by the GA 131 are then provided to the FNN 142 and the output of the FNN 142 to the fuzzy controller 143. The output of the fuzzy controller 143 is a collection of gain schedules for the PID controller 150 that controls the plant. For the soft computing system 100 based on a genetic analyzer, there is very often no real control law in the classical control sense, but rather, control is based on a physical control law such as minimum entropy production.

For purposes of simulation, the plant 120 can be modeled as a system of non-linear stochastic differential equations. Since analytic solutions cannot be found for stochastic differential equations, complete analysis requires numerical simulations. These simulations are most commonly done with first-order Euler-type algorithm. For higher accuracy, the method of extended Runge-Kutta algorithms, are sometimes used. These extensions are developed first for white noise equations and then in general form for colored noise equations. For stochastic simulations of non-linear dynamic systems with hidden higher order derivatives in non-linear terms, these methods possess high temporal complexity. The method of forming filters for stochastic process simulations based on Fokker-Planck-Kolmogorov equations and modified integration method, possesses smaller temporal complexity for calculation than standard methods.

Computation of optimal control based on soft computing includes using the GA 131 to provide a search for an optimal solution based on a fixed space of positive solutions. The GA searches for a set of control weights for the plant. The weight vector K={k₁, . . . , kₙ} is used by a conventional proportional-integral-differential (PID) controller 150 in the generation of a signal δ(K), which is applied to the plant. The entropy S(δ(K)) associated with the behavior of the plant on this signal is assumed as a fitness function to minimize. The GA is repeated several times at regular time intervals in order to produce the set of weight vectors.

Genetic algorithms are usually computationally expensive search procedures, requiring many calculations of the fitness function. As described above, the fitness function depends on the results of the output of the controlled object (i.e., the plant). The controlled object can be a nonlinear and even an unstable nonlinear dynamic system. Such dynamic systems are usually described as systems of second order differential equations of the following form:

$$\{ \begin{matrix}{\ddot{q}}_{1} = {f}_{1} ( {q}_{1} , {\dot{q}}_{1} , {\ddot{q}}_{1} , … , {q}_{i} , {\dot{q}}_{i} , {\ddot{q}}_{i} , … , {\ddot{q}}_{N} , {ξ}_{1} , {u}_{1} , t ) \\ ⋮ \\ {\ddot{q}}_{1} = {f}_{i} ( {q}_{1} , {\dot{q}}_{1} , {\ddot{q}}_{1} , … , {q}_{i} , {\dot{q}}_{i} , {\ddot{q}}_{i} , … , {\ddot{q}}_{N} , {ξ}_{i} , {u}_{i} , t ) \\ ⋮ \\ {\ddot{q}}_{n} = {f}_{n} ( {q}_{1} , {\dot{q}}_{1} , {\ddot{q}}_{1} , … , {q}_{i} , {\dot{q}}_{i} , {\ddot{q}}_{i} , … , {\ddot{q}}_{N} , {ξ}_{N} , {u}_{N} , t )\end{matrix} , \qquad ( 1 )$$

Where q, are generalized coordinates of the system, \dot{q}₁ are generalized velocities, \ddot{q}ᵢ are generalized accelerations, fᵢ are equations of motions, ξᵢ are stochastic excitations, uᵢ are control forces, (i=1, . . . , n) and t is the time scale. To find a numerical solution of such a system of differential equations, the equations are usually transformed into a set of n×2 first order differential equations via replacement of the variables. For example in the case when n=1 the system of equations becomes:

\ddot{q}=f(q,\dot{q},\ddot{q},ξ,u,t) (2)

By replacing the variables (2) is transformed into:

$$\{ \begin{matrix}{\dot{q}}_{1} = {q}_{2} \\ {\dot{q}}_{2} = f ( {q}_{1} , {\dot{q}}_{1} , {q}_{2} , {\dot{q}}_{2} , ξ , u , t )\end{matrix} \qquad ( 3 )$$

The Equations (1), (2), or (3) can be solved numerically by using the Euler method. The formula for the Euler method is:

yₙ₊₁=yₙhf(xₙ,yₙ)

which advances a solution from xₙ to xₙ₊₁=x_{f}+h. The formula is unsymmetrical in that it advances the solution through an interval h, but uses derivative information only at the beginning of that interval. That means that the step's error is only one power of h smaller than the correction. In some circumstances the method of Euler is less accurate when compared to other methods running at the same step size, and the method can be unstable.

In contrast, to the first-order Euler method, the second (and higher)-order Runge-Kutta methods use symmetrization to cancel out the first-order error term, thus improving the accuracy of the solution for a given step size. The second-order Runge-Kutta algorithm is:

$$\begin{matrix}{k}_{1} = h ( f ( {x}_{n} , {y}_{n} ) \\ {k}_{2} = h f ( {x}_{n} + \frac{1}{2} h , {y}_{n} + \frac{1}{2} {k}_{1} ) \\ {y}_{n + 1} = {y}_{n} + {k}_{2} + O ( {h}^{3} )\end{matrix}$$

and the fourth-order Runge-Kutta algorithm is:

$$\begin{matrix}{k}_{1} = h ( f ( {x}_{n} , {y}_{n} ) \\ {k}_{2} = h f ( {x}_{n} + \frac{1}{2} h , {y}_{n} + \frac{1}{2} {k}_{1} ) \\ {k}_{3} = h f ( {x}_{n} + \frac{1}{2} h , {y}_{n} + \frac{1}{2} {k}_{2} \\ {k}_{4} = h f ( {x}_{n} + \frac{1}{2} h , {y}_{n} + {k}_{3} ) \\ {y}_{n + 1} = {y}_{n} + \frac{{k}_{1}}{6} + \frac{{k}_{2}}{3} + \frac{{k}_{3}}{3} + \frac{{k}_{4}}{6} + O ( {h}^{5} )\end{matrix}$$

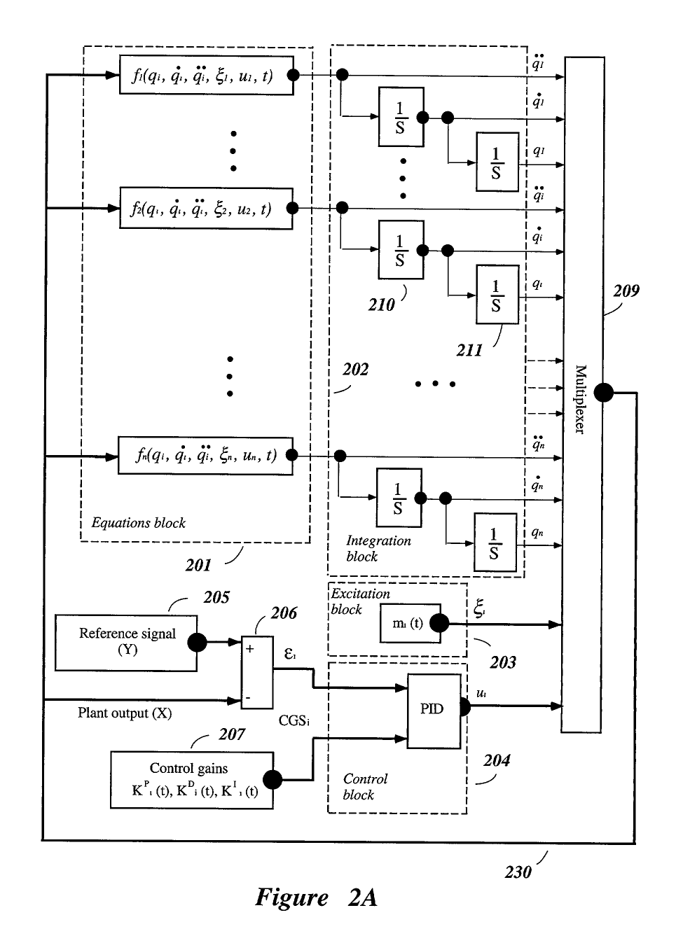

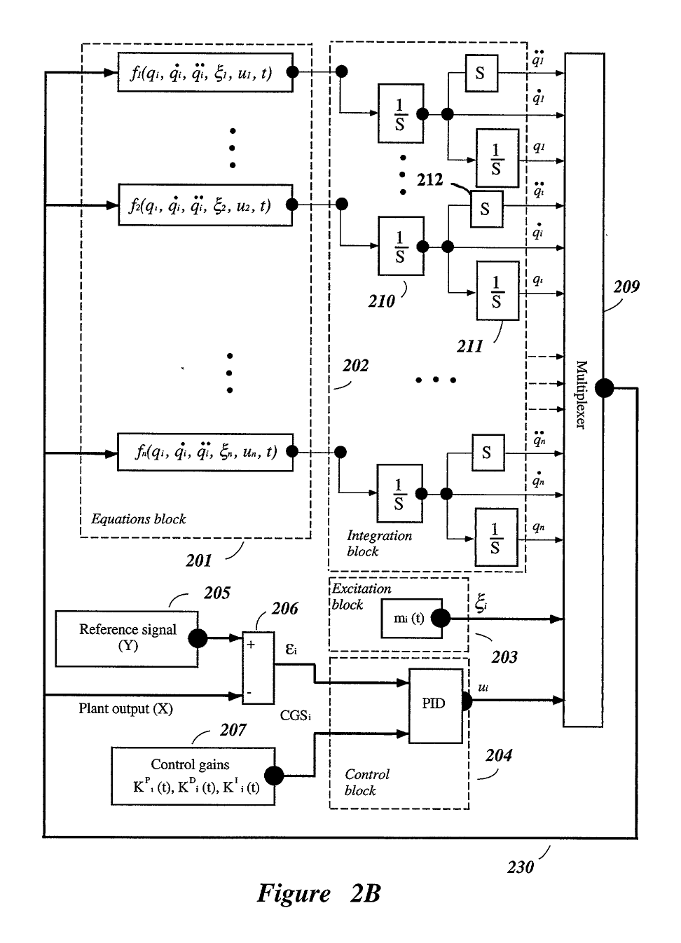

A number of numerical simulation programs, such as, for example, Simulink®, can integrate the dynamic systems presented in Equations (1), (2), and (3). For numerical simulation it is easier to present the system of Equation (1) as an analog computing diagram as shown in FIG. 2A. In FIG. 2A, the system of equations (e.g. as shown in Equation (2)) is provided by an equations block 201. Outputs from the equations block 201 are provided to an integration block 202, which provides multiple levels of integration of the output from the equations block 201. For example, an output signal \ddot{q}ᵢ from the equations block 201, is provided to a \ddot{q}ᵢ input of the integration block 202. In the integration block 202, the signal \ddot{q}ᵢ is provided as an output of the integration block 202 (that is, as an un-integrated output to a multiplexer 209), and to an input of an integrator 210. An output signal \dot{q}ᵢ of the integrator 210 is provided to an input of an integrator 211, and as an output of the integration block 202. An output signal qᵢ of the integrator 211 is provided as an output of the integration block 202.

Outputs of the integration block 202 are provided to inputs of the multiplexer 209. An output ξᵢ from an excitation block 203 is provided to an excitation input of the multiplexer 209. A control output uᵢ from a Proportional Integral-Differential (PID) control block 204 is provided to a control input of the multiplexer 209. An output bus 230 from the multiplexer includes the signals \ddot{q}ᵢ, \dot{q}ᵢ, qᵢ, and ξᵢ where i can vary from 1 to N for each variable. The output bus 230 is provided to in input of an integration control block 231. An output bus 232 from the integration control block includes the signals \ddot{q}ᵢ, \dot{q}ᵢ, qᵢ, ξᵢ, and uᵢ for a next time step in the integration. The output bus 232 also includes a time-step variable t. The output bus 232 is provided to inputs of the equations block 201. A selected signal designated as a plant output x is provided from the output bus 232 to a negative input of an adder 206. The plant output x is typically selected from the group of the signals \ddot{q}ᵢ, \dot{q}ᵢ, and qᵢ.

A reference signal block 205 generates a reference signal that is provided to a positive input of the adder 206. An output of the adder 206, is an error signal εᵢ (which is a difference between the two inputs of the adder 206). The error signal is provided to an error signal input of the PID control block 204. A gain block 207 provides control gains Kᵢ^{P}(t), Kᵢ^{I}(t), and Kᵢ^{D}(t) to a gain-schedule input of the PID control block 204. In one embodiment, the control gains are fixed gains. In one embodiment, the control gains are computed dynamically, as shown in FIG. 1 (in which case the gain block 207 can include the FLCS 140 and the SSCQ 130). If the control gains are computed dynamically, then the plant output x can also be provided to an input of the gain block 207.

The integration control 231 receives previous outputs on the bus 230 and computes the inputs for next time step in the integration. The inputs for the next time step are provided to the bus 232. Thus, it is the integration control 231 that implements the integration (i.e., solution) method (e.g., Euler, Runge-Kutta, etc.).

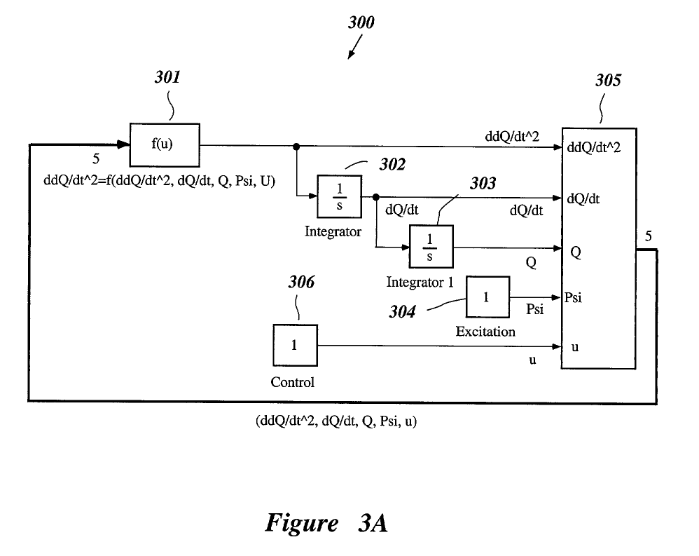

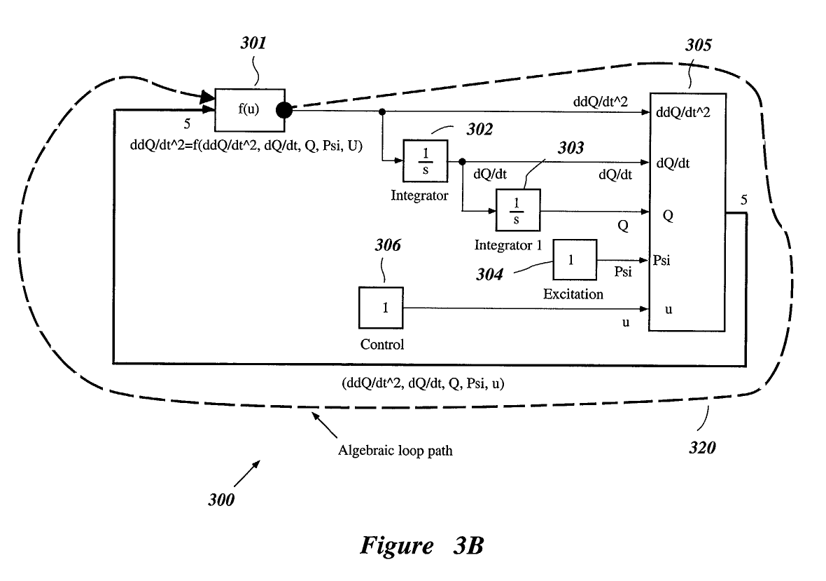

FIG. 2A shows a system with algebraic loops (as discussed in more detail in connection with FIG. 3B below). FIG. 2B shows a system to solve the same equations as the system in FIG. 2A but without the use of algebraic loops. FIG. 2B is similar in most respects to FIG. 2A except that in FIG. 2B, the signal \ddot{q}ᵢ is not provided directly as an output of the integration block 202 (that is, as an un-integrated output to the multiplexer 209). Rather, the signal \ddot{q}ᵢ, is provided to the integrator 210, and the output of the integrator 210 is provided to an input of a differentiator 212. An output of the differentiator 212, being a reconstruction of the signal \ddot{q}ᵢ, is provided as an output of the integration block 202. Thus, the signals \ddot{q}ᵢ, \dot{q}ᵢ, and qᵢ from the integration block 202 have each passed through at least one integrator in the integration block 202.

The multiplexer 209 includes logic to control the evolution of the solution process. The multiplexer 209 receives outputs from an n'th time step of the solution process and provides inputs to the (n+1)'th time step of the solution process.

FIG. 3A is a block diagram of a simulation system 300 with an algebraic loop for simulating a dynamic system. The system 300 is a single-equation version of the more general multi-equation structure shown in FIG. 2. In FIG. 3A, an equation block 301 is used to implement an equation f(\overline{u}), where \overline{u}=\ddot{q}, \dot{q}, q, ξ, t (where the subscript on q and its derivatives has been dropped since there is only one equation). In alternate notation, \overline{u}=ddQ/dt²,dQ/dt,Q,ξ,t. An output \ddot{q} from the equation block 301 is provided to a \ddot{q} input of a multiplexer 305, and to an input of an integrator 302. An output \dot{q} from the integrator 302 is provided to a \dot{q} input of the multiplexer 305 and to an input of an integrator 303. An output q from the integrator 303 is provided to a q input of the multiplexer 305. An excitation φ from an excitation generator 304 is provided to a φ input of the multiplexer 305. A control signal u from a control generator 306 is provided to a u input of the multiplexer 305. An output bus from the multiplexer is provided to an input of the equation block 301.

Calculation time for the integration of nonlinear dynamic systems depends dramatically on the presence of algebraic loops. An algebraic loop occurs when an input of the nonlinear part depends directly on an output of the nonlinear part. In most of the cases of nonlinear dynamic system simulation, an algebraic loop occurs in the terms related to via accelerations of the generalized coordinates, as shown in FIG. 3B. FIG. 3B shows an algebraic loop path 320 corresponding to the variable ddQ/dt². The variable ddQ/dt² is an output of the nonlinear dynamic function f(u), and an argument of the function f(u).

Integrating programs typically use special algebraic loop solving routines that, in addition to adding self-integration complexity to the simulation, require additional calculations of the right-hand portions of Equation (1). These additional calculations reduce the computational speed of the simulation algorithm.

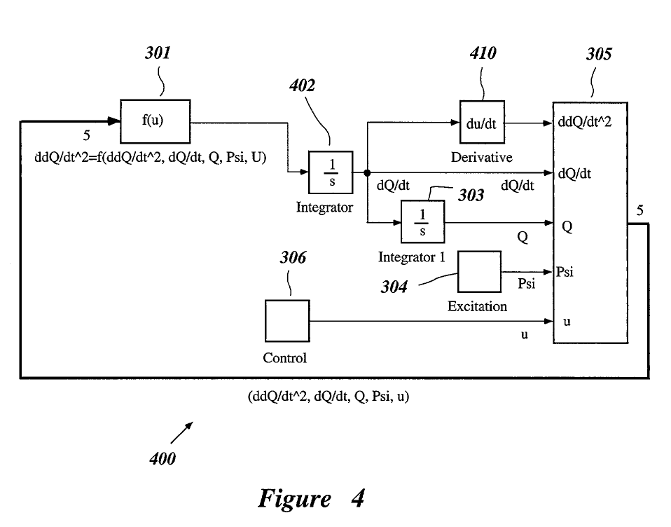

FIG. 4 shows a system 400 wherein higher order derivatives (e.g., accelerations) are not calculated directly, but replaced with the derivatives of smaller order accelerations (e.g., velocities). The system 400 of FIG. 4 eliminates the algebraic loop 320. Like the structure shown in FIG. 3A, FIG. 4 shows a single-equation version of the more general multi-equation structure shown in FIG. 2. In FIG. 4, the equation block 301 is used to implement an equation f(\overline{u}), where \overline{u}=\ddot{q}, \dot{q}, q, ξ, t (where the subscript on q and its derivatives has been dropped since there is only one equation). An output \ddot{q} from the equation block 301 is provided to an input of an integrator 402. An output \dot{q} from the integrator 402 is provided to an input of a differentiator 410, to a \dot{q} input of the multiplexer 305, and to an input of the integrator 302. An output \dot{q} from the integrator 302 is provided to an input of an integrator 303. An output q from the integrator 303 is provided to a q input of the multiplexer 305. An output \ddot{q} of the differentiator 410 is provided to \ddot{q} input of the multiplexer 305. The excitation φ from the excitation generator 304 is provided to the φ input of the multiplexer 305. A control signal u from a control generator 306 is provided to a u input of the multiplexer 305. An output bus from the multiplexer is provided to an input of the equation block 301.

The system 400 eliminates the algebraic loop by first integrating the output \ddot{q} from the equation block 301 to produce \dot{q}. The signal \ddot{q} is the recomputed (reconstructed) by using the differentiator 410.

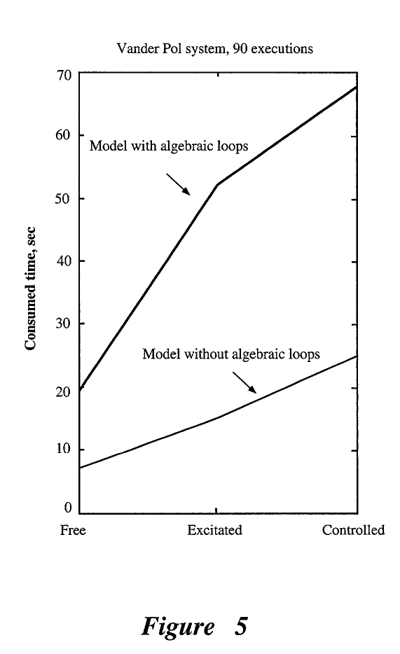

FIG. 5 is a plot showing computer runtimes for the simulations of FIGS. 3A and 4 for free, exited, and controlled simulations, and showing the improvement obtained by removing the algebraic loop. As shown in FIG. 5, the system 400 (without an algebraic loop) is more than twice as fast as the system 300 (with an algebraic loop) when both the excitation and control inputs are zero (i.e., free systems). The system 400 is approximately 3.4 times as fast as the system 300 when an excitation is applied to both systems (i.e., excited systems). The system 400 is approximately 2.7 times as fast as the system 300 when a non-zero control input is applied to both systems (i.e., controlled systems).

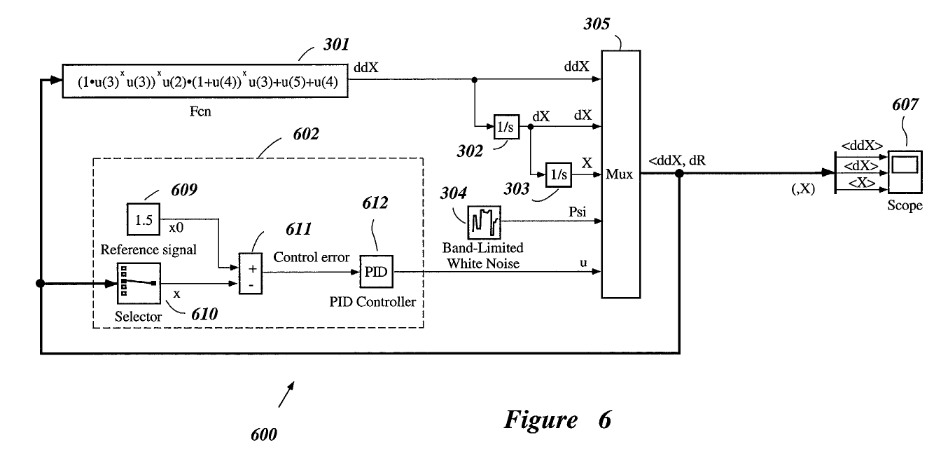

FIG. 6 is a block diagram of a dynamic simulation system 600 having an algebraic loop and including the excitation input 304 and a feedback control system 602. In the system 600, the equation block 301 is used to implement an equation f(\overline{u}), where \overline{u}=\ddot{q},\dot{q}, q,ξ, t (where the subscript on q and its derivatives has been dropped since there is only one equation). An output \ddot{q} from the equation block 301 is provided to the \ddot{q} input of a multiplexer 305, and to an input of the integrator 302. An output \dot{q} from the integrator 302 is provided to the \dot{q} input of the multiplexer 305 and to the input of the integrator 303. An output q from the integrator 303 is provided to the q input of the multiplexer 305. An excitation φ from the excitation generator 304 is provided to the φ input of the multiplexer 305.

The control system 602 includes a PID controller 612, an adder 611, a selector 610, and a reference signal generator 609. A control signal u from the PID controller 612 is provided to the u input of the multiplexer 305. An output bus from the multiplexer is provided to an input of the equation block 301 and to an input of the selector 610. An output from the selector 610 is provided to an inverting input of the adder 611. A reference signal output from the reference signal generator is provided to a non-inverting input of the adder 611. The adder provides an error signal (computed as the reference signal minus the signal selected by the selector 610) to an input of the PID controller 612.

The selector 610 is used to select one of the signals from the multiplexer bus as a feedback signal to be used by the feedback control system 602. The feedback control system computes the error signal, which is then provided to the PID controller 612 to generate the control signal u.

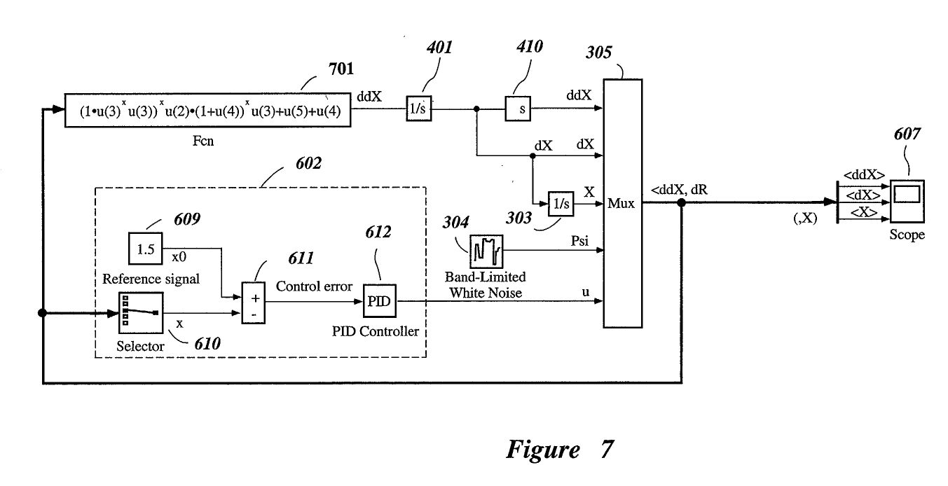

FIG. 7 is a block diagram of a dynamic simulation system 700, which is similar to the system 600 with the algebraic loop removed. In the system 700, the equation block 301 is used to implement an equation f(\overline{u}), where \overline{u}=\ddot{q}, \dot{q}, q, ξ, t (where the subscript on q and its derivatives has been dropped since there is only one equation). The output \ddot{q} from the equation block 301 is provided to the input of the integrator 402. The output \dot{q} from the integrator 402 is provided to an input of the differentiator 410, to a \dot{q} input of the multiplexer 305, and to the input of the integrator 302. The output \dot{q} from the integrator 302 is provided to the input of an integrator 303. The output q from the integrator 303 is provided to the q input of the multiplexer 305. The output \ddot{q} of the differentiator 410 is provided to the \ddot{q} input of the multiplexer 305. An excitation φ from the excitation generator 304 is provided to the φ input of the multiplexer 305. The system 700 also includes the feedback control system 602 as described in connection with FIG. 6.

In one embodiment, the systems shown in FIGS. 3A, 3B, 4, 6, and 7 can be used to model a Van der Pol dynamic system, wherein the equation block 301 implements an equation of the form:

\ddot{q}+(q²−1)\dot{q}+(1+ξ(t))q=u(t)+ξ(t)

where q is a coordinate (e.g., an x, y, or z coordinate), and ξ(t) is a random excitation. The control signal u(t) is given by:

u(t)=kₚe+k_{D}\dot{e}+k₁∫e dt

where e is the error signal computed as e=q₀−q where q₀ is the set point or reference signal. In one simulation, running the above Van der Pol system under conditions of free oscillation (e.g., ξ(t)=0, and u(t)=0) without an algebraic loop is approximately 2.8 times faster than running the simulation with an algebraic loop.

In one simulation, running the above Van der Pol system under conditions of controlled oscillations (i.e., q₀=1.5 and k_{P}=k_{D}=k₁=1) under parametric excitation, where ξ(t) is band-limited white noise having zero mean and a dispersion of 0.3,) without an algebraic loop is approximately 2.7 times faster than running the simulation with an algebraic loop.

In one embodiment, the systems shown in FIGS. 3A, 3B, 4, 6, and 7 can be used to model a nonlinear dynamic system with nonlinear inertial force simulation, wherein the equation block 301 implements an equation of the form:

\ddot{q}+a₁q²\dot{q}+a₂q³+a₃q(q\ddot{q}+\dot{q}²)+a₄\dot{q}+(1+ξ(t))q=u(t)+ξ(t)

where aᵢ, i=1, . . . , 4 are model parameters. In one simulation, a₁=0.5, a₂=0.1, a₃=0.4, and a₄=0.2. Under conditions of free oscillation, this simulation is approximately 4 times faster without algebraic loops than with algebraic loops. Under free oscillation with parametric excitation (zero mean, dispersion of 0.3) the system without algebraic loops is approximately 3.4 times faster without algebraic loops than with algebraic loops. Under PID control with parametric excitation, the simulation without algebraic loops is 3.3 times faster than the system with algebraic loops.

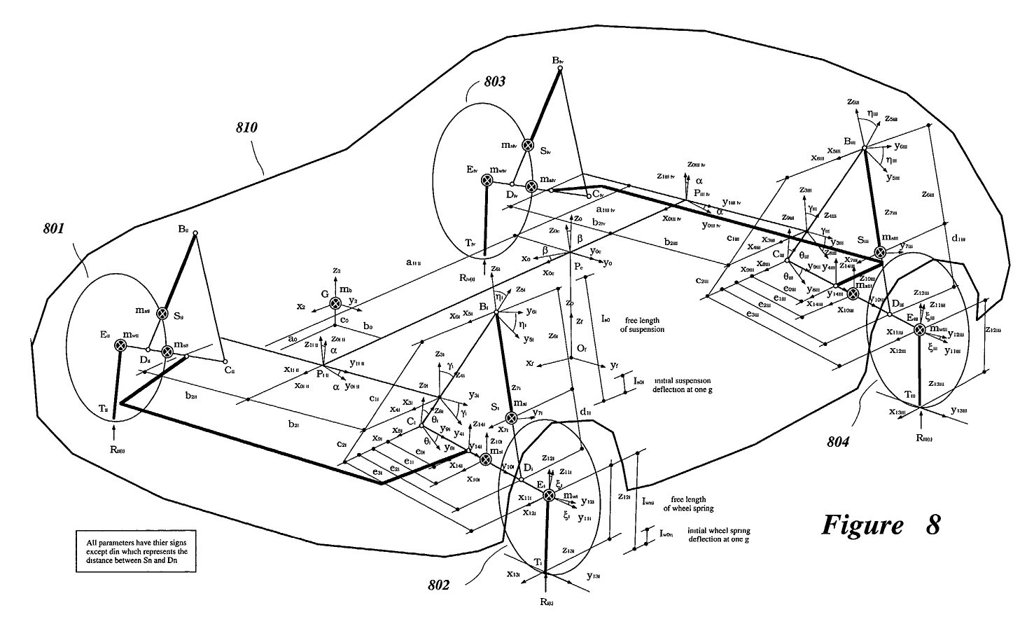

In one embodiment, the systems shown in FIGS. 3A, 3B, 4, 6, and 7 can be used to model a nonlinear dynamic system with nonlinear inertial force simulation, wherein the equation block 301 implements an equation that describes a vehicle suspension system shown in FIG. 8.

FIG. 8 shows a vehicle body 810 with coordinates for describing position of the body 810 with respect to wheels 801-804 and the suspension system. A global reference coordinate xᵣ, yᵣ, zᵣ{r} is assumed to be at the geometric center Pᵣ of the vehicle body 710. The following are the transformation matrices to describe the local coordinates for the suspension and its components:

{2} is a local coordinate in which an origin is the center of gravity of the vehicle body 710;

{7} is a local coordinate in which an origin is the center of gravity of the suspension;

{10n} is a local coordinate in which an origin is the center of gravity of the n'th arm;

{12n} is a local coordinate in which an origin is the center of gravity of the n'th wheel;

{13n} is a local coordinate in which an origin is a contact point of the n'th wheel relative to the road surface; and

{14} is a local coordinate in which an origin is a connection point of the stabilizer.

Note that in the development that follows, the wheels 802, 801, 804, and 803 are indexed using “i”, “ii”, “iii”, and “iv”, respectively.

As indicated, “n” is a coefficient indicating wheel positions such as i, ii, iii, and iv for left front, right front, left rear and right rear respectively. The local coordinate systems x₀, y₀, and z₀ {0} are expressed by using the following conversion matrix that moves the coordinate {r} along a vector (0, 0, z₀)

$${}_{0}^{r} T = [ \begin{matrix}1 & 0 & 0 & 0 \\ 0 & 1 & 0 & 0 \\ 0 & 0 & 1 & {z}_{0} \\ 0 & 0 & 0 & 1\end{matrix} ]$$

Rotating the vector {r} along yᵣ with an angle β makes a local coordinate system x_{0c}, y_{0c}, z_{0c}{0r} with a transformation matrix _{0c}⁰T.

$${}_{0 c}^{0} T = [ \begin{matrix}cos β & 0 & sin β & 0 \\ 0 & 1 & 0 & 0 \\ - sin β & 0 & cos β & 0 \\ 0 & 0 & 0 & 1\end{matrix} ] \qquad ( 2.1 )$$

Transferring {0r} through the vector (a₁ₙ, 0, 0) makes a local coordinate system x_{0f}, y_{0f}, Z_{0f}{0f} with a transformation matrix ^{0r}_{0f}T.

$${}_{0 n}^{0 c} T = [ \begin{matrix}1 & 0 & 0 & {a}_{1 n} \\ 0 & 1 & 0 & 0 \\ 0 & 0 & 1 & 0 \\ 0 & 0 & 0 & 1\end{matrix} ] \qquad ( 2.2 )$$

The above procedure is repeated to create other local coordinate systems with the following transformation matrices.

$$\begin{matrix}{}_{1 n}^{0 n} T = [ \begin{matrix}1 & 0 & 0 & 0 \\ 0 & cos α & - sin α & 0 \\ 0 & sin α & cos α & 0 \\ 0 & 0 & 0 & 1\end{matrix} ] & ( 2.3 ) \\ {}_{2}^{1 i} T = [ \begin{matrix}1 & 0 & 0 & {a}_{0} \\ 0 & 1 & 0 & {b}_{0} \\ 0 & 0 & 1 & {c}_{0} \\ 0 & 0 & 0 & 1\end{matrix} ] & ( 2.4 )\end{matrix}$$

Coordinates for the wheels (index n:i for the left front, ii for the right front, etc.) are generated as follows. Transferring {1n} through the vector (0, b₂ₙ, 0) makes local coordinate system X₃ₙ, y₃ₙ, z₃ₙ {3n} with transformation matrix ^{1f}₃ₙT.

$$\begin{matrix}{}_{3 n}^{1 n} T = [ \begin{matrix}1 & 0 & 0 & 0 \\ 0 & 1 & 0 & {b}_{2 n} \\ 0 & 0 & 1 & 0 \\ 0 & 0 & 0 & 1\end{matrix} ] & ( 2.5 ) \\ {}_{4 n}^{3 n} T = [ \begin{matrix}1 & 0 & 0 & 0 \\ 0 & cos {γ}_{n} & - sin {γ}_{n} & 0 \\ 0 & sin {γ}_{n} & cos {γ}_{n} & 0 \\ 0 & 0 & 0 & 1\end{matrix} ] & ( 2.6 ) \\ {}_{5 n }^{4 n} T = [ \begin{matrix}1 & 0 & 0 & 0 \\ 0 & 1 & 0 & 0 \\ 0 & 0 & 1 & {c}_{1 n} \\ 0 & 0 & 0 & 1\end{matrix} ] & ( 2.7 ) \\ {}_{6 n}^{5 n} T = [ \begin{matrix}1 & 0 & 0 & 0 \\ 0 & cos {η}_{n} & - sin {η}_{n} & 0 \\ 0 & sin {η}_{n} & cos {η}_{n} & 0 \\ 0 & 0 & 0 & 1\end{matrix} ] & ( 2.8 ) \\ {}_{7 n}^{6 n} T = [ \begin{matrix}1 & 0 & 0 & 0 \\ 0 & 1 & 0 & 0 \\ 0 & 0 & 1 & {z}_{6 n} \\ 0 & 0 & 0 & 1\end{matrix} ] & ( 2.9 ) \\ {}_{8 n}^{4 n} T = [ \begin{matrix}1 & 0 & 0 & 0 \\ 0 & 1 & 0 & 0 \\ 0 & 0 & 1 & {c}_{2 n} \\ 0 & 0 & 0 & 1\end{matrix} ] & ( 2.10 ) \\ {}_{9 n}^{8 n} T = [ \begin{matrix}1 & 0 & 0 & 0 \\ 0 & cos {θ}_{n} & - sin {θ}_{n} & 0 \\ 0 & sin {θ}_{n} & cos {θ}_{n} & 0 \\ 0 & 0 & 0 & 1\end{matrix} ] & ( 2.11 ) \\ {}_{10 n}^{9 n} T = [ \begin{matrix}1 & 0 & 0 & 0 \\ 0 & 1 & 0 & {e}_{1 n} \\ 0 & 0 & 1 & 0 \\ 0 & 0 & 0 & 1\end{matrix} ] & ( 2.12 ) \\ {}_{11 n}^{9 n} T = [ \begin{matrix}1 & 0 & 0 & 0 \\ 0 & 1 & 0 & {e}_{3 n} \\ 0 & 0 & 1 & 0 \\ 0 & 0 & 0 & 1\end{matrix} ] & ( 2.13 ) \\ {}_{12 n}^{11 n} T = [ \begin{matrix}1 & 0 & 0 & 0 \\ 0 & cos {ζ}_{n} & - sin {ζ}_{n} & 0 \\ 0 & sin {ζ}_{n} & cos {ζ}_{n} & 0 \\ 0 & 0 & 0 & 1\end{matrix} ] & ( 2.14 ) \\ {}_{13 n}^{12 n} T = [ \begin{matrix}1 & 0 & 0 & 0 \\ 0 & 1 & 0 & 0 \\ 0 & 0 & 1 & {z}_{12 n} \\ 0 & 0 & 0 & 1\end{matrix} ] & ( 2.15 ) \\ {}_{14 n}^{9 n} T = [ \begin{matrix}1 & 0 & 0 & 0 \\ 0 & 1 & 0 & {e}_{0 n} \\ 0 & 0 & 1 & 0 \\ 0 & 0 & 0 & 1\end{matrix} ] & ( 2.16 )\end{matrix}$$

Some of the matrices are sub-assembled to make the calculation simpler.

$$\begin{matrix}\begin{matrix}{}_{ 1 n}^{ r} T = {}_{0}^{r} T {}_{0 n}^{0 c} T {}_{1 n}^{0 n} T \\ = [ \begin{matrix}1 & 0 & 0 & 0 \\ 0 & 1 & 0 & 0 \\ 0 & 0 & 1 & {z}_{0} \\ 0 & 0 & 0 & 1\end{matrix} ] [ \begin{matrix}cos β & 0 & sin β & 0 \\ 0 & 1 & 0 & 0 \\ - sin β & 0 & cos β & 0 \\ 0 & 0 & 0 & 1\end{matrix} ] [ \begin{matrix}1 & 0 & 0 & {a}_{1 n} \\ 0 & 1 & 0 & 0 \\ 0 & 0 & 1 & 0 \\ 0 & 0 & 0 & 1\end{matrix} ] [ \begin{matrix}1 & 0 & 0 & 0 \\ 0 & cos α & - sin α & 0 \\ 0 & sin α & cos α & 0 \\ 0 & 0 & 0 & 1\end{matrix} ] \\ = [ \begin{matrix}cos β & 0 & sin β & {a}_{1 n} cos β \\ 0 & 1 & 0 & 0 \\ - sin β & 0 & cos β & {z}_{0} - {a}_{1} sin β \\ 0 & 0 & 0 & 1\end{matrix} ] [ \begin{matrix}1 & 0 & 0 & 0 \\ 0 & cos α & - sin α & 0 \\ 0 & sin α & cos α & 0 \\ 0 & 0 & 0 & 1\end{matrix} ] \\ = [ \begin{matrix}cos β & sin βsin α & sin βcos α & {a}_{1 n} cos β \\ 0 & cos α & - sin α & 0 \\ - sin β & cos βsin α & cos βcos α & {z}_{0} - {a}_{1 n} sin β \\ 0 & 0 & 0 & 1\end{matrix} ]\end{matrix} & ( 2.17 ) \\ \begin{matrix}{}_{ 4 n}^{ r} T = {}_{ 1 n}^{ r} T {}_{3 n}^{1 n} T {}_{4 n}^{3 n} T \\ = [ \begin{matrix}cos β & sin βsin α & sin βcos α & {a}_{1 n} cos β \\ 0 & cos α & - sin α & 0 \\ - sin β & cos βsin α & cos βcos α & {z}_{0} - {a}_{1 n} sin β \\ 0 & 0 & 0 & 1\end{matrix} ] [ \begin{matrix}1 & 0 & 0 & 0 \\ 0 & 1 & 0 & {b}_{2 n} \\ 0 & 0 & 1 & 0 \\ 0 & 0 & 0 & 1\end{matrix} ] \cdot [ \begin{matrix}1 & 0 & 0 & 0 \\ 0 & cos {γ}_{n} & - sin {γ}_{n} & 0 \\ 0 & sin {γ}_{n} & cos {γ}_{n} & 0 \\ 0 & 0 & 0 & 1\end{matrix} ] \\ = [ \begin{matrix}cos β & sin βsin ( α + {γ}_{n} ) & sin βcos ( α + {γ}_{n} ) & {b}_{2 n} sin βsin α + {a}_{1 n } cos β \\ 0 & cos ( α + {γ}_{n} ) & - sin ( α + {γ}_{n} ) & {b}_{2 n} cos α \\ - sin β & cos βsin ( α + {γ}_{n} ) & cos βcos ( α + {γ}_{n} ) & {z}_{0} - {b}_{2 n} cos β sin α - {a}_{1 n} sin β \\ 0 & 0 & 0 & 1\end{matrix} ]\end{matrix} & ( 2.18 ) \\ \begin{matrix}{}_{7 n}^{4 n} T = {}_{5 n}^{4 n} T {}_{6 n}^{5 n} T {}_{7 n}^{6 n} T \\ = [ \begin{matrix}1 & 0 & 0 & 0 \\ 0 & 1 & 0 & 0 \\ 0 & 0 & 1 & {c}_{1 n} \\ 0 & 0 & 0 & 1\end{matrix} ] [ \begin{matrix}1 & 0 & 0 & 0 \\ 0 & cos {η}_{n} , & - sin {η}_{n} & 0 \\ 0 & sin {η}_{n} & cos {η}_{n} & 0 \\ 0 & 0 & 0 & 1\end{matrix} ] [ \begin{matrix}1 & 0 & 0 & 0 \\ 0 & 1 & 0 & 0 \\ 0 & 0 & 1 & {z}_{6 n} \\ 0 & 0 & 0 & 1\end{matrix} ] \\ = [ \begin{matrix}1 & 0 & 0 & 0 \\ 0 & cos {η}_{n} & - sin {η}_{n} & 0 \\ 0 & sin {η}_{n} & cos {η}_{n} & {c}_{1 n} \\ 0 & 0 & 0 & 1\end{matrix} ] [ \begin{matrix}1 & 0 & 0 & 0 \\ 0 & 1 & 0 & 0 \\ 0 & 0 & 1 & {z}_{6 n} \\ 0 & 0 & 0 & 1\end{matrix} ] \\ = [ \begin{matrix}1 & 0 & 0 & 0 \\ 0 & cos {η}_{n} & - sin {η}_{n} & - {z}_{6 n} sin {η}_{n} \\ 0 & sin {η}_{n} & cos {η}_{n} & {c}_{1 n} + {z}_{6 n} cos {η}_{n} \\ 0 & 0 & 0 & 1\end{matrix} ]\end{matrix} & ( 2.19 ) \\ \begin{matrix}{}_{10 n}^{4 n} T = {}_{8 n}^{4 n} T {}_{9 n}^{8 n} T {}_{10 n}^{9 n} T \\ = [ \begin{matrix}1 & 0 & 0 & 0 \\ 0 & 1 & 0 & 0 \\ 0 & 0 & 1 & {c}_{2 n} \\ 0 & 0 & 0 & 1\end{matrix} ] [ \begin{matrix}1 & 0 & 0 & 0 \\ 0 & cos {θ}_{n} & - sin {θ}_{n} & 0 \\ 0 & sin {θ}_{n} & cos {θ}_{n} & 0 \\ 0 & 0 & 0 & 1\end{matrix} ] [ \begin{matrix}1 & 0 & 0 & 0 \\ 0 & 1 & 0 & {e}_{1 n} \\ 0 & 0 & 1 & 0 \\ 0 & 0 & 0 & 1\end{matrix} ] \\ = [ \begin{matrix}1 & 0 & 0 & 0 \\ 0 & cos {θ}_{n} & - sin {θ}_{n} & 0 \\ 0 & sin {θ}_{n} & cos {θ}_{n} & {c}_{2 n} \\ 0 & 0 & 0 & 1\end{matrix} ] [ \begin{matrix}1 & 0 & 0 & 0 \\ 0 & 1 & 0 & {e}_{1 n} \\ 0 & 0 & 1 & 0 \\ 0 & 0 & 0 & 1\end{matrix} ] \\ = [ \begin{matrix}1 & 0 & 0 & 0 \\ 0 & cos {θ}_{n} & - sin {θ}_{n} & {e}_{1 n} cos {θ}_{n} \\ 0 & sin {θ}_{n} & cos {θ}_{n} & {c}_{2 n} + {e}_{1 n} sin {θ}_{n} \\ 0 & 0 & 0 & 1\end{matrix} ]\end{matrix} & ( 2.20 ) \\ \begin{matrix}{}_{12 n}^{4 n} T = {}_{8 n}^{4 n} T {}_{9 n}^{8 n} T {}_{11 n}^{9 n} T {}_{12 n}^{11 n} T \\ = [ \begin{matrix}1 & 0 & 0 & 0 \\ 0 & 1 & 0 & 0 \\ 0 & 0 & 1 & {c}_{2 n} \\ 0 & 0 & 0 & 1\end{matrix} ] [ \begin{matrix}1 & 0 & 0 & 0 \\ 0 & cos {θ}_{n} & - sin {θ}_{n} & 0 \\ 0 & sin {θ}_{n} & cos {θ}_{n} & 0 \\ 0 & 0 & 0 & 1\end{matrix} ] [ \begin{matrix}1 & 0 & 0 & 0 \\ 0 & 1 & 0 & {e}_{3 n} \\ 0 & 0 & 1 & 0 \\ 0 & 0 & 0 & 1\end{matrix} ] [ \begin{matrix}1 & 0 & 0 & 0 \\ 0 & cos {ζ}_{n} & - sin {ζ}_{n} & 0 \\ 0 & sin {ζ}_{n} & cos {ζ}_{n} & 0 \\ 0 & 0 & 0 & 1\end{matrix} ] \\ = [ \begin{matrix}1 & 0 & 0 & 0 \\ 0 & cos {θ}_{n} & - sin {θ}_{n} & 0 \\ 0 & sin {θ}_{n} & cos {θ}_{n} & {c}_{2 n} \\ 0 & 0 & 0 & 1\end{matrix} ] [ \begin{matrix}1 & 0 & 0 & 0 \\ 0 & 1 & 0 & {e}_{3 n} \\ 0 & 0 & 1 & 0 \\ 0 & 0 & 0 & 1\end{matrix} ] [ \begin{matrix}1 & 0 & 0 & 0 \\ 0 & cos {ζ}_{n} & - sin {ζ}_{n} & 0 \\ 0 & sin {ζ}_{n} & cos {ζ}_{n} & 0 \\ 0 & 0 & 0 & 1\end{matrix} ] \\ = [ \begin{matrix}1 & 0 & 0 & 0 \\ 0 & cos {θ}_{n} & - sin {θ}_{n} & {e}_{3 n} cos {θ}_{n} \\ 0 & sin {θ}_{n} & cos {θ}_{n} & {c}_{2 n} + {e}_{3 n} sin {θ}_{n} \\ 0 & 0 & 0 & 1\end{matrix} ] [ \begin{matrix}1 & 0 & 0 & 0 \\ 0 & cos {ζ}_{n} & - sin {ζ}_{n} & 0 \\ 0 & sin {ζ}_{n} & cos {ζ}_{n} & 0 \\ 0 & 0 & 0 & 1\end{matrix} ] \\ = [ \begin{matrix}1 & 0 & 0 & 0 \\ 0 & cos ( {θ}_{n} + {ζ}_{n} ) & - sin ( {θ}_{n} + {ζ}_{n} ) & {e}_{3 n} cos {θ}_{n} \\ 0 & sin ( {θ}_{n} + {ζ}_{n} ) & cos ( {θ}_{n} + {ζ}_{n} ) & {c}_{2 n} + {e}_{3 n} sin {θ}_{n} \\ 0 & 0 & 0 & 1\end{matrix} ]\end{matrix} & ( 2.21 )\end{matrix}$$

Parts of the model are described both in local coordinate systems and in relations to the coordinate {r} or {1n} referenced to the vehicle body 710.

In the local coordinate systems:

$${P}_{body}^{2} = {P}_{susp . n}^{7 n} = {P}_{arm . n}^{10 n} = {P}_{wheel . n}^{12 n} = {P}_{touchpoint n}^{13 n} = {P}_{stab n}^{14 n} = [ \begin{matrix}\begin{matrix}\begin{matrix}0 \\ 0\end{matrix} \\ 0\end{matrix} \\ 1\end{matrix} ] \qquad ( 2.22 )$$

In the global reference coordinate system {r}:

$$\begin{matrix}\begin{matrix}{P}_{body}^{r} = {}_{1 i}^{r}{T}{}_{2}^{1 i} {TP}_{body}^{2} \\ = [ \begin{matrix}cos β & sin β sin α & sin βcos α & {a}_{1 i} cos β \\ 0 & cos α & - sin α & 0 \\ - sin β & cos βsin α & cos βcosα & {z}_{0} - {a}_{1 i} sin β \\ 0 & 0 & 0 & 1\end{matrix} ] [ \begin{matrix}1 & 0 & 0 & {a}_{0} \\ 0 & 1 & 0 & {b}_{0} \\ 0 & 0 & 1 & {c}_{0} \\ 0 & 0 & 0 & 1\end{matrix} ] [ \begin{matrix}\begin{matrix}\begin{matrix}0 \\ 0\end{matrix} \\ 0\end{matrix} \\ 1\end{matrix} ] \\ = [ \begin{matrix}\begin{matrix}\begin{matrix}{a}_{0} cos β + {b}_{0} sin βsin α + {c}_{0} sin βcos α + {a}_{1 i} cos β \\ {b}_{0} cos α - {c}_{0} sin α\end{matrix} \\ - {a}_{0} sin β + {b}_{0} cos β sin α + {c}_{0} cos β cos α - {a}_{1 i} sin β\end{matrix} \\ 1\end{matrix} ]\end{matrix} & ( 2.23 ) \\ \begin{matrix}{P}_{suspn}^{r} = {}_{4 n}^{r}{T}{}_{7 n}^{4 n} {TP}_{suspn}^{7 n} \\ = [ \begin{matrix}cos β & sin β sin ( α + {γ}_{n} ) & sin βcos ( α + {γ}_{n} ) & {b}_{2 n} sin βsinα + {a}_{1 n} cos β \\ 0 & cos ( α + {γ}_{n} ) & - sin ( α + {γ}_{n} ) & {b}_{2 n} cos α \\ - sin β & cos βsin ( α + {γ}_{n} ) & cos βcos ( α + {γ}_{n} ) & {z}_{0} + {b}_{2 n} cos βsin α - {a}_{1 n} sin β \\ 0 & 0 & 0 & 1\end{matrix} ] \cdot \\ [ \begin{matrix}1 & 0 & 0 & 0 \\ 0 & cos {η}_{n} & - sin {η}_{n} & - {z}_{6 n} sin {η}_{n} \\ 0 & sin {η}_{n} & cos {η}_{n} & {c}_{1 n} + {z}_{6 n} cos {η}_{n} \\ 0 & 0 & 0 & 1\end{matrix} ] [ \begin{matrix}\begin{matrix}\begin{matrix}0 \\ 0\end{matrix} \\ 0\end{matrix} \\ 1\end{matrix} ] \\ = [ \begin{matrix}\begin{matrix}\begin{matrix}\{ {z}_{6 n} cos ( α + {γ}_{n} + {η}_{n} ) + {c}_{1 n} cos ( α + {γ}_{n} ) + {b}_{2 n} sin α \} sin β + {a}_{1 n} cos β \\ - {z}_{6 n} sin ( α + {γ}_{n} + {η}_{n} ) - {c}_{1 n} sin ( α + {γ}_{n} ) + {b}_{2 n} cos α\end{matrix} \\ \{ {z}_{6 n} cos ( α + {γ}_{n} + {η}_{n} ) + {c}_{1 n} cos ( α + {γ}_{n} ) + {b}_{2 n} sin α \} cos β - {a}_{1 n} sin β\end{matrix} \\ 1\end{matrix} ]\end{matrix} & ( 2.24 ) \\ \begin{matrix}{P}_{armn}^{r} = {}_{4 n}^{r}{T}{}_{10 n}^{4 n} {TP}_{armn}^{10 n} \\ = [ \begin{matrix}cos β & sin β sin ( α + {γ}_{n} ) & sin βcos ( α + {γ}_{n} ) & {b}_{2 n} sin βsinα + {a}_{1 n} cos β \\ 0 & cos ( α + {γ}_{n} ) & - sin ( α + {γ}_{n} ) & {b}_{2 n} cos α \\ - sin β & cos βsin ( α + {γ}_{n} ) & cos βcos ( α + {γ}_{n} ) & {z}_{0} + {b}_{2 n} cos βsin α - {a}_{1 n} sin β \\ 0 & 0 & 0 & 1\end{matrix} ] \cdot \\ [ \begin{matrix}1 & 0 & 0 & 0 \\ 0 & cos {θ}_{n} & - sin {θ}_{n} & {e}_{3 n} cos {θ}_{n} \\ 0 & sin {θ}_{n} & cos {θ}_{n} & {c}_{2 n} + {e}_{1 n} sin {θ}_{n} \\ 0 & 0 & 0 & 1\end{matrix} ] [ \begin{matrix}\begin{matrix}\begin{matrix}0 \\ 0\end{matrix} \\ 0\end{matrix} \\ 1\end{matrix} ] \\ = [ \begin{matrix}\begin{matrix}\begin{matrix}\{ {e}_{1 n} sin ( α + {γ}_{n} + {θ}_{n} ) + {c}_{2 n} cos ( α + {γ}_{n} ) + {b}_{2 n} sin α \} sin β + {a}_{1 n} cos β \\ {e}_{1 n} cos ( α + {γ}_{n} + {θ}_{n} ) - {c}_{2 n} sin ( α + {γ}_{n} ) + {b}_{2 n} cos α\end{matrix} \\ \{ {e}_{1 n} sin ( α + {γ}_{n} + {θ}_{n} ) + {c}_{2 n} cos ( α + {γ}_{n} ) + {b}_{2 n} sin α \} cos β - {a}_{1 n} sin β\end{matrix} \\ 1\end{matrix} ]\end{matrix} & ( 2.25 ) \\ \begin{matrix}{P}_{wheel . n}^{r} = {}_{4 n}^{r}{T}{}_{12 n}^{4 n} {TP}_{wheel . n}^{12 n} \\ = [ \begin{matrix}cos β & sin β sin ( α + {γ}_{n} ) & sin βcos ( α + {γ}_{n} ) & {b}_{2 n} sin βsinα + {a}_{1 n} cos β \\ 0 & cos ( α + {γ}_{n} ) & - sin ( α + {γ}_{n} ) & {b}_{2 n} cos α \\ - sin β & cos βsin ( α + {γ}_{n} ) & cos βcos ( α + {γ}_{n} ) & {b}_{2 n} cos βsin α - {a}_{1 n} sin β \\ 0 & 0 & 0 & 1\end{matrix} ] \\ [ \begin{matrix}1 & 0 & 0 & 0 \\ 0 & cos ( {θ}_{n} + {ζ}_{n} ) & - sin ( {θ}_{n} + {ζ}_{n} ) & {e}_{3 n} cos {θ}_{n} \\ 0 & sin ( {θ}_{n} + {ζ}_{n} ) & cos ( {θ}_{n} + {ζ}_{n} ) & {c}_{2 n} + {e}_{3 n} sin {θ}_{n} \\ 0 & 0 & 0 & 1\end{matrix} ] [ \begin{matrix}\begin{matrix}\begin{matrix}0 \\ 0\end{matrix} \\ 0\end{matrix} \\ 1\end{matrix} ] \\ = [ \begin{matrix}\begin{matrix}\begin{matrix}\{ {e}_{3 n} sin ( α + {γ}_{n} + {θ}_{n} ) + {c}_{2 n} cos ( α + {γ}_{n} ) + {b}_{2 n} sin α \} sin β + {a}_{1 n} cos β \\ {e}_{3 n} cos ( α + {γ}_{n} + {θ}_{n} ) - {c}_{2 n} sin ( α + {γ}_{n} ) + {b}_{2 n} cos α\end{matrix} \\ {z}_{0} + \{ {e}_{3 n} sin ( α + {γ}_{n} + {θ}_{n} ) + {c}_{2 n} cos ( α + {γ}_{n} ) + {b}_{2 n} sin α \} cos β - {a}_{1 n} sin β\end{matrix} \\ 1\end{matrix} ]\end{matrix} & ( 2.26 ) \\ \begin{matrix}{P}_{touchpointn}^{r} = {}_{4 n}^{r}{T}{}_{12 n}^{4 n} {T}_{13 n}^{12 n} {TP}_{touchpointn}^{13 n} \\ = [ \begin{matrix}cos β & sin β sin ( α + {γ}_{n} ) & sin βcos ( α + {γ}_{n} ) & {b}_{2 n} sin βsinα + {a}_{1 n} cos β \\ 0 & cos ( α + {γ}_{n} ) & - sin ( α + {γ}_{n} ) & {b}_{2 n} cos α \\ - sin β & cos βsin ( α + {γ}_{n} ) & cos βcos ( α + {γ}_{n} ) & {z}_{0} + {b}_{2 n} cos βsin α - {a}_{1 n} sin β \\ 0 & 0 & 0 & 1\end{matrix} ] \\ [ \begin{matrix}1 & 0 & 0 & 0 \\ 0 & cos ( {θ}_{n} + {ζ}_{n} ) & - sin ( {θ}_{n} + {ζ}_{n} ) & {e}_{3 n} cos {θ}_{n} \\ 0 & sin ( {θ}_{n} + {ζ}_{n} ) & cos ( {θ}_{n} + {ζ}_{n} ) & {c}_{2 n} + {e}_{3 n} sin {θ}_{n} \\ 0 & 0 & 0 & 1\end{matrix} ] [ \begin{matrix}1 & 0 & 0 & 0 \\ 0 & 1 & 0 & 0 \\ 0 & 0 & 1 & {z}_{12 n} \\ 0 & 0 & 0 & 1\end{matrix} ] [ \begin{matrix}\begin{matrix}\begin{matrix}0 \\ 0\end{matrix} \\ 0\end{matrix} \\ 1\end{matrix} ] \\ = [ \begin{matrix}\{ {z}_{12 n} cos α + {e}_{3 n} sin ( α + {γ}_{n} + {θ}_{n} ) + {c}_{2 n} cos ( α + {γ}_{n} ) + {b}_{2 n} sin α \} sin β + {a}_{1 n} cos β \\ - {z}_{12 n} sin α + {e}_{3 n} cos ( α + {γ}_{n} + {θ}_{n} ) - {c}_{2 n} sin ( α + {γ}_{n} ) + {b}_{2 n} cos α \\ {z}_{0} + \{ {z}_{12 n} cos α + {e}_{3 n} sin ( α + {γ}_{n} + {θ}_{n} ) + {c}_{2 n} cos ( α + {γ}_{n} ) + {b}_{2 n} sin α \} cos β - {a}_{1 n} sin β \\ 1\end{matrix} ]\end{matrix} & ( 2.27 )\end{matrix}$$

where ζₙ is substituted by,

ζₙ=−γₙ−θₙ

because of the link mechanism to support a wheel at this geometric relation.

The stabilizer linkage point is in the local coordinate system {1n}. The stabilizer works as a spring in which force is proportional to the difference of displacement between both arms in a local coordinate system {1n} fixed to the body 710.

$$\begin{matrix}{P}_{stab . n}^{1 n} = {}_{3 n}^{1 n}{T}{}_{4 n}^{3 n} {T}_{8 n}^{4 n} {T}_{9 n}^{8 n} {T}_{14 n}^{9 n} {TP}_{stab n}^{14 n} \\ = [ \begin{matrix}1 & 0 & 0 & 0 \\ 0 & 1 & 0 & {b}_{2 n} \\ 0 & 0 & 1 & 0 \\ 0 & 0 & 0 & 1\end{matrix} ] [ \begin{matrix}1 & 0 & 0 & 0 \\ 0 & cos {γ}_{n} & - sin {γ}_{n} & 0 \\ 0 & sin {γ}_{n} & cos {γ}_{n} & 0 \\ 0 & 0 & 0 & 1\end{matrix} ] [ \begin{matrix}1 & 0 & 0 & 0 \\ 0 & 1 & 0 & 0 \\ 0 & 0 & 1 & {c}_{2 n} \\ 0 & 0 & 0 & 1\end{matrix} ] \\ [ \begin{matrix}1 & 0 & 0 & 0 \\ 0 & cos {θ}_{n} & - sin {θ}_{n} & 0 \\ 0 & sin {θ}_{n} & cos {θ}_{n} & 0 \\ 0 & 0 & 0 & 1\end{matrix} ] [ \begin{matrix}1 & 0 & 0 & 0 \\ 0 & 1 & 0 & {e}_{0 n} \\ 0 & 0 & 1 & 0 \\ 0 & 0 & 0 & 1\end{matrix} ] [ \begin{matrix}\begin{matrix}\begin{matrix}0 \\ 0\end{matrix} \\ 0\end{matrix} \\ 1\end{matrix} ] \\ = [ \begin{matrix}\begin{matrix}\begin{matrix}0 \\ {e}_{0 n} cos ( {γ}_{n} + {θ}_{n} ) - {c}_{2 n} sin {γ}_{n} + {b}_{2 n}\end{matrix} \\ {e}_{0 n} sin ( {γ}_{n} + {θ}_{n} ) + {c}_{2 n} cos {γ}_{n}\end{matrix} \\ 0\end{matrix} ]\end{matrix} \qquad ( 2.28 )$$

Kinetic energy, potential energy and dissipative functions for the <Body>, <Suspension>, <Arm>, <Wheel> and <Stabilizer> are developed as follows. Kinetic energy and potential energy except by springs are calculated based on the displacement referred to the inertial global coordinate {r}. Potential energy by springs and dissipative functions are calculated based on the movement in each local coordinate.

$$\begin{matrix}\text{<Body>} \\ {T}_{b}^{tr} = \frac{1}{2} {m}_{b} ( {\dot{x}}_{b}^{2} + {\dot{y}}_{b}^{2} + {\dot{z}}_{b}^{2} ) \\ \text{where} & ( 2.89 ) \\ \begin{matrix}\begin{matrix}{x}_{b} = ( {a}_{0} + {a}_{1 n} ) cos β + ( {b}_{0} sin α + {c}_{0} cos α ) sin β \\ {y}_{b} = {b}_{0} cos α - {c}_{0} sin α\end{matrix} \\ {z}_{b} = {z}_{0} - ( {a}_{0} + {a}_{1 n} ) sin β + ( {b}_{0} sin α + {c}_{0} cos α ) cos β\end{matrix} \\ \text{and} & ( 2.30 ) \\ \begin{matrix}\begin{matrix}\begin{matrix}\begin{matrix}\begin{matrix}\begin{matrix}\begin{matrix}{q}_{j , k} = β , α , {z}_{0} \\ \frac{\partial {x}_{b}}{\partial β} = - ( {a}_{0} + {a}_{1 n} ) sin β + ( {b}_{0} sin α + {c}_{0} cos α ) cos β\end{matrix} \\ \frac{\partial {x}_{b}}{\partial α} = ( {b}_{0} cos α - {c}_{0} sin α ) sin β\end{matrix} \\ \frac{\partial {y}_{b}}{\partial β} = \frac{\partial {x}_{b}}{\partial {z}_{0}} = \frac{\partial {y}_{b}}{\partial {z}_{0}} = 0\end{matrix} \\ \frac{\partial {y}_{b}}{\partial α} = - {b}_{0} sin α - {c}_{0} cos α\end{matrix} \\ \frac{\partial {z}_{b}}{\partial β} = - ( {a}_{0} + {a}_{1 n} ) cos β - ( {b}_{0} sin α + {c}_{0} cos α ) sin β\end{matrix} \\ \frac{\partial {z}_{b}}{\partial α} = ( {b}_{0} cos α - {c}_{0} sin α ) cos β\end{matrix} \\ \frac{\partial {z}_{b}}{\partial {z}_{0}} = 1\end{matrix} \\ \text{and thus} & ( 2.31 ) \\ \begin{matrix}{T}_{b}^{tr} = \frac{1}{2} {m}_{b} ( {\dot{x}}_{b}^{2} + {\dot{y}}_{b}^{2} + {\dot{z}}_{b}^{2} ) \\ = \frac{1}{2} {m}_{b} {\sum }_{j , k} ( \frac{\partial {x}_{b}}{\partial {q}_{j}} \frac{\partial {x}_{b}}{\partial {q}_{k}} {\dot{q}}_{j} {\dot{q}}_{k} + \frac{\partial {y}_{b}}{\partial {q}_{j}} \frac{\partial {y}_{b}}{\partial {q}_{k}} {\dot{q}}_{j} {\dot{q}}_{k} + \frac{\partial {z}_{b}}{\partial {q}_{j}} \frac{\partial {z}_{b}}{\partial {q}_{k}} {\dot{q}}_{j} {\dot{q}}_{k} ) \\ = \frac{1}{2} {m}_{b} ⟨ {\dot{β}}^{2} {\{ - ( {a}_{0} + {a}_{1} ) sin β + ( {b}_{0} sin α + {c}_{0} cos α ) cos β \}}^{2} + \\ {\dot{α}}^{2} {\{ ( {b}_{0} cos α - {c}_{0} sin α ) sin β \}}^{2} + {{\dot{α}}^{2} ( - {b}_{0} sin α - {c}_{0} cos α )}^{2} + \\ {\dot{β}}^{2} {\{ - ( {a}_{0} + {a}_{1} ) cos β - ( {b}_{0} sin α + {c}_{0} cos α ) sin β \}}^{2} + \\ {\dot{α}}^{2} {\{ ( {b}_{0} cos α - {c}_{0} sin α ) cos β \}}^{2} + {\dot{z}}_{0}^{2} + 2 \dot{α} \dot{β} [ \{ - ( {a}_{0} + {a}_{1} ) sin β + \\ ( {b}_{0} sin α + {c}_{0} cos α ) cos β \} ( {b}_{0} cos α - {c}_{0} sin α ) sin β + \\ \{ - ( {a}_{0} + {a}_{1} ) cos β - \\ ( {b}_{0} sin α + {c}_{0} cos α ) sin β \} ( {b}_{0} cos α - {c}_{0} sin α ) cos β ] - \\ 2 \dot{β} {\dot{z}}_{0} \{ ( {a}_{0} + {a}_{1 n} ) cos β + ( {b}_{0} sin α - {c}_{0} cos α ) sin β \} + \\ 2 \dot{α} {\dot{z}}_{0} ( {b}_{0} cos α - {c}_{0} sin α ) cos β ⟩ \\ = \frac{1}{2} {m}_{b} ⟨ {\dot{α}}^{2} ( {b}_{0}^{2} + {c}_{0}^{2} ) + {\dot{β}}^{2} \{ {( {a}_{0} + {a}_{1 i} )}^{2} + {( {b}_{0} sin α + {c}_{0} cos α )}^{2} \} + \\ {\dot{z}}_{0}^{2} - 2 \dot{α} \dot{β} ( {a}_{0} + {a}_{1 i} ) ( {b}_{0} cos α - {c}_{0} sin α ) - \\ 2 \dot{β} {\dot{z}}_{o} \{ ( {a}_{0} + {a}_{1 i} ) cos β + ( {b}_{0} sin α - {c}_{0} cos α ) sin β + \\ 2 \dot{α} {\dot{z}}_{0} ( {b}_{0} cos α - {c}_{0} sin α ) cos β ⟩\end{matrix} & ( 2.32 ) \\ {T}_{b}^{ro} = \frac{1}{2} ( {I}_{bx} {ω}_{bx}^{2} + {I}_{by} {ω}_{by}^{2} + {I}_{bz} {ω}_{bz}^{2} ) \\ \text{where} \\ \begin{matrix}\begin{matrix}{ω}_{bx} = \dot{α} \\ {ω}_{by} = \dot{β}\end{matrix} \\ {ω}_{bz} = 0\end{matrix} ∴ \\ \begin{matrix}{T}_{b}^{ro} = \frac{1}{2} ( {I}_{bx} {\dot{α}}^{2} + {I}_{by} {\dot{β}}^{2} ) \\ {U}_{b} = {m}_{b} g {z}_{b} \\ = {m}_{b} g \{ - ( {a}_{0} + {a}_{1 n} ) sin β + ( {b}_{0} sin α + {c}_{0} cos α ) cos β \}\end{matrix} & ( 2.33 ) \\ \text{<Suspension>} \\ {T}_{sn}^{tr} = \frac{1}{2} {m}_{sn} ( {\dot{x}}_{sn}^{2} + {\dot{y}}_{sn}^{2} + {\dot{z}}_{sn}^{2} ) \\ \text{where} \\ \begin{matrix}{x}_{sn} = \{ {z}_{6 n} cos ( α + {γ}_{n} + {η}_{n} ) + {c}_{1 n} cos ( α + {γ}_{n} ) + \\ {b}_{2 n} sin α \} sin β + {a}_{1 n} cos β \\ {y}_{sn} = - {z}_{6 n} sin ( α + {γ}_{n} + {η}_{n} ) - {c}_{1 n} sin ( α + {γ}_{n} ) + {b}_{2 n} cos α \\ {z}_{sn} = {z}_{0} + \{ {z}_{6 n} cos ( α + {γ}_{n} + {η}_{n} ) + {c}_{1 n} cos ( α + {γ}_{n} ) + \\ {b}_{2 n} sin α \} cos β - {a}_{1 n} sin β\end{matrix} & ( 2.34 ) \\ \begin{matrix}\begin{matrix}\begin{matrix}\begin{matrix}\begin{matrix}\begin{matrix}\begin{matrix}\begin{matrix}{q}_{j , k} = {z}_{6 n} , {η}_{n} , α , β , {z}_{0} \\ \frac{\partial {x}_{sn}}{\partial {z}_{6 n}} = cos ( α + {γ}_{n} + {η}_{n} ) sin β\end{matrix} \\ \frac{\partial {x}_{sn}}{\partial {η}_{n}} = - {z}_{6 n} sin ( α + {γ}_{n} + {η}_{n} ) sin β\end{matrix} \\ \frac{\partial {x}_{sn}}{\partial α} = \{ - {z}_{6 n} sin ( α + {γ}_{n} + {η}_{n} ) - {c}_{1 n} sin ( α + {γ}_{n} ) + {b}_{2 n} cos α \} sin β\end{matrix} \\ \frac{\partial {y}_{sn}}{\partial {z}_{6 n}} = - sin ( α + {γ}_{n} + {η}_{n} )\end{matrix} \\ \frac{\partial {y}_{sn}}{\partial {η}_{n}} = - {z}_{6 n} cos ( α + {γ}_{n} + {η}_{n} )\end{matrix} \\ \frac{\partial {y}_{sn}}{\partial α} = - {z}_{6 n} cos ( α + {γ}_{n} + {η}_{n} ) - {c}_{1 n} cos ( α + {γ}_{n} ) - {b}_{2 n} sin α\end{matrix} \\ \frac{\partial {y}_{sn}}{\partial β} = \frac{\partial {x}_{sn}}{\partial {z}_{0}} = \frac{\partial {y}_{sn}}{\partial {z}_{0}} = 0\end{matrix} \\ \frac{\partial {z}_{sn}}{\partial {z}_{0}} = 1\end{matrix} & ( 2.35 ) \\ \begin{matrix}\frac{\partial {z}_{sn}}{\partial {z}_{6 n}} = cos ( α + {γ}_{n} + {η}_{n} ) cos β \\ \frac{\partial {z}_{sn}}{\partial {η}_{n}} = - {z}_{6 n} sin ( α + {γ}_{n} + {η}_{n} ) cos β \\ \frac{\partial {z}_{sn}}{\partial α} = \{ - {z}_{6 n} sin ( α + {γ}_{n} + {η}_{n} ) - {c}_{1 n} sin ( α + {γ}_{n} ) + {b}_{2 n} cos α \} cos β \\ \frac{\partial {z}_{sn}}{\partial β} = - \{ {z}_{6 n} cos ( α + {γ}_{n} + {η}_{n} ) + {c}_{1 n} cos ( α + {γ}_{n} ) + \\ {b}_{2 n} sin α \} sin β - {a}_{1 n} cos β ∴\end{matrix} & ( 2.36 ) \\ {T}_{sn}^{tr} = \frac{1}{2} {m}_{sn} ( {\dot{x}}_{sn}^{2} + {\dot{y}}_{sn}^{2} + {\dot{z}}_{sn}^{2} ) \\ = \frac{1}{2} {m}_{sn} {\sum }_{j , k} ( \frac{\partial {x}_{sn}}{\partial {q}_{j}} \frac{\partial {x}_{sn}}{\partial {q}_{k}} {\dot{q}}_{j} {\dot{q}}_{k} + \frac{\partial {y}_{sn}}{\partial {q}_{j}} \frac{\partial {y}_{sn}}{\partial {q}_{k}} {\dot{q}}_{j} {\dot{q}}_{k} + \frac{\partial {z}_{sn}}{\partial {q}_{j}} \frac{\partial {z}_{sn}}{\partial {q}_{k}} {\dot{q}}_{j} {\dot{q}}_{k} ) & ( 2.37 ) \\ = \frac{1}{2} {m}_{sn} ⟨ {\dot{z}}_{6 n}^{2} + {\dot{η}}_{n}^{2} {z}_{6 n}^{2} + {\dot{α}}^{2} [ {z}_{6 n}^{2} + {c}_{1 n}^{2} + {b}_{2 n}^{2} + 2 \{ {z}_{6 n} {c}_{1 n} cos {η}_{n} - {z}_{6 n} {b}_{2 n} sin ( {γ}_{n} + {η}_{n} ) - {c}_{1 n} {b}_{2 n} sin {γ}_{n} \} ] + {\dot{β}}^{2} [ {\{ ( {z}_{6 n} cos ( α + {γ}_{n} + {η}_{n} ) + {c}_{1 n} cos ( α + {γ}_{n} ) + {b}_{2 n} sin α ) \}}^{2} + {a}_{1 n}^{2} ] + {\dot{z}}_{0}^{2} + 2 {\dot{z}}_{6 n} \dot{α} \{ {c}_{1 n} sin {η}_{n} + {b}_{2 n} cos ( {γ}_{n} + {η}_{n} ) \} - 2 {\dot{z}}_{6 n} \dot{β} {a}_{1 n} cos ( α + {γ}_{n} + {η}_{n} ) + 2 {\dot{η}}_{n} \dot{α} {z}_{6 n} \{ {z}_{6 n} + {c}_{1 n} cos {η}_{n} - {b}_{2 n} sin ( {γ}_{n} + {η}_{n} ) \} + 2 {\dot{η}}_{n} \dot{β} {z}_{6 n} {a}_{1 n} sin ( α + {γ}_{n} + {η}_{n} ) + 2 \dot{α} \dot{β} {a}_{1 n} \{ {z}_{6 n} sin ( α + {γ}_{n} + {η}_{n} ) + {c}_{1 n} sin α + {γ}_{n} - {b}_{2 n} cos α \} + 2 {\dot{z}}_{6 n} {\dot{z}}_{0} cos ( α + {γ}_{n} + {η}_{n} ) cos β - 2 {\dot{η}}_{n} {\dot{z}}_{0} {z}_{6 n} sin ( α + {γ}_{n} + {η}_{n} ) cos β + 2 \dot{α} {\dot{z}}_{0} \{ {z}_{6 n} sin ( α + {γ}_{n} + {η}_{n} ) - {c}_{1 n} sin ( α + {γ}_{n} ) + {b}_{2 n} cos α \} cos β + 2 \dot{β} {\dot{z}}_{0} [ \{ {z}_{6 n} cos ( α + {γ}_{n} + {η}_{n} ) + {c}_{1 n} sin ( α + {γ}_{n} ) + {b}_{2 n} cos α \} sin β + {α}_{1 n} cos β ] ⟩ & ( 2.38 ) \\ \begin{matrix}{T}_{sn}^{ro} ≅ 0 \\ {U}_{sn} = {m}_{sn} g {z}_{sn} + \frac{1}{2} {{k}_{sn} ( {z}_{6 n} - {l}_{sn} )}^{2} \\ = {m}_{sn} g [ {z}_{0} + \{ {z}_{6 n} cos ( α + {γ}_{n} + {η}_{n} ) + {c}_{1 n} cos ( α + {γ}_{n} ) + \\ {b}_{2 n} sin α \} cos β - {a}_{1 n} sin β ] + \frac{1}{2} {{k}_{sn} ( {z}_{6 n} - {l}_{sn} )}^{2} \\ {F}_{sn} = - \frac{1}{2} {c}_{sn} {\dot{z}}_{6 n}^{2}\end{matrix} & ( 2.39 ) \\ \text{<Arm>} \\ {T}_{an}^{tr} = \frac{1}{2} {m}_{an} ( {\dot{x}}_{an}^{2} + {\dot{y}}_{an}^{2} + {\dot{z}}_{an}^{2} ) \\ \text{where} & ( 2.40 ) \\ \begin{matrix}{x}_{an} = \{ {e}_{1 n} sin ( α + {γ}_{n} + {θ}_{n} ) + {c}_{2 n} cos ( α + {γ}_{n} ) \\ + {b}_{2 n} sin α \} sin β + {a}_{1 n} cos β \\ {y}_{an} = {e}_{1 n} cos ( α + {γ}_{n} + {θ}_{n} ) - {c}_{2 n} sin ( α + {γ}_{n} ) + {b}_{2 n} cos α \\ {z}_{an} = {z}_{0} + \{ {e}_{1 n} sin ( α + {γ}_{n} + {θ}_{n} ) + {c}_{2 n} cos ( α + {γ}_{n} ) + \\ {b}_{2 n} sin α \} cos β - {a}_{1 n} sin β\end{matrix} \\ \text{and} & ( 2.41 ) \\ \begin{matrix}{q}_{j , k} = {θ}_{n} , α , β , {z}_{0} \\ \frac{\partial {x}_{an}}{\partial {θ}_{n}} = {e}_{1 n} cos ( α + {γ}_{n} + {θ}_{n} ) sin β \\ \frac{\partial {x}_{an}}{\partial α} = \{ {e}_{1 n} cos ( α + {γ}_{n} + {θ}_{n} ) - {c}_{2 n} sin ( α + {γ}_{n} ) + {b}_{2 n} cos α \} sin β \\ \frac{\partial {x}_{an}}{\partial β} = \{ {e}_{1 n} sin ( α + {γ}_{n} + {θ}_{n} ) + {c}_{2 n} cos ( α + {γ}_{n} ) + \\ {b}_{2 n} sin α \} cos β - {a}_{1 n} sin β \\ \frac{\partial {y}_{an}}{\partial {θ}_{n}} = - {e}_{1 n} sin ( α + {γ}_{n} + {θ}_{n} ) \\ \frac{\partial {y}_{an}}{\partial α} = - {e}_{1 n} sin ( α + {γ}_{n} + {θ}_{n} ) - {c}_{2 n} cos ( α + {γ}_{n} ) - {b}_{2 n} sin α \\ \frac{\partial {y}_{an}}{\partial β} = \frac{\partial {x}_{an}}{\partial {z}_{0}} = \frac{\partial {y}_{an}}{\partial {z}_{0}} = 0 \\ \frac{\partial {z}_{an}}{\partial {θ}_{n}} = {e}_{1 n} cos ( α + {γ}_{n} + {θ}_{n} ) cos β \\ \frac{\partial {z}_{an}}{\partial α} = \{ {e}_{1 n} cos ( α + {γ}_{n} + {θ}_{n} ) - {c}_{2 n} sin ( α + {γ}_{n} ) + {b}_{2 n} cos α \} cos β \\ \frac{\partial {z}_{an}}{\partial β} = - \{ {e}_{1 n} sin ( α + {γ}_{n} + {θ}_{n} ) + {c}_{2 n} cos ( α + {γ}_{n} ) + \\ {b}_{2 n} sin α \} sin β - {a}_{1 n} cos β \\ \frac{\partial {z}_{an}}{\partial {z}_{0}} = 1\end{matrix} \\ \text{thus} & ( 2.42 ) \\ \begin{matrix}{T}_{an}^{tr} = \frac{1}{2} {m}_{an} ( {\dot{x}}_{an}^{2} + {\dot{y}}_{an}^{2} + {\dot{z}}_{an}^{2} ) \\ = \frac{1}{2} {m}_{an} {\sum }_{j , k} ( \frac{\partial {x}_{an}}{\partial {q}_{j}} \frac{\partial {x}_{an}}{\partial {q}_{k}} {\dot{q}}_{j} {\dot{q}}_{k} + \frac{\partial {y}_{an}}{\partial {q}_{j}} \frac{\partial {y}_{an}}{\partial {q}_{k}} {\dot{q}}_{j} {\dot{q}}_{k} + \\ \frac{\partial {z}_{an}}{\partial {q}_{j}} \frac{\partial {z}_{an}}{\partial {q}_{k}} {\dot{q}}_{j} {\dot{q}}_{k} )\end{matrix} & ( 2.43 ) \\ = \frac{1}{2} {m}_{an} ⟨ {\dot{θ}}_{n}^{2} {e}_{1 n}^{2} + {\dot{α}}^{2} [ {e}_{1 n}^{2} + {c}_{2 n}^{2} + {b}_{2 n}^{2} - 2 \{ {e}_{1 n} {c}_{2 n} sin {θ}_{n} + {e}_{1 n} {b}_{2 n} cos ( {γ}_{n} + {θ}_{n} ) + {c}_{2 n} {b}_{2 n} sin {γ}_{n} \} ] + {\dot{β}}^{2} [ {\{ {e}_{1 n} sin ( α + {γ}_{n} + {θ}_{n} ) + {c}_{2 n} cos ( α + {γ}_{n} ) + {b}_{2 n} sin α \}}^{2} + {a}_{1 n}^{2} ] + {\dot{z}}_{0}^{2} + 2 \dot{θ} \dot{α} {e}_{1 n} \{ {e}_{1 n} - {c}_{2 n} sin {θ}_{n} + {b}_{2 n} cos ( {γ}_{n} + {θ}_{n} ) \} - 2 {\dot{θ}}_{n} \dot{β} {e}_{1 n} {a}_{1 n} cos ( α + {γ}_{n} + {θ}_{n} ) - 2 \dot{α} \dot{β} {a}_{1 n} \{ {e}_{1 n} cos ( α + {γ}_{n} + {θ}_{n} ) - {c}_{1 n} sin ( α + {γ}_{n} ) + {b}_{2 n} cos α \} - 2 {\dot{θ}}_{n} {\dot{z}}_{0} {e}_{1 n} cos ( α + {γ}_{n} + {θ}_{n} ) cos β + 2 \dot{α} {\dot{z}}_{0} \{ {e}_{1 n} cos ( α + {γ}_{n} + {θ}_{n} ) - {c}_{2 n} sin ( α + {γ}_{n} ) + {b}_{2 n} cos α \} cos β + 2 \dot{β} {\dot{z}}_{0} [ \{ {e}_{1 n} sin ( α + {γ}_{n} + {θ}_{n} ) + {c}_{2 n} cos ( α + {γ}_{n} ) + {b}_{2 n} sin α \} sin β + {α}_{1 n} cos β ] ⟩ & ( 2.44 ) \\ \begin{matrix}{T}_{an}^{ro} = \frac{1}{2} {I}_{ax} {ω}_{ax}^{2} \\ = \frac{1}{2} {{I}_{ax} ( \dot{α} + {\dot{θ}}_{n} )}^{2} \\ {U}_{an} = {m}_{an} g {z}_{an} \\ = {m}_{an} g [ {z}_{0} + \{ {e}_{1 n} sin ( α + {γ}_{n} + {θ}_{n} ) + {c}_{2 n} cos ( α + {γ}_{n} ) + \\ {b}_{2 n} sin α \} cos β - {a}_{1 n} sin β\end{matrix} & ( 2.45 ) \\ \text{<Wheel>} \\ {T}_{wn}^{tr} = \frac{1}{2} {m}_{wn} ( {\dot{x}}_{wn}^{2} + {\dot{y}}_{wn}^{2} + {\dot{z}}_{wn}^{2} ) \\ \text{where} & ( 2.46 ) \\ \begin{matrix}{x}_{wn} = \{ {e}_{3 n} sin ( α + {γ}_{n} + {θ}_{n} ) + {c}_{2 n} cos ( α + {γ}_{n} ) + \\ {b}_{2 n} sin α \} sin β + {a}_{1 n} cos β \\ {y}_{wn} = {e}_{3 n} cos ( α + {γ}_{n} + {θ}_{n} ) - {c}_{2 n} sin ( α + {γ}_{n} ) + {b}_{2 n} cos α \\ {z}_{wn} = {z}_{0} + \{ {e}_{3 n} sin ( α + {γ}_{n} + {θ}_{n} ) + {c}_{2 n} cos ( α + {γ}_{n} ) + \\ {b}_{2 n} sin α \} cos β - {a}_{1 n} sin β\end{matrix} & ( 2.47 )\end{matrix}$$

Substituting mₐₙ with m_{wn} and e₁ₙ with e₃ₙ in the equation for the arm, yields an equation for the wheel as:

$$\begin{matrix}{T}_{wn}^{tr} = \frac{1}{2} {m}_{wn} ⟨ {\dot{θ}}_{n}^{2} {e}_{3 n}^{2} + {\dot{α}}^{2} [ {e}_{3 n}^{2} + {c}_{2 n}^{2} + {b}_{2 n}^{2} - 2 \{ {e}_{3 n} {c}_{2 n} sin {θ}_{n} + {e}_{3 n} {b}_{2 n} cos ( {γ}_{n} + {θ}_{n} ) + {c}_{2 n} {b}_{2 n} sin {γ}_{n} \} ] + {\dot{β}}^{2} [ {\{ {e}_{3 n} sin ( α + {γ}_{n} + {θ}_{n} ) + {c}_{2 n} cos ( α + {γ}_{n} ) + {b}_{2 n} sin α \}}^{2} + {a}_{1 n}^{2} ] + {\dot{z}}_{0}^{2} + 2 \dot{θ} \dot{α} {e}_{3 n} \{ {e}_{3 n} - {c}_{2 n} sin {θ}_{n} + {b}_{2 n} cos ( {γ}_{n} + {θ}_{n} ) \} - 2 \dot{{θ}_{n}} \dot{β} {e}_{3 n} {a}_{1 n} cos ( α + {γ}_{n} + {θ}_{n} ) - 2 \dot{α} \dot{β} {a}_{1 n} \{ {e}_{3 n} cos ( α + {γ}_{n} + {θ}_{n} ) - {c}_{1 n} sin ( α + {γ}_{n} ) + {b}_{2 n} cos α \} + 2 {\dot{θ}}_{n} {\dot{z}}_{0} {e}_{3 n} cos ( α + {γ}_{n} + {θ}_{n} ) cos β + 2 \dot{α} {\dot{z}}_{0} \{ {e}_{3 n} cos ( α + {γ}_{n} + {θ}_{n} ) - {c}_{2 n} sin ( α + {γ}_{n} ) + {b}_{2 n} cos α \} cos β - 2 \dot{β} {\dot{z}}_{0} [ \{ {e}_{3 n} sin ( α + {γ}_{n} + {θ}_{n} ) + {c}_{2 n} sin ( α + {γ}_{n} ) + {b}_{2 n} sin α \} sin β + {α}_{1 n} cos β ] ⟩ & ( 2.48 ) \\ \begin{matrix}{T}_{wn}^{ro} = 0 \\ {U}_{wn} = {m}_{wn} g {z}_{wn} + \frac{1}{2} {{k}_{wn} ( {z}_{12 n} - {l}_{wn} )}^{2} \\ = {m}_{wn} g [ {z}_{0} + \{ {e}_{3 n} sin ( α + {γ}_{n} + {θ}_{n} ) + \\ {c}_{2 n} cos ( α + {γ}_{n} ) + {b}_{2 n} sin α \} cos β - {a}_{1 n} sin β ] + \\ \frac{1}{2} {{k}_{wn} ( {z}_{12 n} - {l}_{wn} )}^{2} \\ {F}_{wn} = - \frac{1}{2} {c}_{wn} {\dot{z}}_{12 n}^{2}\end{matrix} \\ \text{<Stabilizer>} & ( 2.49 ) \\ {T}_{zn}^{tr} ≅ 0 & ( 2.50 ) \\ {T}_{zn}^{ro} ≅ 0 & ( 2.51 ) \\ \begin{matrix}{U}_{zi , u} ≅ \frac{1}{2} {{k}_{zi} ( {z}_{zi} - {z}_{zu} )}^{2} \\ = \frac{1}{2} {k}_{zi} [ \{ {e}_{0 i} sin ( {γ}_{i} + {θ}_{i} ) + {c}_{2 i} cos {γ}_{i} \} - \\ { \{ {e}_{0 u} sin ( {γ}_{u} + {θ}_{u} ) + {c}_{2 u} cos {γ}_{u} \} ]}^{2} \\ = \frac{1}{2} {k}_{zi} {e}_{0 i}^{2} {\{ sin ( {γ}_{i} + {θ}_{i} ) + sin ( {γ}_{ii} + {θ}_{ii} ) \}}^{2}\end{matrix} \\ where {e}_{0 ii} = - {e}_{0 i} , {c}_{2 ii} = {c}_{2 i} , {γ}_{ii} = - {γ}_{i} & ( 2.52 ) \\ \begin{matrix}{U}_{ziu , iv} ≅ \frac{1}{2} {{k}_{ziu} ( {z}_{ziu} - {z}_{ziv} )}^{2} \\ = \frac{1}{2} {k}_{ziu} [ \{ {e}_{0 iu} sin ( {γ}_{iu} + {θ}_{iu} ) + {c}_{2 iii} cos {γ}_{iu} \} - \\ { \{ {e}_{0 iv} sin ( {γ}_{iv} + {θ}_{iv} ) + {c}_{2 iv} cos {γ}_{iv} \} ]}^{2} \\ = \frac{1}{2} {k}_{ziu} {e}_{0 iu}^{2} {\{ sin ( {γ}_{iu} + {θ}_{iii} ) + sin ( {γ}_{iv} + {θ}_{uv} ) \}}^{2}\end{matrix} \\ where {e}_{0 ii} = - {e}_{0 iu} , {c}_{2 iv} = {c}_{2 iu} , {γ}_{iv} = - {γ}_{iu} & \\ {F}_{zn} ≅ 0 & ( 2.53 )\end{matrix}$$

Therefore the total kinetic energy is:

$$\begin{matrix}{T}_{tot} = {T}_{b}^{tr} + {\sum }_{n = i}^{iv} \vert {T}_{sn}^{tr} + {T}_{an}^{tr} + {T}_{wn}^{tr} + {T}_{b}^{ro} + {T}_{an}^{ro} & ( 2.54 ) \\ \begin{matrix}\begin{matrix}\begin{matrix}\begin{matrix}\begin{matrix}\begin{matrix}\begin{matrix}\begin{matrix}\begin{matrix}{T}_{tot} = {T}_{b}^{tr} + {\sum }_{n = i}^{iv} \vert {T}_{sn}^{tr} + {T}_{an}^{tr} + {T}_{wn}^{tr} + {T}_{b}^{ro} + {T}_{an}^{ro} \vert = \\ \frac{1}{2} {m}_{b} ⟨ {\dot{α}}^{2} ( {b}_{0}^{2} + {c}_{0}^{2} ) + {\dot{β}}^{2} \{ {( {a}_{0} + {a}_{1 i} )}^{2} + {( {b}_{0} sin α + {c}_{0} cos α )}^{2} \} +\end{matrix} \\ {\dot{z}}_{0}^{2} - 2 \dot{α} \dot{β} ( {a}_{0} + {a}_{1 i} ) ( {b}_{0} cos α - {c}_{0} sin α ) -\end{matrix} \\ 2 \dot{β} {\dot{z}}_{0} \{ ( {a}_{0} + {a}_{1 i} ) cos β + ( {b}_{0} sin α + {c}_{0} cos α ) sin β \} +\end{matrix} \\ 2 \dot{a} {\dot{z}}_{0} ( {b}_{0} cos α - {c}_{0} sin α ) cos β ⟩ +\end{matrix} \\ {\sum }_{n = i}^{iv} \vert \frac{1}{2} {m}_{sn} ⟨ {\dot{z}}_{6 n}^{2} + {\dot{η}}_{n}^{2} {z}_{6 n}^{2} + {\dot{α}}^{2} [ {z}_{6 n}^{2} + {c}_{1 n}^{2} + {b}_{2 n}^{2} +\end{matrix} \\ 2 \{ {z}_{6 n} {c}_{1 n} cos {η}_{n} - {z}_{6 n} {b}_{2 n} sin ( {γ}_{n} + {η}_{n} ) - {c}_{1 n} {b}_{2 n} sin {γ}_{n} \} ] +\end{matrix} \\ {\dot{β}}^{2} [ {\{ {z}_{6 n} cos ( α + {γ}_{n} + {η}_{n} ) + {c}_{1 n} cos ( α + {γ}_{n} ) + {b}_{2 n} sin α \}}^{2} + {a}_{1 n}^{2} ] +\end{matrix} \\ {\dot{z}}_{0}^{2} + 2 {\dot{z}}_{6 n} \dot{α} \{ {c}_{1 n} sin {η}_{n} + {b}_{2 n} cos ( {γ}_{n} + {η}_{n} ) \} -\end{matrix} \\ 2 {\dot{z}}_{6 n} \dot{β} {a}_{1 n} cos ( α + {γ}_{n} + {η}_{n} ) +\end{matrix} & ( 2.55 ) \\ \begin{matrix}\begin{matrix}\begin{matrix}\begin{matrix}\begin{matrix}\begin{matrix}2 {\dot{η}}_{n} \dot{α} {z}_{6 n} \{ {z}_{6 n} + {c}_{1 n} cos {η}_{n} - {b}_{2 n} sin ( {γ}_{n} + {η}_{n} ) \} + \\ 2 {\dot{η}}_{n} \dot{α} {z}_{6 n} {a}_{1 n} sin ( α + {γ}_{n} + {η}_{n} ) +\end{matrix} \\ 2 \dot{α} \dot{β} {a}_{1 n} \{ {z}_{6 n} sin ( α + {γ}_{n} + {η}_{n} ) + {c}_{1 n} sin ( α + {γ}_{n} ) -\end{matrix} \\ {b}_{2 n} cos α \} + 2 {\dot{z}}_{6 n} {\dot{z}}_{0} cos ( α + {γ}_{n} + {η}_{n} ) cos β -\end{matrix} \\ 2 {\dot{η}}_{n} {\dot{z}}_{0} {\dot{z}}_{6 n} sin ( α + {γ}_{n} + {η}_{n} ) cos β +\end{matrix} \\ 2 \dot{α} {\dot{z}}_{0} \{ - {z}_{6 n} sin ( α + {γ}_{n} + {η}_{n} ) - {c}_{1 n} sin ( α + {γ}_{n} )\end{matrix} \\ + {b}_{2 n} cos α \} cos β - 2 \dot{β} {\dot{z}}_{0} [ \{ {z}_{6 n} cos ( α + {γ}_{n} + {η}_{n} ) -\end{matrix} & \\ \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}{c}_{1 n} cos ( α + {γ}_{n} ) + {b}_{2 n} sin α \} + {a}_{1 n} cos β ] ⟩ + \\ \frac{1}{2} {m}_{an} ⟨ {\dot{θ}}_{n}^{2} {e}_{1 n}^{2} + {\dot{α}}^{2} [ {e}_{1 n}^{2} + {c}_{2 n}^{2} + {b}_{2 n}^{2} -\end{matrix} \\ 2 \{ {e}_{1 n} {c}_{2 n} sin {θ}_{n} + {e}_{1 n} {b}_{2 n} cos ( {γ}_{n} + {θ}_{n} ) + {c}_{2 n} {b}_{2 n} sin {γ}_{n} \} ] +\end{matrix} \\ {\dot{β}}^{2} [ {\{ {e}_{1 n} sin ( α + {γ}_{n} + {θ}_{n} ) + {c}_{2 n} cos ( α + {γ}_{n} ) + {b}_{2 n} sin α \}}^{2} + {a}_{1 n}^{2} ] +\end{matrix} \\ {\dot{z}}_{0}^{2} + 2 \dot{θ} \dot{α} {e}_{1 n} \{ {e}_{1 n} - {c}_{2 n} sin {θ}_{n} + {b}_{2 n} cos ( {γ}_{n} + {θ}_{n} ) \} -\end{matrix} \\ 2 \dot{{θ}_{n}} \dot{β} {e}_{1 n} {a}_{1 n} cos ( α + {γ}_{n} + {θ}_{n} ) -\end{matrix} \\ 2 \dot{α} \dot{β} {a}_{1 n} \{ {e}_{1 n} cos ( α + {γ}_{n} + {θ}_{n} ) - {c}_{1 n} sin ( α + {γ}_{n} ) +\end{matrix} \\ {b}_{2 n} cos α \} + 2 {\dot{θ}}_{n} {\dot{z}}_{0} {e}_{1 n} cos ( α + {γ}_{n} + {θ}_{n} ) cos β +\end{matrix} \\ 2 \dot{α} {\dot{z}}_{0} \{ {e}_{1 n} cos ( α + {γ}_{n} + {θ}_{n} ) - {c}_{2 n} sin ( α + {γ}_{n} ) + {b}_{2 n} cos α \} cos β -\end{matrix} \\ 2 \dot{β} {\dot{z}}_{0} [ \{ {e}_{1 n} sin ( α + {γ}_{n} + {θ}_{n} ) + {c}_{2 n} sin ( α + {γ}_{n} ) + {b}_{2 n} sin α \} +\end{matrix} \\ {α}_{1 n} cos β ⟩ + \frac{1}{2} {m}_{wn} ⟨ {\dot{θ}}_{n}^{2} {e}_{3 n}^{2} + {\dot{α}}^{2} [ {e}_{3 n}^{2} + {c}_{2 n}^{2} + {b}_{2 n}^{2} -\end{matrix} \\ 2 \{ {e}_{3 n} {c}_{2 n} sin {θ}_{n} - {e}_{3 n} {b}_{2 n} cos ( {γ}_{n} + {θ}_{n} ) + {c}_{2 n} {b}_{2 n} sin {γ}_{n} \} ] +\end{matrix} \\ {\dot{β}}^{2} [ {\{ {e}_{3 n} sin ( α + {γ}_{n} + {θ}_{n} ) + {c}_{2 n} cos ( α + {γ}_{n} ) + {b}_{2 n} sin α \}}^{2} +\end{matrix} \\ {a}_{1 n}^{2} ] + {\dot{z}}_{0}^{2} + 2 \dot{θ} \dot{α} {e}_{3 n} \{ {e}_{3 n} - {c}_{2 n} sin {θ}_{n} + {b}_{2 n} cos ( {γ}_{n} + {θ}_{n} ) \} -\end{matrix} \\ 2 \dot{{θ}_{n}} \dot{β} {e}_{3 n} {a}_{1 n} cos ( α + {γ}_{n} + {θ}_{n} ) -\end{matrix} & \\ \begin{matrix}\begin{matrix}\begin{matrix}\begin{matrix}2 \dot{α} \dot{β} {a}_{1 n} \{ {e}_{3 n} cos ( α + {γ}_{n} + {θ}_{n} ) - {c}_{1 n} sin ( α + {γ}_{n} ) + {b}_{2 n} cos α \} + \\ 2 {\dot{θ}}_{n} {\dot{z}}_{0} {e}_{3 n} cos ( α + {γ}_{n} + {θ}_{n} ) cos β +\end{matrix} \\ 2 \dot{α} {\dot{z}}_{0} \{ {e}_{3 n} cos ( α + {γ}_{n} + {θ}_{n} ) - {c}_{2 n} sin ( α + {γ}_{n} ) + {b}_{2 n} cos α \} cos β -\end{matrix} \\ 2 \dot{β} {\dot{z}}_{0} [ \{ {e}_{3 n} sin ( α + {γ}_{n} + {θ}_{n} ) - {c}_{2 n} sin ( α + {γ}_{n} ) + {b}_{2 n} sin α \} +\end{matrix} \\ {α}_{1 n} cos β ⟩ + \frac{1}{2} ( {I}_{bx} {\dot{α}}^{2} + {I}_{by} {\dot{β}}^{2} ) + \frac{1}{2} {{I}_{anx} ( \dot{α} + {\dot{θ}}_{n} )}^{2} \vert\end{matrix} & \\ \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}= \frac{1}{2} [ {\dot{α}}^{2} {m}_{bb1} + {\dot{β}}^{2} \{ {m}_{ba1} + {{m}_{b} ( {b}_{0} sin α + {c}_{0} cos α )}^{2} \} + {\dot{z}}_{0}^{2} {m}_{b} - \\ 2 \dot{α (} \dot{β} {m}_{ba} - {\dot{z}}_{0} {m}_{b} cos β ) ( {b}_{0} cos α - {c}_{0} sin α ) -\end{matrix} \\ 2 \dot{β} {\dot{z}}_{0} \{ {m}_{ba} cos β + {m}_{b} ( {b}_{0} sin α + {c}_{0} cos α ) sin β \} ] + \frac{1}{2} {{\sum }_{n = i}}^{iv} \vert\end{matrix} \\ {m}_{sn} ( {\dot{z}}_{6 n}^{2} + {\dot{η}}_{n}^{2} {z}_{6 n}^{2} ) + {\dot{θ}}_{n}^{2} {m}_{aw21n} + {\dot{z}}_{0}^{2} {m}_{sawn} + {\dot{α}}^{2} ⟨ {m}_{saw1n} +\end{matrix} \\ {m}_{sn} {z}_{6 n} [ {z}_{6 n} + 2 {m}_{sn} \{ {c}_{1 n} cos {η}_{n} - {b}_{2 n} sin ( {γ}_{n} + {η}_{n} ) \} ] -\end{matrix} \\ 2 {m }_{aw1n} \{ {c}_{2 n} sin {θ}_{n} - {b}_{2 n} cos ( {γ}_{n} + {θ}_{n} ) \} ⟩ + {\dot{β}}^{2} ⟨ {m}_{saw2n} +\end{matrix} \\ {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} +\end{matrix} \\ {m}_{an} {\{ {e}_{1} sin ( α + {γ}_{n} + {θ}_{n} ) + {c}_{2 n} cos ( α + {γ}_{n} ) + {b}_{2 n} sin α \}}^{2} +\end{matrix} \\ {m}_{wn} {\{ {e}_{3} sin ( α + {γ}_{n} + {θ}_{n} ) + {c}_{2 n} cos ( α + {γ}_{n} ) + {b}_{2 n} sin α \}}^{2} ⟩ +\end{matrix} \\ 2 {\dot{z}}_{6 n} \dot{α} {m}_{sn} \{ {c}_{1 n} sin {η}_{n} + {b}_{2 n} cos ( {γ}_{n} + {η}_{n} ) \} -\end{matrix} \\ 2 {\dot{z}}_{6 n} \dot{β} {ma}_{1 n} cos ( α + {γ}_{n} + {η}_{n} ) + 2 {\dot{η}}_{n} \dot{α} {m}_{sn} {z}_{6 n} \{ {z}_{6 n} + {c}_{1 n} cos {η}_{n} -\end{matrix} \\ {b}_{2 n} sin ( {γ}_{n} + {η}_{n} ) \} + 2 {\dot{η}}_{n} \dot{β} {m}_{sn} {z}_{6 n} {a}_{1 n} sin ( α + {γ}_{n} + {η}_{n} ) +\end{matrix} \\ 2 \dot{θ} \dot{α} [ {m}_{aw21n} - {m}_{aw1n} \{ {c}_{2 n} sin {θ}_{n} - {b}_{2 n} cos ( {γ}_{n} + {θ}_{n} ) \} ] -\end{matrix} \\ 2 \dot{θ} \dot{β} {m}_{aw1n} {a}_{1 n} cos ( α + {γ}_{n} + {θ}_{n} ) +\end{matrix} \\ 2 \dot{α} \dot{β} {a}_{1 n} \{ {m}_{sawcn} sin ( α + {γ}_{n} ) - {m}_{sawbn} cos α +\end{matrix} & ( 2.56 ) \\ \begin{matrix}\begin{matrix}\begin{matrix}\begin{matrix}\begin{matrix}\begin{matrix}\begin{matrix}{m}_{sn} {z}_{6 n} sin ( α + {γ}_{n} + {η}_{n} ) - {m}_{aw1n} cos ( α + {γ}_{n} + {θ}_{n} ) \} + \\ 2 {\dot{z}}_{6 n} {\dot{z}}_{0} {m}_{sn} cos ( α + {γ}_{n} + {η}_{n} ) cos β -\end{matrix} \\ 2 ( \dot{α} + {\dot{η}}_{n} ) {\dot{z}}_{0} {z}_{6 n} {m}_{sn} sin ( α + {γ}_{n} + {η}_{n} ) cos β +\end{matrix} \\ 2 {\dot{θ}}_{n} {\dot{z}}_{0} {m}_{aw1n} cos ( α + {γ}_{n} + {θ}_{n} ) cos β +\end{matrix} \\ 2 \dot{α} {\dot{z}}_{0} \{ {m}_{aw1n} sin ( α + {γ}_{n} + {θ}_{n} ) -\end{matrix} \\ {m}_{sawcn} sin ( α + {γ}_{n} ) + {m}_{sawbn} cos α \} cos β -\end{matrix} \\ 2 \dot{β} {\dot{z}}_{0} [ \{ {z}_{6 n} {m}_{sn} cos ( α + {γ}_{n} + {η}_{n} ) - {m}_{aw1n} sin ( α + {γ}_{n} ) +\end{matrix} \\ {m}_{sawcn} cos ( α + {γ}_{n} ) + {m}_{sawbn} sin α \} sin β \} + {m}_{sawan} cos β ] ⟩ \vert\end{matrix} & \end{matrix}$$

Hereafter variables and coefficients which have index “n” implies implicit or explicit that they require summation with n=i, ii, iii, and iv.

The total potential energy is:

$$\begin{matrix}{U}_{tot} = {U}_{b} + {\sum }_{n = i}^{iv} \vert {U}_{sn} + {U}_{an} + {U}_{wn} + {U}_{zn} \vert & ( 2.58 ) \\ = {m}_{b} g \{ {z}_{0} - ( {a}_{0} + {a}_{1 n} ) sin β + ( {b}_{0} sin α + {c}_{0} cos α ) cos β \} + {\sum }_{n = i}^{iv} \vert {m}_{sn} g [ {z}_{0} + \{ {z}_{6 n} cos ( α + {γ}_{n} + {η}_{n} ) + {c}_{1 n} cos ( α + {γ}_{n} ) + {b}_{2 n} sin α \} cos β - {a}_{1 n} sin β ] + \frac{1}{2} {{k}_{sn} ( {z}_{6 n} - {l}_{sn} )}^{2} + {m}_{an} g [ {z}_{0} + \{ {e}_{1 n} sin ( α + {γ}_{n} + {θ}_{n} ) + {c}_{2 n} cos ( α + {γ}_{n} ) + {b}_{2 n} sin α \} cos β - {a}_{1 n} sin β ] + {m}_{wn} g [ {z}_{0} + \{ {e}_{3 n} sin ( α + {γ}_{n} + {θ}_{n} ) + {c}_{2 n} cos ( α + {γ}_{n} ) + {b}_{2 n} sin α \} cos β - {a}_{1 n} sin β ] + \frac{1}{2} {{k}_{wn} ( {z}_{12 n} - {l}_{wn} )}^{2} \vert + \frac{1}{2} {k}_{zi} {e}_{oi}^{2} {\{ sin ( {γ}_{i} + {θ}_{i} ) + sin ( {γ}_{ii} + {θ}_{ii} ) \}}^{2} + \\ \frac{1}{2} {k}_{ziii} {e}_{oiii}^{2} {\{ sin ( {γ}_{iii} + {θ}_{iii} ) + sin ( {γ}_{iv} + {θ}_{iv} ) \}}^{2} & ( 2.59 ) \\ = g \{ {z}_{0} {m}_{b} - {m}_{ba} sin β + {m}_{b} ( {b}_{0} sin α + {c}_{0} cos α ) cos β \} + {\sum }_{n = i}^{iv} ⟨ g [ \{ {z}_{0} {m}_{sawn} + {m}_{sn} {z}_{6 n} cos ( α + {γ}_{n} + {η}_{n} ) + {m}_{aw1n} sin ( α + {γ}_{n} + {θ}_{n} ) + {m}_{sawcn} cos ( α + {γ}_{n} ) + {m}_{sawbn} sin α \} cos β - {m}_{sawan} sin β ] + \frac{1}{2} {{k}_{sn} ( {z}_{6 n} - {l}_{sn} )}^{2} + \frac{1}{2} {{k}_{wn} ( {z}_{12 n} - {l}_{wn} )}^{2} ⟩ + + \frac{1}{2} {k}_{zi} {e}_{oi}^{2} {\{ sin ( {γ}_{i} + {θ}_{i} ) + sin ( {γ}_{ii} + {θ}_{ii} ) \}}^{2} + \frac{1}{2} {k}_{ziu} {e}_{oiu}^{2} {\{ sin ( {γ}_{iu} + {θ}_{iu} ) + sin ( {γ}_{iv} + {θ}_{iv} ) \}}^{2} & ( 2.60 ) \\ \begin{matrix}where \\ {m}_{ba} = {m}_{b} ( {a}_{0} + {a}_{1 i} ) \\ {m}_{sawan} = ( {m}_{sn} + {m}_{an} + {m}_{wn} ) {a}_{1 n} \\ {m}_{sawbn} = ( {m}_{sn} + {m}_{an} + {m}_{wn} ) {b}_{2 n} \\ {m}_{sawcn} = {m}_{sn} {c}_{1 n} + ( {m}_{an} + {m}_{wn} ) {c}_{2 n} \\ {γ}_{ii} = - {γ}_{i}\end{matrix} & ( 2.61 )\end{matrix}$$

The Lagrangian is written as:

$$\begin{matrix}L = {T}_{tot} - {U}_{tot} \\ = \frac{1}{2} [ {\dot{α}}^{2} {m}_{bb1} + {\dot{β}}^{2} \{ {m}_{ba1} + {{m}_{b} ( {b}_{0} sin α + {c}_{0} cos α )}^{2} \} + {\dot{z}}_{0}^{2} {m}_{b} - ( 2 \dot{α} \dot{β} {m}_{ba} - {\dot{z}}_{0} {m}_{b} cos β ) ( {b}_{0} cos α - {c}_{0} sin α ) ] - 2 \dot{β} {\dot{z}}_{0} \{ {m}_{ba} cos β + {m}_{b} ( {b}_{0} sin α + {c}_{0} cos α ) sin β \} ] + \frac{1}{2} {\sum }_{n = i}^{iv} \vert {m}_{sn} ( {\dot{z}}_{6 n}^{2} + {\dot{η}}_{n}^{2} {z}_{6 n}^{2} ) + {\dot{θ}}_{n}^{2} {m}_{aw21n} + {\dot{z}}_{0}^{2} {m}_{sawn} + {\dot{α}}^{2} ⟨ {m}_{saw1n} + {m}_{sn} {z}_{6 n} [ {z}_{6 n} + 2 \{ {c}_{1 n} cos {η}_{n} - {b}_{2 n} sin ( {γ}_{n} + {η}_{n} ) \} ] - 2 {m}_{aw1n} \{ {c}_{2 n} sin {θ}_{n} - {b}_{2 n} cos ( {γ}_{n} + {θ}_{n} ) \} ⟩ + {\dot{β}}^{2} ⟨ {m}_{saw2n} + {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} + {m}_{an} {\{ {e}_{1} sin ( α + {γ}_{n} + {θ}_{n} ) + {c}_{2 n} cos ( α + {γ}_{n} ) + {b}_{2 n} sin α \}}^{2} + {m}_{wn} {\{ {e}_{3} sin ( α + {γ}_{n} + {θ}_{n} ) + {c}_{2 n} cos ( α + {γ}_{n} ) + {b}_{2 n} sin α \}}^{2} ⟩ + 2 {\dot{z}}_{6 n} \dot{α} {m}_{sn} \{ {c}_{1 n} sin {η}_{n} + {b}_{2 n} cos ( {γ}_{n} + {η}_{n} ) \} - 2 {\dot{z}}_{6 n} \dot{β} {m}_{sn} {a}_{1 n} cos ( α + {γ}_{n} + {η}_{n} ) + 2 {\dot{η}}_{n} \dot{α} {m}_{sn} {z}_{6 n} \{ {z}_{6 n} + {c}_{1 n} cos {η}_{n} - {b}_{2 n} sin ( {γ}_{n} + {η}_{n} ) \} + 2 {\dot{η}}_{n} \dot{β} {m}_{sn} {z}_{6 n} {a}_{1 n} sin ( α + {γ}_{n} + {η}_{n} ) + 2 \dot{θ} \dot{α} [ {m}_{aw21n} - {m}_{aw1n} \{ {c}_{2 n} sin {θ}_{n} - {b}_{2 n} cos ( {γ}_{n} + {θ}_{n} ) \} ] - & ( 2.62 ) \\ 2 \dot{θ} \dot{β} {m}_{aw1n} {a}_{1 n} cos ( α + {γ}_{n} + {θ}_{n} ) + 2 \dot{α} \dot{β} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} + 2 {\dot{z}}_{0} \{ {\dot{z}}_{6 n} {m}_{sn} cos ( α + {γ}_{n} + {η}_{n} ) + ( \dot{α} + {\dot{θ}}_{n} ) {m}_{aw1n} cos ( α + {γ}_{n} + {θ}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α - \dot{β} {m}_{sawcn} \} cos β - 2 \dot{β} {\dot{z}}_{0} [ \{ {z}_{6 n} {m}_{sn} cos ( α + {γ}_{n} + {η}_{n} ) - {m}_{aw1n} sin ( α + {γ}_{n} + {θ}_{n} ) + {m}_{sawcn} cos ( α + {γ}_{n} ) + {m}_{sawbn} sin α \} sin β \} \vert - g \{ {z}_{0} {m}_{b} - {m}_{ba} sin β + {m}_{b} ( {b}_{0} sin α + {c}_{0} cos α ) cos β \} - \frac{1}{2} {k}_{zi} {e}_{oi}^{2} {\{ sin ( {γ}_{i} + {θ}_{i} ) + sin ( {γ}_{ii} + {θ}_{ii} ) \}}^{2} - \frac{1}{2} {k}_{ziii} {e}_{0 iii}^{2} {\{ sin ( {γ}_{iii} + {θ}_{iii} ) + sin ( {γ}_{iv} + {θ}_{iv} ) \}}^{2} - {\sum }_{n = i}^{iv} ⟨ g [ {z}_{0} {m}_{sawn} + \{ {m}_{sn} {z}_{6 n} cos ( α + {γ}_{n} + {η}_{n} ) + {m}_{aw1n} sin ( α + {γ}_{n} + {θ}_{n} ) + {m}_{sawcn} cos ( α + {γ}_{n} ) + {m}_{sawbn} sin α \} cos β - {m}_{sawan} sin β ] + \frac{1}{2} {{k}_{sn} ( {z}_{6 n} - {l}_{sn} )}^{2} + \frac{1}{2} {{k}_{wn} ( {z}_{12 n} - {l}_{wn} )}^{2} ⟩ & \\ \frac{\partial L}{\partial {z}_{0}} = - g ( {m}_{b} + {m}_{sawn} ) \\ \frac{\partial L}{\partial {\dot{z}}_{0}} = {\dot{z}}_{0} {m}_{b} + \dot{α} {m}_{b} cos β ( {b}_{0} cos α - {c}_{0} sin α ) - \dot{β} \{ {m}_{ba} cos β + {m}_{b} ( {b}_{0} sin α + {c}_{0} cos α ) sin β \} + {\dot{z}}_{0} {m}_{sawn} + \{ {z}_{6 n} {m}_{sn} cos ( α + {γ}_{n} + {η}_{n} ) + ( \dot{α} + {\dot{θ}}_{n} ) {m}_{aw1n} cos ( α + {γ}_{n} + {θ}_{n} ) - ( \dot{α} + {\dot{η}}_{n} ) {z}_{6 n} {m}_{sn} sin ( α + {γ}_{n} + {θ}_{n} ) - \dot{α} {m}_{sawcn} sin ( α + {γ}_{n} ) + \dot{α} {m}_{sawbn} cos α - \dot{β} {m}_{sawan} \} cos β - \dot{β} \{ {m}_{aw1n} sin ( α + {γ}_{n} + {θ}_{n} ) - {z}_{6 n} {m}_{sn} cos ( α + {γ}_{n} + {η}_{n} ) + {m}_{sawcn} cos ( α + {γ}_{n} ) + {m}_{sawbn} sin α \} sin β & ( 2.63 ) \\ \frac{ⅆ}{ⅆ t} ( \frac{\partial L}{\partial {\dot{z}}_{0}} ) = {\ddot{z}}_{0} ( {m}_{b} - {m}_{sawn} ) + \ddot{α} {m}_{b} ( {b}_{0} cos α - {c}_{0} sin α ) - \dot{β} \dot{α} {m}_{b} sin β ( {b}_{0} cos α - {c}_{0} sin α ) + {\dot{α}}^{2} {m}_{b} cos β ( {b}_{0} sin α + {c}_{0} cos α ) - \ddot{β} \{ {m}_{ba} cos β + {m}_{b} ( {b}_{0} sin α + {c}_{0} cos α ) sin β \} + \dot{β} \{ \dot{β} {m}_{ba} sin β + \dot{α} {m}_{b} ( {b}_{0} cos α - {c}_{0} sin α ) sin β + \dot{β} {m}_{b} ( {b}_{0} sin α + {c}_{0} cos α ) cos β \} + \{ {\ddot{z}}_{6 n} {m}_{sn} cos ( α + {γ}_{n} + {η}_{n} ) + ( \dot{α} + {\dot{η}}_{n} ) {\dot{z}}_{6 n} {m}_{sn} sin ( α + {γ}_{n} + {η}_{n} ) \} - ( \ddot{α} + {\ddot{η}}_{n} ) {z}_{6 n} {m}_{sn} sin ( α + {γ}_{n} + {η}_{n} ) - ( \dot{α} + {\dot{η}}_{n} ) {\dot{z}}_{6 n} {m}_{sn} sin ( α + {γ}_{n} + {η}_{n} ) - {( \dot{α} + {\dot{η}}_{n} )}^{2} {z}_{6 n} {m}_{sn} cos ( α + {γ}_{n} + {η}_{n} ) - \ddot{α} {m}_{sawcn} sin ( α + {γ}_{n} ) - {\dot{α}}^{2} {m}_{sawcn} sin ( α + {γ}_{n} ) + \ddot{α} {m}_{sawbn} cos α - {α}^{2} {m}_{sawbn} sin α - \ddot{β} {m}_{sawan} \} cos β - \dot{β} \{ {\dot{z}}_{6 n} {m}_{sn} cos ( α + {γ}_{n} + {η}_{n} ) + ( \dot{α} + {\dot{θ}}_{n} ) {m}_{aw1n} cos ( α + {γ}_{n} + {θ}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) - \dot{α} {m}_{sawbn} cos α - \dot{β} {m}_{sawan} \} sin β - \ddot{β} \{ {m}_{aw1n} sin ( α + {γ}_{n} + {θ}_{n} ) + {z}_{6 n} {m}_{sn} cos ( α + {γ}_{n} + {η}_{n} ) + {m}_{awcn} cos ( α + {γ}_{n} ) + {m}_{sawbn} sin α \} sin β - \dot{β} \{ ( \dot{α} + {\dot{θ}}_{n} ) {m}_{aw1n} cos ( α + {γ}_{n} + {θ}_{n} ) + {z}_{6 n} {m}_{sn} cos ( α + {γ}_{n} + {η}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α \} sin β - {\dot{β}}^{2} \{ {m}_{aw1n} sin ( α + {γ}_{n} + {θ}_{n} ) - {z}_{6 n} {m}_{sn} cos ( α + {γ}_{n} + {η}_{n} ) + {m}_{sawcn} cos ( α + {γ}_{n} ) + {m}_{sawbn} sin α \} cos β & \\ \frac{\partial L}{\partial β} = - \dot{α} \dot{{z}_{0}} {m}_{b} sin β ( {b}_{0} cos α - {c}_{0} sin α ) + \dot{β} {\dot{z}}_{0} \{ {m}_{ba} sin β - {m}_{b} ( {b}_{0} sin α - {c}_{0} cos α ) cos β \} ) g \{ {m}_{ba} cos β + {m}_{b} ( {b}_{0} sin α + {c}_{0} cos α ) sin β + ⟨ g [ \{ {m}_{sn} {z}_{6 n} cos ( α + {γ}_{n} + {η}_{n} ) + {m}_{aw1n} sin ( α + {γ}_{n} + {θ}_{n} ) + {m}_{sawcn} cos ( α + {γ}_{n} ) + {m}_{sawbn} sin α \} sin β + {m}_{sawan} cos β ] - {\dot{z}}_{0} \{ {\dot{z}}_{6 n} {m}_{sn} cos ( α + {γ}_{n} + {η}_{n} ) + ( \dot{α} + {\dot{θ}}_{n} ) {m}_{aw1n} cos ( α + {γ}_{n} + {θ}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α - \dot{β} {m}_{sawan} \} sin β + \dot{β} {\dot{z}}_{0} \{ {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} cos β ⟩ & \\ \frac{\partial L}{\partial α} = \{ {\dot{β}}^{2} {m}_{b} ( {b}_{0} cos α - {c}_{0} sin α ) + \dot{α} \dot{β } {m}_{ba} \} ( {b}_{0} sin α + {c}_{0} cos α ) - \dot{α} \dot{{z}_{0}} {m}_{b} cos β ( {b}_{0} sin α - {c}_{0} cos α ) - \dot{β} {\dot{z}}_{0} {m}_{b} ( {b}_{0} cos α - {c}_{0} sin α ) sin β + \vert {\dot{β}}^{2} ⟨ {m}_{sn} \{ {z}_{6 n} cos ( α + {γ}_{n} + {η}_{n} ) + {c}_{1 n} cos ( α + {γ}_{n} ) + {b}_{2 n} sin α \} \{ - {z}_{6 n} sin ( α + {γ}_{n} + {η}_{n} ) - {c}_{1 n} sin ( α + {γ}_{n} ) + {b}_{2 n} cos α \} + {m}_{an} \{ {e}_{1 n} sin ( α + {γ}_{n} + {θ}_{n} ) + {c}_{2 n} cos ( α + {γ}_{n} ) + {b}_{2 n} sin α \} \{ {e}_{1} cos ( α + {γ}_{n} + {θ}_{n} ) - {c}_{2 n} sin ( α + {γ}_{n} ) + {b}_{2 n} cos α \} + {m}_{wn} \{ {e}_{3 n} sin ( α + {γ}_{n} + {θ}_{n} ) + {c}_{2 n} cos ( α + {γ}_{n} ) + {b}_{2 n} sin α \} \{ {e}_{3} cos ( α + {γ}_{n} + {θ}_{n} ) - {c}_{2 n} sin ( α + {γ}_{n} ) + {b}_{2 n} cos α \} ⟩ + {\dot{z}}_{6 n} \dot{β} {m}_{sn} {a}_{1 n} sin ( α + {γ}_{n} + {η}_{n} ) + {\dot{η}}_{n} \dot{β} {m}_{sn} {z}_{6 n} {a}_{1 n} cos ( α + {γ}_{n} + {η}_{n} ) + \dot{θ} \dot{β} {m}_{aw1n} {a}_{1 n} sin ( α + {γ}_{n} + {θ}_{n} ) + \dot{α} \dot{β} {a}_{1 n} \{ {m}_{sawcn} cos ( α + {γ}_{n} ) + {m}_{sawbn} sin α + {m}_{sn} {z}_{6 n} cos ( α + {γ}_{n} + {η}_{n} ) + {m}_{aw1n} sin ( α + {γ}_{n} + {θ}_{n} ) \} - {\dot{z}}_{0} ( {\dot{z}}_{6 n} {m}_{sn} sin ( α + {γ}_{n} + {η}_{n} ) + ( \dot{α} + {\dot{θ}}_{n} ) {m}_{aw1n} sin ( α + {γ}_{n} + {θ}_{n} ) + ( \dot{α} + {\dot{η}}_{n} ) {z}_{6 n} {m}_{sn} cos ( α + {γ}_{n} + {η}_{n} ) + \dot{α} {m}_{sawcn} cos ( α + {γ}_{n} ) + \dot{α} {m}_{sawbn} sin α \} cos β - \dot{β} {\dot{z}}_{0} [ \{ {m}_{aw1n} cos ( α + {γ}_{n} + {θ}_{n} ) - {z}_{6 n} {m}_{sn} sin ( α + {γ}_{n} + {η}_{n} ) - {m}_{sawcn} sin ( α + {γ}_{n} ) + {m}_{sawbn} cos α \} sin β \vert - {gm}_{b} ( {b}_{0} cos α - {c}_{0} sin α ) cos β + g \{ {m}_{sn} {z}_{6 n} sin ( α + {γ}_{n} + {η}_{n} ) - {m}_{aw1n} cos ( α + {γ}_{n} + {θ}_{n} ) + {m}_{sawcn} sin ( α + {γ}_{n} ) - {m}_{sawbn} cos α \} cos β & ( 2.64 ) \\ \frac{\partial L}{\partial {η}_{n}} = {\dot{α}}^{2} {m}_{sn} {z}_{6 n} \{ - {c}_{1 n} sin {η}_{n} - {b}_{2 n} cos ( {γ}_{n} + {η}_{n} ) \} + {\dot{β}}^{2} {m}_{sn} \{ {z}_{6 n} cos ( α + {γ}_{n} + {η}_{n} ) + {c}_{1 n} cos ( α + {γ}_{n} ) + {b}_{2 n} sin α \} \{ - {z}_{6 n} sin ( α + {γ}_{n} + {η}_{n} ) \} + {\dot{z}}_{6 n} \dot{α} {m}_{sn} \{ {c}_{1 n} cos {η}_{n} - {b}_{2 n} sin ( {γ}_{n} + {η}_{n} ) \} + {\dot{z}}_{6 n} \dot{β} {m}_{sn} {a}_{1 n} sin ( α + {γ}_{n} + {η}_{n} ) - {\dot{η}}_{n} \dot{α} {m}_{sn} {z}_{6 n} \{ {c}_{1 n} sin {η}_{n} + {b}_{2 n} cos ( {γ}_{n} + {η}_{n} ) \} + {\dot{η}}_{n} \dot{β } {m}_{sn} {z}_{6 n} {a}_{1 n} cos ( α + {γ}_{n} + {η}_{n} ) + \dot{α} \dot{β} {a}_{1 n} {m}_{sn} {z}_{6 n} cos ( α + {γ}_{n} + {η}_{n} ) + {gm}_{sn} {z}_{6 n} sin ( α + {γ}_{n} + {η}_{n} ) \} cos β - {\dot{z}}_{0} \{ {\dot{z}}_{6 n} {m}_{sn} sin ( α + {γ}_{n} + {η}_{n} ) + ( \dot{α} + {\dot{η}}_{n} ) {z}_{6 n} {m}_{sn} cos ( α + {γ}_{n} + {η}_{n} ) \} \\ cos β + \dot{β} {\dot{z}}_{0} {z}_{6 n} {m}_{sn} sin ( α + {γ}_{n} + {η}_{n} ) sin β & ( 2.65 ) \\ \frac{\partial L}{\partial {θ}_{n}} = - {k}_{zi} {e}_{0 i}^{2} \{ sin ( {γ}_{i} + {θ}_{i} ) + sin ( {γ}_{ii} + {η}_{ii} ) \} \{ cos ( {γ}_{i} + {θ}_{i} ) + cos ( {r}_{ii} + {θ}_{ii} ) \} - {k}_{ziii} {e}_{0 iii}^{2} \{ sin ( {γ}_{iii} + {θ}_{iii} ) + sin ( {γ}_{iv} + {θ}_{iv} ) \} cos ( {γ}_{iii} + {θ}_{iii} ) + cos ( {γ}_{iv} + {θ}_{iv} ) \} - {\dot{α}}^{2} {m}_{aw1n} \{ {c}_{2 n} cos {θ}_{n} + {b}_{2 n} sin ( {γ}_{n} + {θ}_{n} ) \} + {\dot{β}}^{2} ⟨ {m}_{an} \{ {e}_{1 n} sin ( α + {γ}_{n} + {θ}_{n} ) + {c}_{2 n} cos ( α + {γ}_{n} ) + {b}_{2 n} sin α \} {e}_{1 n} cos ( ( α + {γ}_{n} + {θ}_{n} ) + {m}_{wn} \{ {e}_{3 n} sin ( α + {γ}_{n} + {θ}_{n} ) + {c}_{2 n} cos ( α + {γ}_{n} ) + {b}_{2 n} sin α \} {e}_{3 n} cos ( α + {γ}_{n} + {θ}_{n} ) ⟩ - \dot{θ} \dot{α} {m}_{aw1n} \{ {c}_{2 n} cos {θ}_{n} + {b}_{2 n} sin ( {γ}_{n} + {θ}_{n} ) \} + \dot{θ} {\dot{β}}_{aw1n} {a}_{1 n} sin ( α + {γ}_{n} + {θ}_{n} ) + \dot{α} \dot{β} {a}_{1 n} {m}_{aw1n} sin ( α + {γ}_{n} + {θ}_{n} ) - {gm}_{aw1n} cos ( α + {γ}_{n} + {η}_{n} ) \} cos β - {\dot{z}}_{0} ( \dot{α} + {\dot{θ}}_{n} ) {m}_{aw1n} sin ( α + {γ}_{n} + {θ}_{n} ) \} cos β - \\ \dot{β} {\dot{z}}_{0} {m}_{aw1n} cos ( α + {γ}_{n} + {θ}_{n} ) sin β & ( 2.66 ) \\ \frac{\partial L}{\partial {z}_{6 n}} = {m}_{sn} {\dot{η}}_{n}^{2} {z}_{6 n} + {\dot{α}}^{2} {m}_{sn} [ {z}_{6 n} + \{ {c}_{1 n} cos {η}_{n} - {b}_{2 n} sin ( {γ}_{n} + {η}_{n} ) \} ] + {\dot{β}}^{2} {m}_{sn} \{ {z}_{6 n} cos ( α + {γ}_{n} + {η}_{n} ) + {c}_{1 n} cos ( α + {γ}_{n} ) + {b}_{2 n} sin α \} cos ( α + {γ}_{n} + {η}_{n} ) + {\dot{η}}_{n} \dot{α} {m}_{sn} \{ 2 {z}_{6 n} + {c}_{1 n} cos {η}_{n} - {b}_{2 n} sin ( {γ}_{n} + {η}_{n} ) \} + {\dot{η}}_{n} \dot{β} {m}_{sn} {a}_{1 n} sin ( α + {γ}_{n} + {η}_{n} ) + \dot{α} \dot{β} {a}_{1 n} {m}_{sn} sin ( α + {γ}_{n} + {η}_{n} ) - g {\dot{m}}_{sn} cos ( α + {γ}_{n} + {η}_{n} ) cos β - {k}_{sn} ( {z}_{6 n} - {l}_{sn} ) - ( \dot{α} + {\dot{η}}_{n} ) {\dot{z}}_{0} {m}_{sn} sin ( α + {γ}_{n} + {η}_{n} ) cos β - \dot{β} {\dot{z}}_{0} {m}_{sn} cos ( α + {γ}_{n} + {η}_{n} ) sin β & ( 2.67 ) \\ \frac{\partial L}{\partial {z}_{12 n}} = - {k}_{wn} ( {z}_{12 n} - {l}_{wn} ) & ( 2.68 ) \\ \frac{\partial L}{\partial \dot{β}} = \dot{β} ⟨ {m}_{saw2n} + {m}_{ba1} + {{m}_{b} ( {b}_{0} sin α + {c}_{0} cos α )}^{2} + {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} + {m}_{an} {\{ {e}_{1 n} sin ( α + {γ}_{n} + {θ}_{n} ) + {c}_{2 n} cos ( α + {γ}_{n} ) + {b}_{2 n} sin α \}}^{2} + {m}_{wn} {\{ {e}_{3 n} sin ( α + {γ}_{n} + {θ}_{n} ) + {c}_{2 n} cos ( α + {γ}_{n} ) + {b}_{2 n} sin α \}}^{2} ⟩ - \dot{α} {m}_{ba} ( {b}_{0} cos α - {c}_{0} sin α ) - {\dot{z}}_{6 n} {m}_{sn} {a}_{1 n} cos ( α + {γ}_{n} + {η}_{n} ) + {\dot{η}}_{n} {m}_{sn} {z}_{6 n} {a}_{1 n} sin ( α + {γ}_{n} + {η}_{n} ) - \dot{θ} {m}_{aw1n} {a}_{1 n} cos ( α + {γ}_{n} + {θ}_{n} ) + \dot{α} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} - {\dot{z}}_{0} [ \{ {m}_{b} {b}_{0} sin α + {c}_{0} cos α ) + {m}_{aw1n} sin ( α + {γ}_{n} + {η}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} sin β + ( {m}_{ba} + {m}_{sawcn} ) cos β ] & ( 2.69 ) \\ \frac{ⅆ}{ⅆ t} ( \frac{\partial L}{\partial \dot{β}} ) = \ddot{β} ⟨ {m}_{saw2n} + {m}_{ba1} + {{m}_{b} ( {b}_{0} sin α + {c}_{0} cos α )}^{2} + {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} + {m}_{an} {\{ {e}_{1 n} sin ( α + {γ}_{n} + {θ}_{n} ) + {c}_{2 n} cos ( α + {γ}_{n} ) + {b}_{2 n} sin α \}}^{2} + {m}_{wn} {\{ {e}_{3 n} sin ( α + {γ}_{n} + {θ}_{n} ) + {c}_{2 n} cos ( α + {γ}_{n} ) + {b}_{2 n} sin α \}}^{2} ⟩ + 2 \dot{β} ⟨ \dot{α} {m}_{ba} ( {b}_{0} sin α + {c}_{0} cos α ) ( {b}_{0} cos α - {c}_{0} sin α ) {m}_{sn} \{ {z}_{6 n} cos ( α + {γ}_{n} + {η}_{n} ) + {c}_{1 n} cos ( α + {γ}_{n} ) + {b}_{2 n} sin α \} + \{ {\dot{z}}_{6 n} cos ( α + {γ}_{n} + {η}_{n} ) - ( \dot{α} + \dot{η} ) {z}_{6 n} sin ( α + {γ}_{n} + {η}_{n} ) - \dot{α} [ {c}_{1 n} sin ( α + {γ}_{n} ) - {b}_{2 n} cos α ] \} + {m}_{an} \{ {e}_{1 n} sin ( α + {γ}_{n} + {θ}_{n} ) + {c}_{2 n} cos ( α + {γ}_{n} ) + {b}_{2 n} sin α \} \{ ( \dot{α} + {\dot{θ}}_{n} ) {e}_{1 n} cos ( α + {γ}_{n} + {θ}_{n} ) - & ( 2.70 ) \\ \dot{α} [ {c}_{2 n} sin ( α + {γ}_{n} ) - {b}_{2 n} cos α ] \} + {m}_{wn} \{ {e}_{3 n} sin ( α + {γ}_{n} + {θ}_{n} ) + {c}_{2 n} cos ( α + {γ}_{n} ) + {b}_{2 n} sin α \} \{ ( \dot{α} + {\dot{θ}}_{n} ) {e}_{3 n} sin ( α + {γ}_{n} + {θ}_{n} ) - \dot{α} [ {c}_{2 n} sin ( α + {γ}_{n} ) - {b}_{2 n} cos α ] \} ⟩ - \ddot{α} {m}_{ba} ( {b}_{0} cos α - {c}_{0} sin α ) + {\dot{α}}^{2} {m}_{ba} ( {b}_{0} sin α - {c}_{0} cos α ) - {\ddot{z}}_{6 n} {m}_{sn} {a}_{1 n} cos ( α + {γ}_{n} + {η}_{n} ) + {\dot{z}}_{6 n} ( \dot{α} + {\dot{η}}_{n} ) {m}_{sn} {a}_{1 n} sin ( α + {γ}_{n} + {η}_{n} ) + {\ddot{η}}_{n} {m}_{sn} {z}_{6 n} {a}_{1 n} sin ( α + {γ}_{n} + {η}_{n} ) - {\dot{η}}_{n} {m}_{sn} {\dot{z}}_{6 n} {a}_{1 n} sin ( α + {γ}_{n} + {η}_{n} ) + {\dot{η}}_{n} ( \dot{a} + {\dot{η}}_{n} ) {m}_{sn} {z}_{6 n} {a}_{1 n} cos ( α + {γ}_{n} + {η}_{n} ) - {\ddot{θ}}_{6 n} {m}_{aw1n} {a}_{1 n} cos ( α + {γ}_{n} + {θ}_{n} ) + {\dot{θ}}_{n} ( \dot{α} + {\dot{θ}}_{n} ) {m}_{aw1n} {a}_{1 n} sin ( α + {γ}_{n} + {θ}_{n} ) + & \\ \ddot{α} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} \dot{α} {a}_{1 n} \{ \dot{α} {m}_{sawcn} cos ( α + {γ}_{n} ) + \dot{α} {m}_{sawbn} sin α + ( \dot{α} + {\dot{η}}_{n} ) {m}_{sn} {a}_{6 n} cos ( α + {γ}_{n} + {η}_{n} ) + {m}_{sn} {\dot{z}}_{6 n} sin ( α + {γ}_{n} + {η}_{n} ) + ( \dot{α} + {\dot{θ}}_{n} ) {m}_{aw1n} sin ( α + {γ}_{n} + {θ}_{n} ) \} - {\ddot{z}}_{0} [ \{ {m}_{b} ( {b}_{0} sin α - {c}_{0} cos α ) + {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} sin β + ( {m}_{ba} + {m}_{sawan} cos β ] - {\dot{z}}_{0} [ \{ \dot{α} {m}_{b} ( {b}_{0} cos α - {c}_{0} sin α ) + ( \dot{α} + {\dot{θ}}_{n} ) {m}_{aw1n} cos ( α + {γ}_{n} + {θ}_{n} ) + {z}_{6 n} {m}_{sn} cos ( α + {γ}_{n} + {η}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α \} sin β + \dot{β} \{ {m}_{b} ( {b}_{0} sin α + {c}_{0} cos α ) + {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} cos β - \dot{β} ( {m}_{ba} + {m}_{sawan} ) cos β ] & \\ \frac{\partial L}{\partial \dot{α}} = \dot{α} {m}_{bb1} - \dot{β} {m}_{ba} ( {b}_{0} cos α - {c}_{0} sin α ) + {\dot{z}}_{0} {m}_{b} cos β ( {b}_{0} cos α - {c}_{0} sin α ) + \dot{α} ⟨ {m}_{saw1n} + {m}_{sn} {z}_{6 n} [ {z}_{6 n} + 2 \{ {c}_{1 n} cos {η}_{n} - {b}_{2 n} sin ( {γ}_{n} + {η}_{n} ) \} ] - 2 {m}_{aw1n} \{ {c}_{2 n} sin {θ}_{n} - {b}_{2 n} cos ( {γ}_{n} + {θ}_{n} ) \} ⟩ + {\dot{z}}_{6 n} {m}_{sn} \{ {c}_{1 n} sin {η}_{n} + {b}_{2 n} cos ( {γ}_{n} + {η}_{n} ) \} + {\dot{η}}_{n} {m}_{sn} {z}_{6 n} \{ {z}_{6 n} + {c}_{1 n} cos {η}_{n} - {b}_{2 n} sin ( {γ}_{n} + {η}_{n} ) \} + \dot{β} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} + {\dot{z}}_{0} \{ {m}_{aw1n} cos ( α + {γ}_{n} + {θ}_{n} ) - {z}_{6 n} {m}_{sn} sin ( α + {γ}_{n} + {η}_{n} ) - {m}_{sawcn} sin ( α + {γ}_{n} ) + {m}_{sawbn} cos α \} cos β & ( 2.71 ) \\ \frac{ⅆ}{ⅆ t} ( \frac{\partial L}{\partial \dot{α}} ) = - \ddot{β} {m}_{ba} ( {b}_{0} cos α - {c}_{0} sin α ) + \dot{β} \dot{α} {m}_{ba} ( {b}_{0} sin α + {c}_{0} cos α ) + {\ddot{z}}_{0} {m}_{b} cos β ( {b}_{0} cos α - {c}_{0} sin α ) - β {z}_{0} {m}_{b} sin β ( {b}_{0} cos α - {c}_{0} sin α ) + \dot{α} {\dot{z}}_{0} {m}_{b} cos β ( {b}_{0} sin α + {c}_{0} cos α ) + \ddot{α} ⟨ {m}_{bb1} + {m}_{saw1n} + {m}_{sn} {z}_{6 n} [ {z}_{6 n} + 2 \{ {c}_{1 n} cos {η}_{n} - {b}_{2 n} sin ( {γ}_{n} + {η}_{n} ) \} ] - 2 {m}_{aw1n} \{ {c}_{2 n} sin {θ}_{n} - {b}_{2 n} cos ( {γ}_{n} + {θ}_{n} ) \} ⟩ + \dot{α} ⟨ {m}_{sn} {\dot{z}}_{6 n} [ {z}_{6 n} + 2 \{ {c}_{1 n} cos {η}_{n} - {b}_{2 n} sin ( {γ}_{n} + {η}_{n} ) \} ] + {m}_{sn} {z}_{6 n} [ {\dot{z}}_{6 n} + 2 {\dot{η} }_{n} \{ {c}_{1 n} sin {η}_{n} + {b}_{2 n} cos ( {γ}_{n} + {η}_{n} ) \} ] - 2 {\dot{θ}}_{n} {m}_{aw1n} \{ {c}_{2 n} cos {θ}_{n} + {b}_{2 n} sin ( {γ}_{n} + {θ}_{n} ) \} ⟩ + {\ddot{z}}_{6 n} {m}_{sn} \{ {c}_{1 n} sin {η}_{n} + {b}_{2 n} cos ( {γ}_{n} + {η}_{n} ) \} + {\dot{z}}_{6 n} {\dot{η}}_{n} {m}_{sn} \{ {c}_{1 n} cos {η}_{n} - {b}_{2 n} sin ( {γ}_{n} + {η}_{n} ) \} + {\ddot{η}}_{n} {m}_{sn} {z}_{6 n} \{ {z}_{6 n} + {c}_{1 n} cos {η}_{n} - {b}_{2 n} sin ( {γ}_{n} + {η}_{n} ) \} + {\dot{η}}_{n} {m}_{sn} {\dot{z}}_{6 n} \{ {z}_{6 n} + {c}_{1 n} cos {η}_{n} - {b}_{2 n} sin ( {γ}_{n} + {η}_{n} ) \} + {\dot{η}}_{n} {m}_{sn} {z}_{6 n} \{ {\dot{z}}_{6 n} - {\dot{η}}_{n} [ {c}_{1 n} sin {η}_{n} + {b}_{2 n} cos ( {γ}_{n} + {η}_{n} ) ] \} + \ddot{θ} [ {m}_{aw21n} - {m}_{aw1n} \{ {c}_{2 n} sin {θ}_{n} - {b}_{2 n} cos ( {γ}_{n} + {η}_{n} ) \} ] - & ( 2.72 ) \\ {\dot{θ}}_{n}^{2} {m}_{aw1n} \{ {c}_{2 n} cos {θ}_{n} + {b}_{2 n} sin ( {γ}_{n} + {θ}_{n} ) \} ] + \ddot{β} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} + \dot{β} {a}_{1 n} \{ \dot{α} [ {m}_{sawcn} cos ( α + {γ}_{n} ) + {m}_{sawbn} sin α ] + {m}_{sn} {\dot{z}}_{6 n} sin ( α + {γ}_{n} + {η}_{n} ) + \dot{β} {a}_{1 n} \{ \dot{α} [ {m}_{sawcn} cos ( α + {γ}_{n} ) + {m}_{sawbn} sin α ] + {m}_{sn} {\dot{z}}_{6 n} sin ( α + {γ}_{n} + {η}_{n} ) + ( \dot{α} + {\dot{η}}_{n} ) {m}_{sn} {z}_{6 n} cos ( α + {γ}_{n} + {η}_{n} ) + ( \dot{α} + {\dot{θ}}_{n} ) {m}_{aw1n} sin ( α + {γ}_{n} + {θ}_{n} ) \} - {\ddot{z}}_{0} \{ {m}_{aw1n} cos ( α + {γ}_{n} + {θ}_{n} ) + {z}_{6 n} {m}_{sn} sin ( α + {γ}_{n} + {η}_{n} ) - {m}_{sawcn} sin ( α + {γ}_{n} ) + {m}_{sawbn} cos α \} cos β - {\dot{z}}_{0} \{ - ( \dot{α} + {\dot{θ}}_{n} ) {m}_{aw1n} sin ( α + {γ}_{n} + {θ}_{n} ) + {\dot{z}}_{6 n} {m}_{sn} sin ( α + {γ}_{n} + {η}_{n} ) - ( \dot{α} + {\dot{η}}_{n} ) {z}_{6 n} {m}_{sn} cos ( α + {γ}_{n} + {η}_{n} ) - \dot{α} {m}_{sawcn} cos ( α + {γ}_{n} ) - \dot{α} {m}_{sawbn} sin α \} cos β - \dot{β} {\dot{z}}_{0} \{ {m}_{aw1n} cos ( α + {γ}_{n} + {θ}_{n} ) - {z}_{6 n} {m}_{sn} sin ( α + {γ}_{n} + {η}_{n} ) - {m}_{sawcn} sin ( α + {γ}_{n} ) + {m}_{sawbn} cos α \} sin β & \\ \frac{\partial L}{\partial {\dot{η}}_{n}} = {m}_{sn} {\dot{η}}_{n} {z}_{6 n}^{2} + \dot{α} {m}_{sn} {z}_{6 n} \{ {z}_{6 n} + {c}_{1 n} cos {η}_{n} - {b}_{2 n} sin ( {γ}_{n} + {η}_{n} ) \} + \dot{β} {m}_{sn} {z}_{6 n} {a}_{1 n} sin ( α + {γ}_{n} + {η}_{n} ) - {\dot{z}}_{0} {z}_{6 n} {m}_{sn} sin ( α + {γ}_{n} + {η}_{n} ) cos β & ( 2.73 ) \\ \frac{ⅆ}{ⅆ t} ( \frac{\partial L}{\partial \dot{α}} ) = {m}_{sn} {\ddot{η}}_{n} {z}_{6 n}^{2} + 2 {m}_{sn} {\dot{η}}_{n} {\dot{z}}_{6 n} {z}_{6 n} + \ddot{α} {m}_{sn} {z}_{6 n} \{ {z}_{6 n} + {c}_{1 n} cos {η}_{n} - {b}_{2 n} sin ( {γ}_{n} + {η}_{n} ) \} + \dot{α} {m}_{sn} {\dot{z}}_{6 n} \{ {z}_{6 n} + {c}_{1 n} cos {η}_{n} - {b}_{2 n} sin ( {γ}_{n} + {η}_{n} ) \} + \dot{α} {m}_{sn} {z}_{6 n} [ {\dot{z}}_{6 n} - {\dot{η} }_{n} [ {c}_{1 n} sin {η}_{n} + {b}_{2 n} cos ( {γ}_{n} + {η}_{n} ) \} ] + \ddot{β} {m}_{sn} {z}_{6 n} {a}_{1 n} sin ( α + {γ}_{n} + {η}_{n} ) + \dot{β} {m}_{sn} {\dot{z}}_{6 n} {a}_{1 n} sin ( α + {γ}_{n} + {η}_{n} ) + \dot{β} ( \dot{α} + {\dot{η}}_{n} ) {m}_{sn} {z}_{6 n} {a}_{1 n} cos ( α + {γ}_{n} + {η}_{n} ) - {\ddot{z}}_{0} {z}_{6 n} {m}_{sn} sin ( α + {γ}_{n} + {η}_{n} ) cos β - {\dot{z}}_{0} {z}_{6 n} {m}_{sn} sin ( α + {γ}_{n} + {η}_{n} ) cos β - ( \dot{α} + {\dot{η}}_{n} ) {\dot{z}}_{0} {z}_{6 n} {m}_{sn} cos ( α + {γ}_{n} + {η}_{n} ) cos β - \dot{β} {\dot{z}}_{0} {z}_{6 n} {m}_{sn} sin ( α + {γ}_{n} + {η}_{n} ) cos β & ( 2.74 ) \\ \frac{\partial L}{\partial {\dot{θ}}_{n}} = {\dot{θ}}_{n} {m}_{aw21n} + \dot{α} \{ {m}_{aw21n} - {m}_{aw1n} \{ {c}_{2 n} sin {θ}_{n} - {b}_{2 n} cos ( {γ}_{n} + {θ}_{n} ) \} ] - \dot{β} {m}_{aw1n} {a}_{1 n} cos ( α + {γ}_{n} + {θ}_{n} ) + {\dot{z}}_{0} {m}_{aw1n} cos ( α + {γ}_{n} + {θ}_{n} ) cos β & ( 2.75 ) \\ \frac{ⅆ}{ⅆ t} ( \frac{\partial L}{\partial {\dot{θ}}_{n}} ) = {\ddot{θ} }_{n} {m}_{aw21n} + \ddot{α} [ {m}_{aw21n} - {m}_{aw1n} \{ {c}_{2 n} sin {θ}_{n} - {b}_{2 n} cos ( {γ}_{n} + {θ}_{n} ) \} ] - \dot{α} {\dot{θ}}_{n} {m}_{aw1n} \{ {c}_{2 n} cos {θ}_{n} + {b}_{2 n} sin ( {γ}_{n} + {θ}_{n} ) \} - \ddot{β} {m}_{aw1n} {a}_{1 n} cos ( α + {γ}_{n} + {θ}_{n} ) + \dot{β} ( \dot{α} + {\dot{θ}}_{n} ) {m}_{aw1n} {a}_{1 n} sin ( α + {γ}_{n} + {θ}_{n} ) + {\ddot{z}}_{0} {m}_{aw1n} cos ( α + {γ}_{n} + {θ}_{n} ) cos β - ( \dot{α} + {\dot{θ}}_{n} ) {\dot{z}}_{0} {m}_{aw1n} sin ( α + {γ}_{n} + {θ}_{n} ) cos β - \dot{β} {\dot{z}}_{0} {m}_{aw1n} cos ( α + {γ}_{n} + {θ}_{n} ) sin β & ( 2.76 ) \\ \frac{\partial L}{\partial {\dot{z}}_{6 n}} = {m}_{sn} {\dot{z}}_{6 n} + \dot{α} {m}_{sn} \{ {c}_{1 n} sin {η}_{n} + {b}_{2 n} cos ( {γ}_{n} + {η}_{n} ) \} - \dot{β} {m}_{sn} {a}_{1 n} cos ( α + {γ}_{n} + {θ}_{n} ) + {\dot{z}}_{0} {m}_{sn} cos ( α + {γ}_{n} + {η}_{n} ) cos β & ( 2.77 ) \\ \frac{ⅆ}{ⅆ t} ( \frac{\partial L}{\partial {\dot{z}}_{6 n}} ) = {m}_{sn} {\ddot{z}}_{6 n} + \ddot{α} {m}_{sn} \{ {c}_{1 n} sin {η}_{n} + {b}_{2 n} cos ( {γ}_{n} + {η}_{n} ) \} + \dot{α} {\dot{η}}_{n} {m}_{sn} \{ {c}_{1 n} cos {η}_{n} - {b}_{2 n} sin ( {γ}_{n} + {η}_{n} ) \} - \ddot{β} {m}_{sn} {a}_{1 n} cos ( α + {γ}_{n} + {η}_{n} ) + \dot{β} ( \dot{α} + {\dot{η}}_{n} ) {m}_{sn} {a}_{1 n} sin ( α + {γ}_{n} + {η}_{n} ) + {\ddot{z}}_{0} {m}_{sn} cos ( α + {γ}_{n} + {η}_{n} ) cos β - ( \dot{α} + {\dot{η}}_{n} ) {\dot{z}}_{0} {m}_{sn} sin ( α + {γ}_{n} + {η}_{n} ) cos β - \dot{β} {\dot{z}}_{0} {m}_{sn} cos ( α + {γ}_{n} + {η}_{n} ) sin β & ( 2.78 ) \\ \frac{\partial L}{\partial {\dot{z}}_{12 n}} = 0 & ( 2.79 ) \\ \frac{ⅆ}{ⅆ t} ( \frac{\partial L}{\partial {\dot{z}}_{12 n}} ) = 0 & ( 2.80 )\end{matrix}$$

The dissipative function is:

$${F}_{tot} = - \frac{1}{2} ( {c}_{sn} {\dot{z}}_{6 n}^{2} + {c}_{wn} {\dot{z}}_{12 n}^{2} ) \qquad ( 2.81 )$$

The constraints are based on geometrical constraints, and the touch point of the road and the wheel. The geometrical constraint is expressed as

e₂ₙ cos θₙ=−(z₆ₙ−d₁ₙ)sin ηₙ

e₂ₙ sin θₙ−(z₆ₙ−d₁ₙ)cos ηₙ=c₁ₙ−c₂ₙ (2.82)

The touch point of the road and the wheel is defined as

$$\begin{matrix}{z}_{tn} = {z}_{{P}_{touchpointn}^{r}} \\ = {z}_{0} + \{ {z}_{12 n} cos α + {e}_{3 n} sin ( α + {γ}_{n} + {θ}_{n} ) + \\ {c}_{2 n} cos ( α + {γ}_{n} ) + {b}_{2 n} sin α \} cos β - {a}_{1 n} sin β \\ = {R}_{n} ( t )\end{matrix} \qquad ( 2.83 )$$

where Rₙ(t) is road input at each wheel.

Differentials are:

$${\dot{θ}}_{n} {e}_{2 n} sin {θ}_{n} - {\dot{z}}_{6 n} sin {\dot{η}}_{n} - {\dot{η}}_{n} ( {z}_{6 n} - {d}_{1 n} ) cos {η}_{n} = 0 \\ {\dot{θ}}_{n} {e}_{2 n} cos {θ}_{n} - {\dot{z}}_{6 n} cos {η}_{n} - {\dot{η}}_{n} ( {z}_{6 n} - {d}_{1 n} ) sin {η}_{n} = 0 \\ {\dot{z}}_{0} + \{ {\dot{z}}_{12 n} cos α - \dot{α} {z}_{12 n} sin α + ( \dot{α} + {\dot{θ}}_{n} ) {e}_{3 n} cos ( α + {γ}_{n} + {θ}_{n} ) - \dot{α} {c}_{2 n} sin ( α + {γ}_{n} ) + \dot{α} {b}_{2 n} cos α \} cos β - \dot{β} [ \{ {z}_{12 n} cos α + {e}_{3 n} sin ( α + {γ}_{n} + {θ}_{n} ) + {c}_{2 n} cos ( α + {γ}_{n} ) + {b}_{2 n} sin α \} sin β + {a}_{1 n} cos β ] - {\dot{R}}_{n} ( t ) = 0 \qquad ( 2.84 )$$

Since the differentials of these constraints are written as

$$\begin{matrix}{\sum }_{j} {a}_{lnj} ⅆ {\dot{q}}_{j} + {a}_{lnt} ⅆ t = 0 & ( l = 1 , 2 , 3 n = i , ii , iii , iv )\end{matrix} \qquad ( 2.85 )$$

then the values aᵢₙⱼ are obtained as follows.

a₁ₙ₀=0

a₂ₙ₀=0

a₃ₙ₀=1

a₁ₙ₁=0, a₁ₙ₂=0, a₁ₙ₃=−(z₆ₙ−d₁ₙ)cos ηₙ, a₁ₙ₄=e₂ₙ sin θₙ, a₁ₙ₅=−sin ηₙ, a₁ₙ₆=0

a₂ₙ₁=0, a₂ₙ₂=0, a₂ₙ₃=(z₆ₙ−d₁ₙ)sin ηₙ, a₂ₙ₄=e₂ₙ cos θₙ, a₂ₙ₅=−cos ηₙ, a₂ₙ₆=0

a₃ₙ₁=−{z₁₂ₙ cos α+e₃ₙ sin(α+γₙ+θₙ)+c₂ₙ cos(α+γₙ)+b₂ₙ sin α}sin β+a₁ₙ cos β,

a₃ₙ₂={−z₁₂ₙ sin α+e₃ₙ cos(α+γₙ+θₙ)−c₂ₙ sin(α+γₙ)+b₂ₙ cos α}cos β,

a₃ₙ₃=0, a₃ₙ₄=e₃ₙ cos(α+γₙ+θₙ)cos β, a₃ₙ₅=0, a₃ₙ₆=cos α cos β (2.86)

From the above, Lagrange's equation becomes

$$\frac{ⅆ}{ⅆ t} ( \frac{\partial L}{\partial {\dot{q}}_{j}} ) - \frac{\partial l}{\partial {q}_{j}} = {Q}_{j} + {\sum }_{l , n} {λ}_{l n} {a}_{lnj} \qquad ( 2.87 )$$

where

q₀=z₀

q₁=β, q₂=α, q₃ᵢ=ηᵢ, q₄ᵢ=θᵢ, q₅ᵢ=z₆ᵢ, q₆ᵢ=z₁₂ᵢ q₃ᵢᵢ=ηᵢᵢ, q₄ᵢᵢ=θᵢᵢ, q₅ᵢᵢ=z₆ᵢᵢ, q₆ᵢᵢ=z₁₂ᵢᵢ q₃ᵢᵢᵢ=ηᵢᵢᵢ, q₄ᵢᵢᵢ=θᵢᵢᵢ, q₅ᵢᵢᵢ=z₆ᵢᵢᵢ, q₆ᵢᵢᵢ=z₁₂ᵢᵢᵢ q₃ᵢᵥ=ηᵢᵥ, q₄ᵢᵥ=θᵢᵥ, q₅ᵢᵥ=z₆ᵢᵥ, q₆ᵢᵥ=z₁₂ᵢᵥ (2.88)

$$\begin{matrix}\begin{matrix}\frac{ⅆ}{ⅆ t} ( \frac{\partial l}{\partial {\dot{z}}_{0}} ) - \frac{\partial L}{\partial {z}_{0}} = \frac{\partial F}{\partial {\dot{z}}_{0}} + {\sum }_{l , n} {λ}_{l n} {a}_{ln0} & l = 1 , 2 , 3 & n = i , ii , iii , iv\end{matrix} & \\ {\ddot{z}}_{0} ( {m}_{b} + {m}_{sawn} ) + \ddot{α} {m}_{b} cos β ( {b}_{0} cos α - {c}_{0} sin α ) - {\ddot{α}}^{2} {m}_{b} cos β ( {b}_{0} sin α - {c}_{0} cos α ) - \ddot{β} \{ {m}_{ba} cos β + {m}_{b} ( {b}_{0} sin α - {c}_{0} cos α ) sin β \} + \dot{β} \{ \dot{β} ( {m}_{ba} + {m}_{sawan} ) sin β + \dot{β} {m}_{b} ( {b}_{0} sin α - {c}_{0} cos α ) cos β \} + \{ {\ddot{z}}_{6 n} {m}_{sn} cos ( α + {γ}_{n} + {η}_{n} ) - 2 ( \dot{α} + {\dot{η}}_{n} ) {\dot{z}}_{6 n} {m}_{sn} sin ( α + {γ}_{n} + {η}_{n} ) + ( \ddot{α} + {\ddot{θ}}_{n} ) {m}_{awln} cos ( α + {γ}_{n} + {θ}_{n} ) - {( \dot{α} + {\dot{θ}}_{n} )}^{2} {m}_{awln} sin ( α + {γ}_{n} + {θ}_{n} ) - ( \ddot{α} + {\ddot{θ}}_{n} ) {z}_{6 n} {m}_{sn} sin ( α + {γ}_{n} + {η}_{n} ) - {( \dot{α} + {\dot{θ}}_{n} )}^{2} {z}_{6 n} {m}_{sn} cos ( α + {γ}_{n} + {η}_{n} ) - \ddot{α} {m}_{sawcn} sin ( α + {γ}_{n} ) - {\dot{α}}^{2} {m}_{sawcn} cos ( α + {γ}_{n} ) + \ddot{α} {m}_{sawbn} cos α - {\dot{α}}^{2} {m}_{sawbn} sin α - \ddot{β} {m}_{sawan} \} cos β - 2 \dot{β} \{ {\dot{z}}_{6 n} {m}_{sn} cos ( α + {γ}_{n} + {η}_{n} ) + ( \dot{α} + {\dot{θ}}_{n} ) {m}_{awln} cos ( α + {γ}_{n} + {θ}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α \} sin β - ( \ddot{β} sin β + {\dot{β}}^{2} cos β ) \{ {m}_{awln} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} + g ( {m}_{b} + {m}_{sawn} ) = {λ}_{3 n} & \\ {\ddot{z}}_{0} = {λ}_{3 n} - g - \frac{\begin{matrix}\ddot{α} {m}_{b} {C}_{β} {A}_{2} - {\dot{α}}^{2} {m}_{b} {A}_{1} - \ddot{β} \{ {m}_{ba} {C}_{β} + {m}_{b} {A}_{1} {S}_{β} \} + \\ β \{ {m}_{ba} {S}_{β} + \dot{β} {m}_{b} {A}_{1} {C}_{β} \} + \{ {\ddot{z}}_{6 n} {m}_{sn} {C}_{αγ η} - \\ 2 ( \dot{α} + {\dot{η}}_{n} ) {\dot{z}}_{6 n} {m}_{sn} {S}_{αγ η} + ( \ddot{α} + {\ddot{θ}}_{n} ) {m}_{aw1n} {C}_{αγ n} - \\ {( \dot{α} + {\dot{θ}}_{n} )}^{2} {m}_{aw1n} {S}_{αγ η} - ( \ddot{α} + {\ddot{η}}_{n} ) {z}_{6 n} {m}_{sn} {S}_{αγ η} - \\ {( \dot{α} + {\dot{η}}_{n} )}^{2} {z}_{6 n} {m}_{sn} {C}_{αγη} - \ddot{α} {m}_{sawcn} {S}_{αγ η} - \\ {\dot{α}}^{2} {m}_{sawcn} {C}_{αγη} + \ddot{α} {m}_{sawcn} {C}_{α} - {\dot{α}}^{2} {m}_{sawbn} {S}_{α} - \\ \ddot{β} {m}_{sawan} \} {C}_{β} - 2 \dot{β} \{ {\dot{z}}_{6 n} {m}_{sn} {C}_{αγ η} + ( \dot{α} + \\ {\dot{θ}}_{n} ) {m}_{aw1n} {C}_{αγη} - ( \dot{α} + {\dot{η}}_{n} ) {z}_{6 n} {m}_{sn} {S}_{αγ η -} \dot{α} {m}_{sawcn} {S}_{αγη} + \\ \dot{α} {m}_{sawbn} {C}_{α} - \dot{β} {m}_{sawan} / 2 \} S β - ( \ddot{β} {S}_{β} + \\ {\dot{β}}^{2} {C}_{β} ) \{ {m}_{aw1n} {S}_{αγη} + {z}_{6 n} {m}_{sn} {C}_{αγη} + \\ {m}_{sawcn} {C}_{αγη} + {m}_{sawbn} {S}_{α} \}\end{matrix}}{{m}_{bsawn}} & \\ \begin{matrix}\frac{ⅆ}{ⅆ t} ( \frac{\partial L}{\partial \dot{β}} ) - \frac{\partial L}{\partial β} = \frac{\partial F}{\partial \dot{β}} + {\sum }_{l , n} {λ}_{l n} {a}_{l n1} & \begin{matrix}l = 1 , 2 , 3 & n = i , ii , iii , iv\end{matrix}\end{matrix} & ( 2.89 ) \\ \begin{matrix}\ddot{β} ⟨ {m}_{saw2n} + {m}_{baI} + {{m}_{b} ( {b}_{0} sin α + {c}_{0} cos α )}^{2} + \\ {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} + \\ {m}_{an} {\{ {e}_{1 n} sin ( α + {γ}_{n} + {θ}_{n} ) + {c}_{2 n} cos ( α + {γ}_{n} ) + {b}_{2 n} sin α \}}^{2} + \\ {m}_{wn} {\{ {e}_{3 n} sin ( α + {γ}_{n} + {θ}_{n} ) + {c}_{2 n} cos ( α + {γ}_{n} ) + {b}_{2 n} sin α \}}^{2} ⟩ + \\ 2 \dot{β} ⟨ \dot{α} {m}_{b} ( {b}_{0} sin α + {c}_{0} cos α ) ( {b}_{0} cos α - {c}_{0} sin α ) + \\ {m}_{sn} \{ {z}_{6 n} cos ( α + {γ}_{n} + {η}_{n} ) + {c}_{1 n} cos ( α + {γ}_{n} ) + {b}_{2 n} sin α \} \\ \{ {\dot{z}}_{6 n} cos ( α + {γ}_{n} + {η}_{n} ) - ( \dot{α} + {\dot{η}}_{h} ) {z}_{6 n} sin ( α + {γ}_{n} + {η}_{n} ) - \\ \dot{α} [ {c}_{1 n} sin ( α + {γ}_{n} ) - {b}_{2 n} cos α ] \} + \\ {m}_{an} \{ {e}_{1 n} sin ( α + {γ}_{n} + {θ}_{n} ) + {c}_{2 n} cos ( α + {γ}_{n} ) + {b}_{2 n} sin α \} \\ \{ ( \dot{α} + {\dot{θ}}_{n} ) {e}_{1 n} cos ( α + {γ}_{n} + {θ}_{n} ) - \dot{α} [ {c}_{2 n} sin ( α + {γ}_{n} ) - {b}_{2 n} cos α ] \} +\end{matrix} & ( 2.90 ) \\ \begin{matrix}{m}_{wn} \{ {e}_{3 n} sin ( α + {γ}_{n} + {θ}_{n} ) + {c}_{2 n} cos ( α + {γ}_{n} ) + {b}_{2 n} sin α \} \\ \{ ( \dot{α} + {\dot{θ}}_{n} ) {e}_{3 n} sin ( α + {γ}_{n} + {θ}_{n} ) - \dot{α} [ {c}_{2 n} sin ( α + {γ}_{n} ) - {b}_{2 n} cos α ] \} ⟩ - \\ \ddot{α} {m}_{ba} ( {b}_{0} cos α - {c}_{0} sin α ) + {\dot{α}}^{2} {m}_{ba} ( {b}_{0} sin α + {c}_{0} cos α ) - \\ {\ddot{z}}_{6 n} {m}_{sn} {a}_{1 n} cos ( α + {γ}_{n} + {η}_{n} ) + \\ {\dot{z}}_{6 n} ( \dot{α} + {\dot{η}}_{n} ) {m}_{sn} {a}_{1 n} sin ( α + {γ}_{n} + {η}_{n} ) + \\ {\ddot{η}}_{n} {m}_{sn} {z}_{6 n} {a}_{1 n} sin ( α + {γ}_{n} + {η}_{n} ) + {\dot{η}}_{n} {m}_{sn} {\dot{z}}_{6 n} {a}_{1 n} sin ( α + {γ}_{n} + {η}_{n} ) + \\ {\dot{η}}_{n} ( \dot{α} + {\dot{η}}_{n} ) {m}_{sn} {z}_{6 n} {a}_{1 n} cos ( α + {γ}_{n} + {η}_{n} ) - \\ {\ddot{θ}}_{n} {m}_{aw1n} {a}_{1 n} cos ( α + {γ}_{n} + {θ}_{n} ) + \\ {\dot{θ}}_{n} ( \dot{α} + {\dot{θ}}_{n} ) {m}_{aw1n} {a}_{1 n} sin ( α + {γ}_{n} + {θ}_{n} ) + \\ \ddot{α} {a}_{1 n} \{ {m}_{sawcn} sin ( α + {γ}_{n} ) - {m}_{sawbn} cos α +\end{matrix} & \\ \begin{matrix}{m}_{sn} {z}_{6 n} sin ( α + {γ}_{n} + {η}_{n} ) - \\ {m}_{aw1n} cos ( α + {γ}_{n} + {θ}_{n} ) \} + \\ \dot{α} {a}_{1 n} \{ \dot{α} {m}_{sawcn} cos ( α + {γ}_{n} ) + \\ \dot{α} {m}_{sawbn} sin α + ( \dot{α} + {\dot{η}}_{n} ) {m}_{sn} {z}_{6 n} cos ( α + {γ}_{n} + {η}_{n} ) + \\ {m}_{sn} {\dot{z}}_{6 n} sin ( α + {γ}_{n} + {η}_{n} ) + \\ ( \dot{α} + {\dot{θ}}_{n} ) {m}_{aw1n} sin ( α + {γ}_{n} + {θ}_{n} ) \} - \\ {\ddot{z}}_{0} [ \{ {m}_{b} ( {b}_{0} sin α + {c}_{0} cos α ) + {m}_{saw1n} sin ( α + {γ}_{n} + {θ}_{n} ) + \\ {z}_{6 n} {m}_{sn} cos ( α + {γ}_{n} + {η}_{n} ) + {m}_{sawcn} cos ( α + γ ) + \\ {m}_{sawbn} sin α \} sin β + ( {m}_{ba} + {m}_{sawan} cos β ) ] - \\ {\dot{z}}_{0} [ \{ \dot{α} {m}_{b} ( {b}_{0} cos α - {c}_{0} sin α ) + ( \dot{α} + {\dot{θ}}_{n} ) {m}_{aw1n} cos ( α + {γ}_{n} + {θ}_{n} )\end{matrix} & \\ \begin{matrix}\begin{matrix}\begin{matrix}\begin{matrix}\begin{matrix}\begin{matrix}\begin{matrix}\begin{matrix}\begin{matrix}+ {\dot{z}}_{6 n} {m}_{sn} cos ( α + {γ}_{n} + {η}_{n} ) - \\ ( \dot{α} + {\dot{η}}_{n} ) {z}_{6 n} {m}_{sn} sin ( α + {γ}_{n} + {η}_{n} ) -\end{matrix} \\ \dot{α} {m}_{sawcn} sin ( α + {γ}_{n} ) + \dot{α} {m}_{sawbn} cos α \} sin β +\end{matrix} \\ β {\dot{z}}_{0} \{ {m}_{b} ( {b}_{0} sin α + {c}_{0} cos α ) + {m}_{aw1n} sin ( α + {γ}_{n} + {θ}_{n} ) +\end{matrix} \\ {z}_{6 n} {m}_{sn} cos ( α + {γ}_{n} + {η}_{n} ) + {m}_{sawcn} cos ( α + {γ}_{n} ) +\end{matrix} \\ {m}_{sawbn} sin α \} cos β - ( {m}_{ba} + {m}_{sawan} sin β ) ] +\end{matrix} \\ \dot{α} {\dot{z}}_{0} {m}_{b} sin β ( {b}_{0} cos α - {c}_{0} sin α ) -\end{matrix} \\ \dot{β} {\dot{z}}_{0} \{ {m}_{ba} sin β - {m}_{b} ( {b}_{0} sin α + {c}_{0} cos α ) cos β \} -\end{matrix} \\ g \{ {m}_{ba} cos β + {m}_{b} ( {b}_{0} sin α + {c}_{0} cos α ) sin β \} -\end{matrix} \\ ⟨ g [ \{ {m}_{sn} {z}_{6 n} cos ( α + {γ}_{n} + {η}_{n} ) + {m}_{aw1n} sin ( α + {γ}_{n} + {θ}_{n} ) +\end{matrix} & \\ \begin{matrix}\begin{matrix}\begin{matrix}\begin{matrix}\begin{matrix}\begin{matrix}{m}_{sawcn} cos ( α + {γ}_{n} ) + {m}_{sawbn} sin α \} sin β + {m}_{sawan} cos β ] - \\ {\dot{z}}_{0} \{ {\dot{z}}_{6 n} {m}_{sn} cos ( α + {γ}_{n} + {η}_{n} ) + ( \dot{α} + {\dot{θ}}_{n} ) {m}_{aw1n} cos ( α + {γ}_{n} + {θ}_{n} ) -\end{matrix} \\ ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) +\end{matrix} \\ \dot{α} {m}_{sawbn} cos α - \dot{β} {m}_{sawan} \} sin β \} -\end{matrix} \\ \dot{β} {\dot{z}}_{0} \{ {m}_{aw1n} sin ( α + {γ}_{n} + {θ}_{n} ) + {z}_{6 n} {m}_{sn} cos ( α + {γ}_{n} + {η}_{n} ) +\end{matrix} \\ {m}_{sawcn} cos ( α + {γ}_{n} ) + {m}_{sawbn} sin α \} cos β ⟩ =\end{matrix} \\ {λ}_{3 n} [ - \{ {z}_{12 n} cos α + {e}_{3 n} sin ( α + {γ}_{n} + {θ}_{n} ) + {c}_{2 n} cos ( α + {γ}_{n} )\end{matrix} & \\ \ddot{β} ( {m}_{saw2n} + {m}_{baI} + {m}_{b} {A}_{1}^{2} + {m}_{sn} {B}_{1}^{2} + {m}_{an} {B}_{2}^{2} + {m}_{wn} {B}_{3}^{2} ) + 2 \dot{β} [ \dot{α} {m}_{b} {A}_{1} {A}_{2} + {m}_{sn} {B}_{1} \{ {\dot{z}}_{6 n} {C}_{αγη n} - ( \dot{α} + {\dot{η}}_{n} ) {z}_{6 n} {S}_{αγη n} - \dot{α} {A}_{4} \} + {m}_{an} {B}_{2} \{ ( \dot{α} + {\dot{θ}}_{n} ) {e}_{1 n} {C}_{αγθ n} - \dot{α} {A}_{6} \} + {m}_{wn} {B}_{3} \{ ( \dot{α} + {\dot{θ}}_{n} ) {e}_{3 n} {S}_{αγθ n} - \dot{α} {A}_{6} \} ] - \ddot{α} {m}_{ba} {A}_{2} + {\dot{α}}^{2} {m}_{ba} {A}_{1} - {\ddot{z}}_{6 n} {m}_{sn} {a}_{1 n} {C}_{α γ η n} + 2 {\dot{z}}_{6 n} ( \dot{α} + {\dot{η}}_{n} ) {m}_{sn} {a}_{1 n} {S}_{αγ η n} + {\ddot{η}}_{n} {m}_{sn} {z}_{6 n} {a}_{1 n} {S}_{αγ η n} + {\dot{η}}_{n} ( 2 \dot{α} + {\dot{η}}_{n} ) {m}_{sn} {z}_{6 n} {a}_{1 n} {C}_{α γ η n} - {\ddot{θ}}_{n} {m}_{aw1n} {a}_{1 n} {C}_{α γ θ n} + {\dot{θ}}_{n} ( 2 \dot{α} + {\dot{θ}}_{n} ) {m}_{aw1n} {a}_{1 n} {S}_{αγθn} + \ddot{α} {a}_{1 n} \{ {m}_{sawcn} {S}_{αγ n} - {m}_{sawbn} {C}_{α} + {m}_{sn} {z}_{6 n} {S}_{αγ η n} - {m}_{aw1n} {C}_{α γ θ n} \} + {\dot{α}}^{2} {a}_{1 n} \{ {m}_{sawcn} {C}_{α γ n} + {m}_{sawbn} {S}_{α} + {m}_{sn} {z}_{6 n} {C}_{αγη n} + {m}_{aw1n} {S}_{α γ θ n} \} - {\ddot{z}}_{0} [ \{ {m}_{b} ( {b}_{0} {S}_{α} + {c}_{0} {C}_{α} ) + {m}_{aw1n} {S}_{αγη n} + {z}_{6 n} {m}_{sn} {C}_{αγ η n} + {m}_{sawcn} {C}_{αγ n} + {m}_{sawbn} {S}_{α} \} {S}_{β} + ( {m}_{ba} + {m}_{sawan} ) {C}_{β} ] + {\dot{z}}_{0} ( 1 - \dot{β} ) ( {m}_{ba} + {m}_{sawan} ) sin β - g [ {m}_{ba} {C}_{β} + {m}_{b} {A}_{1} {S}_{β} + \{ {m}_{sn} {z}_{6 n} {C}_{αγ η n} + {m}_{aw1n} {S}_{αγ θ n} + {m}_{sawcn} {C}_{α γ n} + {m}_{sawbn} {S}_{α} \} {S}_{β} + {m}_{sawan} {C}_{β} ] = {λ}_{3 n} [ - \{ {z}_{12 n} {C}_{α} + {e}_{3 n} {S}_{αγ θ n} + {c}_{2 n} {C}_{αγ n} + {b}_{2 n} {S}_{α} \} {S}_{β} + {a}_{1 n} {C}_{β} ] ∴ & ( 2.91 ) \\ \ddot{β} = \frac{\begin{matrix}\begin{matrix}\begin{matrix}\begin{matrix}\begin{matrix}\begin{matrix}\begin{matrix}\begin{matrix}2 \dot{β} [ \dot{α} {m}_{b} {A}_{1} {A}_{2} + {m}_{sn} {B}_{1} \{ {\dot{z}}_{6 n} {C}_{αγ η n} - ( \dot{α} + {\dot{η}}_{n} ) {z}_{6 n} {S}_{αγη n} - \dot{α} {A}_{4} \} + \\ {m}_{an} {B}_{2} \{ ( \dot{α} + {\dot{θ}}_{n} ) {e}_{1 n} {C}_{αγθ n} - \dot{α} {A}_{6} \} + {m}_{wn} {B}_{3} \{ ( \dot{α} + {\dot{θ}}_{n} ) {e}_{3 n} {S}_{αγθ n} -\end{matrix} \\ \dot{α} {A}_{6} \} ] - \ddot{α} {m}_{ba} {A}_{2} + {\dot{α}}^{2} {m}_{ba} {A}_{1} - {\ddot{z}}_{6 n} {m}_{sn} {a}_{1 n} {C}_{αγη n} +\end{matrix} \\ 2 {\dot{z}}_{6 n} ( \dot{α} + {\dot{η}}_{n} ) {m}_{sn} {a}_{1 n} {S}_{αγη n} + {\ddot{η}}_{n} {m}_{sn} {z}_{6 n} {a}_{1 n} {S}_{αγη n} +\end{matrix} \\ {\dot{η}}_{n} ( 2 \dot{α} + {\dot{η}}_{n} ) {m}_{sn} {z}_{6 n} {a}_{1 n} {C}_{αγη n} - {\ddot{θ}}_{n} {m}_{aw1n} {a}_{1 n} {C}_{αγθ n} +\end{matrix} \\ {\dot{θ}}_{n} ( 2 \dot{α} + {\dot{θ}}_{n} ) {m}_{aw1n} {a}_{1 n} {S}_{αγθ n} + \ddot{α} {a}_{1 n} \{ {m}_{sawcn} {S}_{α γ n} -\end{matrix} \\ {m}_{sawbn} {C}_{α} + {m}_{sn} {z}_{6 n} {S}_{αγη n} - {m}_{aw1n} {C}_{αγθ n} \} +\end{matrix} \\ {\dot{α}}^{2} {a}_{1 n} \{ {m}_{sawcn} {C}_{αγ n} + {m}_{sawbn} {S}_{α} + {m}_{sn} {z}_{6 n} {C}_{αγ η n} + {m}_{aw1n} {S}_{αγθ n} \} -\end{matrix} \\ \begin{matrix}\begin{matrix}\begin{matrix}\begin{matrix}\begin{matrix}{\ddot{z}}_{0} [ \{ {m}_{b} ( {b}_{0} {S}_{α} + {c}_{0} {C}_{α} ) + {m}_{aw1n} {S}_{αγ η n} + {z}_{6 n} {m}_{sn} {C}_{αγη n} + \\ {m}_{sawcn} {C}_{αγ n} + {m}_{sawbn} {S}_{α} \} {S}_{β} + ( {m}_{ba} + {m}_{sawan} ) {C}_{β} ] +\end{matrix} \\ {\dot{z}}_{0} ( 1 - \dot{β} ) ( {m}_{ba} + {m}_{sawan} ) sin β - g [ {m}_{ba} {C}_{β} + {m}_{b} {A}_{1} {S}_{β} +\end{matrix} \\ \{ {m}_{sn} {z}_{6 n} {C}_{αγη n} + {m}_{aw1n} {S}_{αγθ n} + {m}_{sawcn} {C}_{αγ n} + {m}_{sawbn} {S}_{α} \} {S}_{β} +\end{matrix} \\ {m}_{sawan} {C}_{β} ] + {λ}_{3 n} \{ ( {z}_{12 n} {C}_{α} + {e}_{3 n} {S}_{αγθ n} + {c}_{2 n} {C}_{αγ n} + {b}_{2 n} {S}_{α} ) {S}_{β} -\end{matrix} \\ {a}_{1 n} C β \}\end{matrix}\end{matrix}}{( - ( {m}_{saw2n} + {m}_{baI} + {m}_{b} {A}_{1}^{2} + {m}_{sn} {B}_{1}^{2} + {m}_{an} {B}_{2}^{2} + {m}_{wn} {B}_{3}^{2} ) )} & ( 2.92 ) \\ \begin{matrix}\frac{ⅆ}{ⅆ t} ( \frac{\partial L}{\partial \dot{α}} ) - \frac{\partial L}{\partial α} = \frac{\partial F}{\partial \dot{α}} + {\sum }_{l , n} {λ}_{l n} {a}_{l n2} & l = 1 , 2 , 3 & n = i , ii , iii , iv\end{matrix} & ( 2.93 ) \\ \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}- \ddot{β} {m}_{ba} ( {b}_{0} cos α - {c}_{0} sin α ) + \\ \dot{β} \dot{α} {m}_{ba} ( {b}_{0} sin α + {c}_{0} cos α ) + {\ddot{z}}_{0} {m}_{b} cos β ( {b}_{0} cos α - {c}_{0} sin α ) -\end{matrix} \\ \dot{β} {\dot{z}}_{0} {m}_{b} sin β ( {b}_{0} cos α - {c}_{0} sin α ) - \dot{α} {\dot{z}}_{0} {m}_{b} cos β ( {b}_{0} sin α - {c}_{0} cos α ) +\end{matrix} \\ \ddot{α} ⟨ {m}_{bbI} + {m}_{sawIn} + {m}_{sn} {z}_{6 n} [ {z}_{6 n} + 2 \{ {c}_{1 n} cos {η}_{n} - {b}_{2 n} sin ( {γ}_{n} + {η}_{n} ) \} ] -\end{matrix} \\ 2 {m}_{aw1n} \{ {c}_{2 n} sin {θ}_{n} - {b}_{2 n} cos ( {γ}_{n} + {θ}_{n} ) \} ⟩ +\end{matrix} \\ \dot{α} ⟨ {m}_{sn} {\dot{z}}_{6 n} [ {z}_{6 n} + 2 \{ {c}_{1 n} cos {η}_{n} - {b}_{2 n} sin ( {γ}_{n} + {η}_{n} ) \} ] +\end{matrix} \\ {m}_{sn} {z}_{6 n} [ {\dot{z}}_{6 n} - 2 {\dot{η}}_{n} \{ {c}_{1 n} sin {η}_{n} + {b}_{2 n} cos ( {γ}_{n} + {η}_{n} ) \} ] -\end{matrix} \\ 2 {\dot{θ}}_{n} {m}_{aw1n} \{ {c}_{2 n} cos {θ}_{n} + {b}_{2 n} sin ( {γ}_{n} + {θ}_{n} ) \} ⟩ +\end{matrix} \\ {\ddot{z}}_{6 n} {m}_{sn} \{ {c}_{1 n} sin {η}_{n} + {b}_{2 n} cos ( {γ}_{n} + {η}_{n} ) \} +\end{matrix} \\ {\dot{z}}_{6 n} {\dot{η}}_{n} {m}_{sn} \{ {c}_{1 n} cos {η}_{n} - {b}_{2 n} sin ( {γ}_{n} + {η}_{n} ) \} +\end{matrix} \\ {\ddot{η}}_{n} {m}_{sn} {z}_{6 n} \{ {z}_{6 n} + {c}_{1 n} cos {η}_{n} - {b}_{2 n} sin ( {γ}_{n} + {η}_{n} ) \} +\end{matrix} \\ {\dot{η}}_{n} {m}_{sn} {\dot{z}}_{6 n} \{ {z}_{6 n} + {c}_{1 n} cos {η}_{n} - {b}_{2 n} sin ( {γ}_{n} + {η}_{n} ) \} +\end{matrix} \\ {\dot{η}}_{n} {m}_{sn} {z}_{6 n} \{ {\dot{z}}_{6 n} - {\dot{η}}_{n} [ {c}_{1 n} sin {η}_{n} + {b}_{2 n} cos ( {γ}_{n} + {η}_{n} ) ] \} +\end{matrix} \\ \ddot{θ} [ {m}_{aw2In} - {m}_{aw1n} \{ {c}_{2 n} sin {θ}_{n} - {b}_{2 n} cos ( {γ}_{n} + {θ}_{n} ) \} ] -\end{matrix} \\ {\dot{θ}}_{n}^{2} {m}_{aw1n} \{ {c}_{2 n} cos {θ}_{n} + {b}_{2 n} sin ( {γ}_{n} + {θ}_{n} ) \} ] +\end{matrix} & ( 2.94 ) \\ \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}\ddot{β} {a}_{1 n} \{ {m}_{sawcn} sin ( α + {γ}_{n} ) - {m}_{sawbn} cos α + \\ {m}_{sn} {z}_{6 n} sin ( α + {γ}_{n} + {η}_{n} ) - {m}_{aw1n} cos ( α + {γ}_{n} + {θ}_{n} ) \} +\end{matrix} \\ \dot{β} {a}_{1 n} \{ \dot{α} [ {m}_{sawcn} cos ( α + {γ}_{n} ) + {m}_{sawbn} sin α ] +\end{matrix} \\ {m}_{sn} {\dot{z}}_{6 n} sin ( α + {γ}_{n} + {η}_{n} ) + ( \dot{α} + {\dot{η}}_{n} ) {m}_{sn} {z}_{6 n} cos ( α + {γ}_{n} + {η}_{n} ) +\end{matrix} \\ ( \dot{α} + {\dot{θ}}_{n} ) {m}_{aw1n} sin ( α + {γ}_{n} + {θ}_{n} ) \} + {\ddot{z}}_{0} \{ {m}_{aw1n} cos ( α + {γ}_{n} + {θ}_{n} ) -\end{matrix} \\ {z}_{6 n} {m}_{sn} sin ( α + {γ}_{n} + {η}_{n} ) - {m}_{sawcn} sin ( α + {γ}_{n} ) +\end{matrix} \\ {m}_{sawbn} cos α \} cos β \} + {\dot{z}}_{0} \{ - ( \dot{α} + {\dot{θ}}_{n} ) {m}_{aw1n} sin ( α + {γ}_{n} + {θ}_{n} ) -\end{matrix} \\ {z}_{6 n} {m}_{sn} sin ( α + {γ}_{n} + {η}_{n} ) -\end{matrix} \\ ( \dot{α} + {\dot{θ}}_{n} ) {z}_{6 n} {m}_{sn} cos ( α + {γ}_{n} + {η}_{n} ) -\end{matrix} \\ \dot{α} {m}_{sawcn} cos ( α + {γ}_{n} ) - \dot{α} {m}_{sawbn} sin α \} cos β -\end{matrix} \\ \dot{β} {\dot{z}}_{0} \{ {m}_{aw1n} cos ( α + {γ}_{n} + {θ}_{n} ) - {z}_{6 n} {m}_{sn} sin ( α + {γ}_{n} + {η}_{n} ) -\end{matrix} \\ {m}_{sawcn} sin ( α + {γ}_{n} ) + {m}_{sawbn} cos α \} cos β \} -\end{matrix} \\ \{ {\dot{β}}^{2} {m}_{b} ( {b}_{0} cos α - {c}_{0} sin α ) + \dot{α} \dot{β} {m}_{ba} \} ( {b}_{0} sin α + {c}_{0} cos α ) -\end{matrix} \\ \vert {\dot{β}}^{2} ⟨ {m}_{sn} \{ {z}_{6 n} cos ( α + {γ}_{n} + {η}_{n} ) + {c}_{1 n} cos ( α + {γ}_{n} ) + {b}_{2 n} sin α \}\end{matrix} \\ \{ - {z}_{6 n} sin ( α + {γ}_{n} + {η}_{n} ) - {c}_{1 n} sin ( α + {γ}_{n} + {η}_{n} ) -\end{matrix} & \\ \begin{matrix}\begin{matrix}\begin{matrix}\begin{matrix}\begin{matrix}\begin{matrix}\begin{matrix}\begin{matrix}\begin{matrix}{c}_{1 n} sin ( α + {γ}_{n} ) + {b}_{2 n} cos α \} + {m}_{an} \{ {e}_{1 n} sin ( α + {γ}_{n} + {θ}_{n} ) + \\ {c}_{2 n} cos ( α + {γ}_{n} ) + {b}_{2 n} sin α \} \{ {e}_{1} cos ( α + {γ}_{n} + {θ}_{n} ) -\end{matrix} \\ {c}_{2 n} sin ( α + {γ}_{n} ) + {b}_{2 n} cos α \} +\end{matrix} \\ {m}_{wn} \{ {e}_{3 n} sin ( α + {γ}_{n} + {θ}_{n} ) + {c}_{2 n} cos ( α + {γ}_{n} ) +\end{matrix} \\ {b}_{2 n} sin α \} \{ {e}_{3} cos ( α + {γ}_{n} + {θ}_{n} ) - {c}_{2 n} sin ( α + {γ}_{n} ) +\end{matrix} \\ {b}_{2 n} cos α \} ⟩ + {\dot{z}}_{6 n} \dot{β} {m}_{sn} {a}_{1 n} sin ( α + {γ}_{n} + {η}_{n} ) +\end{matrix} \\ {\dot{η}}_{n} \dot{β} {m}_{sn} {z}_{6 n} {a}_{1 n} cos ( α + {γ}_{n} + {η}_{n} ) +\end{matrix} \\ \dot{θ} \dot{β} {m}_{aw1n} {a}_{1 n} sin ( α + {γ}_{n} + {θ}_{n} ) +\end{matrix} \\ \dot{α} \dot{β} {a}_{1 n} \{ {m}_{sawcn} cos ( α + {γ}_{n} ) + {m}_{sawbn} sin α +\end{matrix} \\ {m}_{sn} {z}_{6 n} cos ( α + {γ}_{n} + {η}_{n} ) + {m}_{aw1n} sin ( α + {γ}_{n} + {θ}_{n} ) \} -\end{matrix} & \\ \begin{matrix}\begin{matrix}\begin{matrix}\begin{matrix}\begin{matrix}\begin{matrix}{\dot{z}}_{0} \{ {\dot{z}}_{6 n} {m}_{sn} sin ( α + {γ}_{n} + {η}_{n} ) + ( \dot{α} + {\dot{θ}}_{n} ) {m}_{aw1n} sin ( α + {γ}_{n} + {θ}_{n} ) + \\ ( \dot{α} + {\dot{η}}_{n} ) {z}_{6 n} {m}_{sn} cos ( α + {γ}_{n} + {θ}_{n} ) + \dot{α} {m}_{sawcn} cos ( α + {γ}_{n} ) +\end{matrix} \\ \dot{α} {m}_{sawbn} sin α \} sin β \vert + {gm}_{b} ( {b}_{0} cos α - {c}_{0} sin α ) cos β -\end{matrix} \\ g \{ {m}_{sn} {z}_{6 n} sin ( α + {γ}_{n} + {η}_{n} ) - {m}_{aw1n} cos ( α + {γ}_{n} + {θ}_{n} ) +\end{matrix} \\ {m}_{sawcn} sin ( α + {γ}_{n} ) - {m}_{sawbn} cos α \} cos β =\end{matrix} \\ {λ}_{3 n} \{ - {z}_{12 n} sin α + {e}_{3 n} cos ( α + {γ}_{n} + {θ}_{n} )\end{matrix} \\ - {c}_{2 n} sin ( α + {γ}_{n} ) + {b}_{2 n} cos α \} cos β\end{matrix} & \\ {\ddot{z}}_{0} \{ {m}_{b} {A}_{2} + {m}_{aw1n} {C}_{αγθ n} - {z}_{6 n} {m}_{sn} {S}_{αγθ n} - {m}_{sawcn} {S}_{αγ n} + {m}_{sawbn} {C}_{α} \} {C}_{β} - \ddot{β} {m}_{ba} {A}_{2} + \ddot{α} \{ {m}_{bbI} + {m}_{sawIn} + {m}_{sn} {z}_{6 n} ( {z}_{6 n} + 2 {E}_{1 n} ) - 2 {m}_{aw1n} {H}_{1 n} \} + 2 \dot{α} \{ {m}_{sn} {\dot{z}}_{6 n} ( {z}_{6 n} + {E}_{1 n} ) - {m}_{sn} {z}_{6 n} {\dot{η}}_{n} {E}_{2 n} - {\dot{θ}}_{n} {m}_{aw1n} {H}_{2 n} \} + {\ddot{z}}_{6 n} {m}_{sn} {E}_{2 n} + {\dot{z}}_{6 n} {\dot{η}}_{n} {m}_{sn} {E}_{1 n} + {\ddot{η}}_{n} {m}_{sn} {z}_{6 n} \{ {z}_{6 n} + {E}_{1 n} \} + {\dot{η}}_{n} {m}_{sn} {\dot{z}}_{6 n} \{ 2 {z}_{6 n} + {E}_{1 n} \} - {\dot{η}}_{n}^{2} {m}_{sn} {z}_{6 n} {E}_{2 n} + \ddot{θ} ( {m}_{aw21n} - {m}_{aw1n} {H}_{1 n} ) - {\dot{θ}}_{n}^{2} {m}_{aw1n} {H}_{2 n} + \ddot{β} {a}_{1 n} ( {m}_{sawcn} {S}_{αγ n} - {m}_{sawbn} {C}_{α} + {m}_{sn} {z}_{6 n} {S}_{α γη n} - {m}_{aw1n} {C}_{αγθ n} ) + \dot{β} {a}_{1 n} \{ \dot{α} ( {m}_{sawcn} {C}_{αγ n} + {m}_{sawbn} {S}_{α} ) + {m}_{sn} {\dot{z}}_{6 n} {S}_{α γη n} + ( \dot{α} + {\dot{η}}_{n} ) {m}_{sn} {z}_{6 n} {C}_{αγη n} + ( \dot{α} + {\dot{θ}}_{n} ) {m}_{aw1n} {S}_{αγθ n} \} - {\dot{β}}^{2} {m}_{b} {A}_{2} {A}_{1} - [ {\dot{β}}^{2} \{ {m}_{sn} {B}_{1} ( - {z}_{6 n} {S}_{αγ η n} - {A}_{4} ) + {m}_{an} {B}_{2} ( {e}_{1} {C}_{αγθ n} - {A}_{6} ) + {m}_{wn} {B}_{3} ( {e}_{3} {C}_{αγθ n} - {A}_{6} ) \} + {\dot{z}}_{6 n} \dot{β} {m}_{sn} {a}_{1 n} {S}_{αγη n} + {\dot{η}}_{n} \dot{β} {m}_{sn} {z}_{6 n} {a}_{1 n} {C}_{αγη n} + \dot{θ} \dot{β} {m}_{aw1n} {a}_{1 n} {S}_{αγθ n} + \dot{α} \dot{β} {a}_{1 n} \{ {m}_{sawcn} {C}_{αγ n} + {m}_{sawbn} {S}_{α} + {m}_{sn} {z}_{6 n} {C}_{αγη n} + {m}_{aw1n} {S}_{αγθ n} \} ] + g {m}_{b} {A}_{2} {C}_{β} - g \{ {m}_{sn} {z}_{6 n} {S}_{αγη n} - {m}_{aw1n} {C}_{αγθ n} + {m}_{sawcn} {S}_{α γ n} - {m}_{sawbn} {C}_{α} \} {C}_{β} = {λ}_{3 n} \{ - {z}_{12 n} {S}_{α} + {e}_{3 n} {C}_{αγ θ n} - {c}_{2 n} {S}_{αγ n} + {b}_{2 n} {C}_{α} \} {C}_{β} & ( 2.95 ) \\ {\ddot{z}}_{0} \{ {m}_{b} {A}_{2} + {m}_{aw1n} {C}_{αγ θ n} - {z}_{6 n} {m}_{sn} {S}_{αγη n} - {m}_{sawcn} {S}_{αγ n} + {m}_{sawbn} {C}_{α} \} {C}_{β} - \ddot{β} {m}_{ba} {A}_{2} + \ddot{α} \{ {m}_{bbI} + {m}_{sawIn} + {m}_{sn} {z}_{6 n} ( {z}_{6 n} + 2 {E}_{1 n} ) - 2 {m}_{aw1n} {H}_{1 n} \} + {m}_{sn} ( 2 \dot{α} {\dot{z}}_{6 n} + {\ddot{η}}_{n} {\dot{z}}_{6 n} ) ( {z}_{6 n} + {E}_{1 n} ) - 2 \dot{α} ( {m}_{sn} {z}_{6 n} {\dot{η}}_{n} {E}_{2 n} + {\dot{θ}}_{n} {m}_{aw1n} {H}_{2 n} ) + {\ddot{z}}_{6 n} {m}_{sn} {E}_{2 n} - {\dot{η}}_{n}^{2} {m}_{sn} {z}_{6 n} {E}_{2 n} + \ddot{θ} ( {m}_{aw21n} - {m}_{aw1n} {H}_{1 n} ) - {\dot{θ}}_{n}^{2} {m}_{aw1n} {H}_{2 n} + \ddot{β} {a}_{1 n} ( {m}_{sawcn} {S}_{αγ n} - {m}_{sawbn} {C}_{α} + {m}_{sn} {z}_{6 n} {S}_{αγ η n} - {m}_{aw1n} {C}_{αγθ n} ) - {\dot{β}}^{2} \{ {m}_{b} {A}_{2} {A}_{1} + {m}_{sn} {B}_{1} ( - {z}_{6 n} {S}_{αγη n} - {A}_{4} ) + {m}_{an} {B}_{2} ( {e}_{1} {C}_{αγ θ n} - {A}_{6} ) + {m}_{wn} {B}_{3} ( {e}_{3} {C}_{αγ θ n} - {A}_{6} ) \} + g {m}_{b} {A}_{2} {C}_{β} - g \{ {m}_{sn} {z}_{6 n} {S}_{αγη n} - {m}_{aw1n} {C}_{αγθ n} + {m}_{sawcn} {S}_{αγ n} - {m}_{sawbn} {C}_{α} \} {C}_{β} = {λ}_{3 n} ( - {z}_{12 n} {S}_{α} + {e}_{3 n} {C}_{αγθ n} - {c}_{2 n} {S}_{αγ n} + {b}_{2 n} {C}_{α} ) {C}_{β} ∴ \\ {\ddot{z}}_{0} \{ {m}_{b} {A}_{2} + {m}_{aw1n} {C}_{αγθ n} - {z}_{6 n} {m}_{sn} {S}_{αγη n} - {m}_{sawcn} {S}_{αγ n} + {m}_{sawbn} {C}_{α} \} {C}_{β} & ( 2.96 ) \\ \ddot{α} = \frac{\begin{matrix}\begin{matrix}\begin{matrix}\begin{matrix}\begin{matrix}\begin{matrix}\begin{matrix}{m}_{sn} ( 2 \dot{α} {\dot{z}}_{6 n} + {\ddot{η}}_{n} {z}_{6 n} + 2 {\dot{η}}_{n} {\dot{z}}_{6 n} ) ( {z}_{6 n} + {E}_{1 n} ) - 2 \dot{α} ( {m}_{sn} {z}_{6 n} {\dot{η}}_{n} {E}_{2 n} + \\ {\dot{θ}}_{n} {m}_{aw1n} {H}_{2 n} ) + {\ddot{z}}_{6 n} {m}_{sn} {E}_{2 n} - {\dot{η}}_{n}^{2} {m}_{sn} {z}_{6 n} {E}_{2 n} +\end{matrix} \\ \ddot{θ} ( {m}_{aw21n} - {m}_{aw1n} {H}_{1 n} ) - {\dot{θ}}_{n}^{2} {m}_{aw1n} {H}_{2 n} +\end{matrix} \\ \ddot{β} {a}_{1 n} ( {m}_{sawcn} {S}_{αγ n} - {m}_{sawbn} {C}_{α} + {m}_{sn} {z}_{6 n} {S}_{αγ η n} - {m}_{aw1n} {C}_{αγθ n} ) -\end{matrix} \\ {\dot{β}}^{2} \{ {m}_{b} {A}_{2} {A}_{1} + {m}_{sn} {B}_{1} ( - {z}_{6 n} {S}_{αγ η n} - {A}_{4} ) +\end{matrix} \\ {m}_{an} {B}_{2} ( {e}_{1} {C}_{αγθ n} - {A}_{6} ) + {m}_{wn} {B}_{3} ( {e}_{3} {C}_{αγθ n} - {A}_{6} ) \} +\end{matrix} \\ g {m}_{b} {A}_{2} {C}_{β} - g \{ {m}_{sn} {z}_{6 n} {S}_{αγη n} - {m}_{aw1n} {C}_{αγ θ n} + {m}_{sawcn} {S}_{αγ n} -\end{matrix} \\ \begin{matrix}{m}_{sawbn} {C}_{α} \} {C}_{β} - \ddot{β} {m}_{ba} {A}_{2} + {λ}_{3 n} ( {z}_{12 n} {S}_{α} - {e}_{3 n} {C}_{αγθ n} + \\ {c}_{2 n} {S}_{αγ n} - {b}_{2 n} {C}_{α} ) {C}_{β}\end{matrix}\end{matrix}}{( - \{ {m}_{bbI} + {m}_{saw1n} + {m}_{sn} {z}_{6 n} ( {z}_{6 n} + 2 {E}_{1 n} ) - 2 {m}_{aw1n} {H}_{1 n} \} )} & ( 2.97 ) \\ \begin{matrix}\frac{ⅆ}{ⅆ t} ( \frac{\partial L}{\partial {\dot{η}}_{n}} ) - \frac{\partial L}{\partial {η}_{n}} = \frac{\partial F}{\partial {\dot{η}}_{n}} + {\sum }_{l , n} {λ}_{l n} {a}_{l n3} & l = 1 , 2 , 3 & n = i , ii , iii , iv\end{matrix} & ( 2.98 ) \\ {m}_{sn} {\ddot{η}}_{n} {z}_{6 n}^{2} + 2 {m}_{sn} {\dot{η}}_{n} {\dot{z}}_{6 n} {z}_{6 n} + \ddot{α} {m}_{sn} {z}_{6 n} \{ {z}_{6 n} + {c}_{1 n} cos {η}_{n} - {b}_{2 n} sin ( {γ}_{n} + {η}_{n} ) \} + \dot{α} {m}_{sn} {\dot{z}}_{6 n} \{ {z}_{6 n} + {c}_{1 n} cos {η}_{n} - {b}_{2 n} sin ( {γ}_{n} + {η}_{n} ) \} + \dot{α} {m}_{sn} {z}_{6 n} \{ {\dot{z}}_{6 n} - {\dot{η}}_{n} [ {c}_{1 n} sin {η}_{n} + {b}_{2 n} cos ( {γ}_{n} + {η}_{n} ) ] \} + \ddot{β} {m}_{sn} {z}_{6 n} {a}_{1 n} sin ( α + {γ}_{n} + {η}_{n} ) + \dot{β} {m}_{sn} {\dot{z}}_{6 n} {a}_{1 n} sin ( α + {γ}_{n} + {η}_{n} ) + \dot{β} ( \dot{α} + {\dot{η}}_{n} ) + \dot{β} ( \dot{α} + {\dot{η}}_{n} ) {m}_{sn} {z}_{6 n} {a}_{1 n} cos ( α + {γ}_{n} + {η}_{n} ) - {\ddot{z}}_{0} {z}_{6 n} {m}_{sn} sin ( α + {γ}_{n} + {η}_{n} ) cos β - {\dot{z}}_{0} {\dot{z}}_{6 n} {m}_{sn} sin ( α + {γ}_{n} + {η}_{n} ) cos β - ( \dot{α} + {\dot{η}}_{n} ) {\dot{z}}_{0} {z}_{6 n} {m}_{sn} cos ( α + {γ}_{n} + {η}_{n} ) cos β - \dot{β} {\dot{z}}_{0} {\dot{z}}_{6 n} {m}_{sn} sin ( α + {γ}_{n} + {η}_{n} ) sin β - ⟨ {\dot{α}}^{2} {m}_{sn} {z}_{6 n} \{ - {c}_{1 n} sin {η}_{n} - {b}_{2 n} cos ( {γ}_{n} + {η}_{n} ) \} + {\dot{β}}^{2} {m}_{sn} \{ {z}_{6 n} cos ( α + {γ}_{n} + {η}_{n} ) + {c}_{1 n} cos ( α + {γ}_{n} ) + {b}_{2 n} sin α \} \{ - {z}_{6 n} sin ( α + {γ}_{n} + {η}_{n} ) \} + {\dot{z}}_{6 n} \dot{α} {m}_{sn} \{ {c}_{1 n} cos {η}_{n} - {b}_{2 n} sin ( {γ}_{n} + {η}_{n} ) \} + {\dot{z}}_{6 n} \dot{β} {m}_{sn} {a}_{1 n} sin ( α + {γ}_{n} + {η}_{n} ) - {\dot{η}}_{n} \dot{α} {m}_{sn} {z}_{6 n} \{ {c}_{1 n} sin {η}_{n} + {b}_{2 n} cos ( {γ}_{n} + {η}_{n} ) \} + {\dot{η}}_{n} \dot{β} {m}_{sn} {z}_{6 n} {a}_{1 n} cos ( α + {γ}_{n} + {η}_{n} ) + \dot{α} \dot{β} {a}_{1 n} {m}_{sn} {z}_{6 n} cos ( α + {γ}_{n} + {η}_{n} ) + g {m}_{sn} {z}_{6 n} sin ( α + {γ}_{n} + {η}_{n} ) cos β - {\dot{z}}_{0} \{ {z}_{6 n} {m}_{sn} sin ( α + {γ}_{n} + {η}_{n} ) + ( \dot{α} + {\dot{η}}_{n} ) {\dot{z}}_{0} {z}_{6 n} {m}_{sn} cos ( α + {γ}_{n} + {η}_{n} ) \} cos β + \dot{β} {\dot{z}}_{0} {\dot{z}}_{6 n} {m}_{sn} sin ( α + {γ}_{n} + {η}_{n} ) sin β ⟩ = - {λ}_{1 n} ( {z}_{6 n} - {d}_{1 n} ) cos {η}_{n} + {λ}_{2 n} ( {z}_{6 n} - {d}_{1 n} ) sin {η}_{n} & ( 2.99 ) \\ {m}_{sn} {\ddot{η}}_{n} {z}_{6 n}^{2} + 2 {m}_{sn} {\dot{η}}_{n} {\dot{z}}_{6 n} {z}_{6 n} + \ddot{α} {m}_{sn} {z}_{6 n} \{ {z}_{6 n} + {E}_{1} \} + \dot{α} {m}_{sn} {\dot{z}}_{6 n} \{ 2 {z}_{6 n} + {E}_{1} \} - \dot{α} {m}_{sn} {z}_{6 n} {\dot{η}}_{n} {E}_{2} + \ddot{β} {m}_{sn} {z}_{6 n} {a}_{1 n} {S}_{αγ η n} + \dot{β} {m}_{sn} {\dot{z}}_{6 n} {a}_{1 n} {S}_{αγη n} + \dot{β} ( \dot{α} + {\dot{η}}_{n} ) {m}_{sn} {z}_{6 n} {a}_{1 n} {C}_{α γη n} - {\ddot{z}}_{0} {z}_{6 n} {m}_{sn} {S}_{αγη n} {C}_{β} + {\dot{α}}^{2} {m}_{sn} {z}_{6 n} {E}_{2} + {\dot{β}}^{2} {m}_{sn} {B}_{1} {z}_{6 n} {S}_{αγη n} - {\dot{z}}_{6 n} \dot{α} {m}_{sn} {E}_{1} - {\dot{z}}_{6 n} \dot{β} {m}_{sn} {a}_{1 n} {S}_{αγη n} + {\dot{η}}_{n} \dot{α} {m}_{sn} {z}_{6 n} {E}_{2} - {\dot{η}}_{n} \dot{β} {m}_{sn} {z}_{6 n} {a}_{1 n} {C}_{αγη n} - \dot{α} \dot{β} {a}_{1 n} {m}_{sn} {z}_{6 n} {C}_{αγ η n} - g {m}_{sn} {z}_{6 n} {S}_{αγη n} {C}_{β} = - {λ}_{1 n} ( {z}_{6 n} - {d}_{1 n} ) {C}_{η n} + {λ}_{2 n} ( {z}_{6 n} - {d}_{1 n} ) {S}_{η n} & ( 2.100 ) \\ {m}_{sn} {z}_{6 n} \{ {\ddot{η}}_{n} {z}_{6 n} + 2 {\dot{η}}_{n} {\dot{z}}_{6 n} + \ddot{α} ( {z}_{6 n} + {E}_{1} ) + 2 \dot{α} {\dot{z}}_{6 n} + \ddot{β} {a}_{1 n} {S}_{αγη n} - {\ddot{z}}_{0} {S}_{αγη n} {C}_{β} + {\dot{α}}^{2} {E}_{2} + {\dot{β}}^{2} {B}_{1} {S}_{αγη n} - g {S}_{αγη n} {C}_{β} \} = - {λ}_{1 n} ( {z}_{6 n} - {d}_{1 n} ) {C}_{η n} + {λ}_{2 n} ( {z}_{6 n} - {d}_{1 n} ) {S}_{η n} ∴ & ( 2.101 ) \\ {λ}_{1 n} = \frac{\begin{matrix}\begin{matrix}{m}_{sn} {z}_{6 n} \{ {\ddot{η}}_{n} {z}_{6 n} + 2 {\dot{η}}_{n} {\dot{z}}_{6 n} + \ddot{α} ( {z}_{6 n} + {E}_{1} ) + 2 \dot{α} {\dot{z}}_{6 n} + \ddot{β} {a}_{1 n} {S}_{αγη n} - \\ {\ddot{z}}_{0} {S}_{αγη n} {C}_{β} + {\dot{α}}^{2} {E}_{2} + {\dot{β}}^{2} {B}_{1} {S}_{αγη n} - g {S}_{αγη n} {C}_{ β} \} -\end{matrix} \\ {λ}_{2 n} ( {z}_{6 n} - {d}_{1 n} ) {S}_{η n}\end{matrix}}{( - ( {z}_{6 n} - {d}_{1 n} ) {C}_{η n} )} & ( 2.102 ) \\ \begin{matrix}\frac{ⅆ}{ⅆ t} ( \frac{\partial L}{\partial {\dot{θ}}_{n}} ) - \frac{\partial L}{\partial {θ}_{n}} = \frac{\partial F}{\partial {\dot{θ}}_{n}} + {\sum }_{l , n} {λ}_{l n} {a}_{l n 4} & l = 1 , 2 , 3 & n = i , ii , iii , iv\end{matrix} & ( 2.103 ) \\ {\ddot{θ}}_{n} {m}_{aw21n} + \ddot{α} [ {m}_{aw21n} - {m}_{aw1n} \{ {c}_{2 n} sin {θ}_{n} - {b}_{2 n} cos ( {γ}_{n} + {θ}_{n} ) \} - \dot{α} {\dot{θ}}_{n} {m}_{aw1n} \{ {c}_{2 n} cos {θ}_{n} + {b}_{2 n} sin ( {γ}_{n} + {θ}_{n} ) \} - \ddot{β} {m}_{aw1n} {a}_{1 n} cos ( α + {γ}_{n} + {θ}_{n} ) + \dot{β} ( \dot{α} + {\dot{θ}}_{n} ) {m}_{aw1n} {a}_{1 n} sin ( α + {γ}_{n} + {θ}_{n} ) + {\ddot{z}}_{0} {m}_{aw1n} cos ( α + {γ}_{n} + {θ}_{n} ) cos β - ( \dot{α} + {\dot{θ}}_{n} ) {\dot{z}}_{0} {m}_{aw1n} sin ( α + {γ}_{n} + {θ}_{n} ) cos β - \dot{β} {\dot{z}}_{0} {m}_{aw1n} cos ( α + {γ}_{n} + {θ}_{n} ) sin β - [ - {k}_{zi} {e}_{0 i}^{2} \{ sin ( {γ}_{i} + {θ}_{i} ) - sin ( {γ}_{ii} + {θ}_{ii} ) \} cos ( {γ}_{n} + {θ}_{n} ) {X}_{s} - {k}_{ziii} {e}_{0 iii}^{2} \{ sin ( {γ}_{iii} + {θ}_{iii} ) - sin ( {γ}_{iv} + {θ}_{iv} ) \} cos ( {γ}_{n} + {θ}_{n} ) {X}_{s} - {\dot{α}}^{2} {m}_{aw1n} \{ {c}_{2 n} cos {θ}_{n} + {b}_{2 n} sin ( {γ}_{n} + {θ}_{n} ) \} + {\dot{β}}^{2} ⟨ {m}_{an} \{ {e}_{1 n} sin ( α + {γ}_{n} + {θ}_{n} ) + {c}_{2 n} cos ( α + {γ}_{n} ) + {b}_{2 n} sin α \} {e}_{1 n} cos ( α + {γ}_{n} + {θ}_{n} ) + {m}_{wn} \{ {e}_{3 n} sin ( α + {γ}_{n} + {θ}_{n} ) + {c}_{2 n} cos ( α + {γ}_{n} ) + {b}_{2 n} sin α \} {e}_{3 n} cos ( α + {γ}_{n} + {θ}_{n} ) ⟩ - \dot{θ} \dot{α} {m}_{aw1n} \{ {c}_{2 n} cos {θ}_{n} + {b}_{2 n} sin ( {γ}_{n} + {θ}_{n} ) \} + \dot{θ} \dot{β} {m}_{aw1n} {a}_{1 n} sin ( α + {γ}_{n} + {θ}_{n} ) + \dot{α} \dot{β} {a}_{1 n} {m}_{aw1n} sin ( α + {γ}_{n} + {θ}_{n} ) - g {m}_{aw1n} cos ( α + {γ}_{n} + {θ}_{n} ) cos β - {\dot{z}}_{0} ( \dot{α} + {\dot{θ}}_{n} ) {m}_{aw1n} sin ( α + {γ}_{n} + {θ}_{n} ) cos β - \dot{β} {\dot{z}}_{0} {m}_{aw1n} cos ( α + {γ}_{n} + {θ}_{n} ) sin β ] = {λ}_{1 n} {e}_{2 n} sin {θ}_{n} + {λ}_{2 n} {e}_{2 n} cos {θ}_{n} + {λ}_{3 n} {e}_{3 n} cos ( α + {γ}_{n} + {θ}_{n} ) cos β & ( 2.104 ) \\ {\ddot{θ}}_{n} {m}_{aw21n} + \ddot{α} ( {m}_{aw21n} - {m}_{aw1n} {H}_{1} ) - \dot{α} {\dot{θ}}_{n} {m}_{aw1n} {H}_{2} - \ddot{β} {m}_{aw1n} {a}_{1 n} {C}_{αγθ n} + \dot{β} ( \dot{α} + {\dot{θ}}_{n} ) {m}_{aw1n} {a}_{1 n} {S}_{αγθ n} + {\ddot{z}}_{0} {m}_{aw1n} {C}_{αγθ n} {C}_{β} - [ - {k}_{zi} {e}_{0 i}^{2} \{ sin ( {γ}_{i} + {θ}_{i} ) + sin ( {γ}_{ii} + {θ}_{ii} ) \} {X}_{s} - {k}_{ziii} {e}_{0 iii}^{2} \{ sin ( {γ}_{iii} + {θ}_{iii} ) + sin ( {γ}_{iv} + {θ}_{iv} ) \} cos ( {γ}_{n} + {θ}_{n} ) {X}_{s} - {\dot{α}}^{2} {m}_{aw1n} {H}_{2} + {\dot{β}}^{2} ( {m}_{an} {B}_{2} {e}_{1 n} {C}_{αγθ n} + {m}_{wn} {B}_{3} {e}_{3 n} {C}_{αγ θ n} ) - \dot{θ} \dot{α} {m}_{aw1n} {H}_{2} + \dot{θ} \dot{β} {m}_{aw1n} {a}_{1 n} {S}_{αγ θ n} + \dot{α} \dot{β} {a}_{1 n} {m}_{aw1n} {S}_{α γθ n} - g {m}_{aw1n} {C}_{αγθ n} {C}_{β} ] = {λ}_{1 n} {e}_{2 n} {S}_{θ n} + {λ}_{2 n} {e}_{2 n} {C}_{θ n} + {λ}_{3 n} {e}_{3 n} {C}_{αγθ n} {C}_{β} & ( 2.105 ) \\ {\ddot{θ}}_{n} {m}_{aw21n} + \ddot{α} ( {m}_{aw21n} - {m}_{aw1n} {H}_{1} ) - \ddot{β} {m}_{aw1n} {a}_{1 n} {C}_{αγθ n} + {\ddot{z}}_{0} {m}_{aw1n} {C}_{αγθ n} {C}_{β} + {\dot{α}}^{2} {m}_{aw1n} {H}_{2} - {\dot{β}}^{2} ( {m}_{an} {B}_{2} {e}_{1 n} {C}_{αγθ n} + {m}_{wn} {B}_{3} {e}_{3 n} {C}_{αγ θ n} ) + g {m}_{aw1n} {C}_{αγθ n} {C}_{β} + {k}_{zi} {e}_{0 i}^{2} \{ sin ( {γ}_{i} + {θ}_{i} ) + sin ( {γ}_{ii} + {θ}_{ii} ) \} cos ( {γ}_{n} + {θ}_{n} ) + {k}_{ziii} {e}_{0 iii}^{2} \{ sin ( {γ}_{iii} + {θ}_{iii} ) + sin ( {γ}_{iv} + {θ}_{iv} ) \} cos ( {γ}_{n} + {θ}_{n} ) = {λ}_{1 n} {e}_{2 n} {S}_{θ n} + {λ}_{2 n} {e}_{2 n} {C}_{θ n} + {λ}_{3 n} {e}_{3 n} {C}_{αγθ n} {C}_{β} ∴ & ( 2.106 ) \\ {\ddot{θ}}_{n} = \frac{\begin{matrix}\ddot{α} ( {m}_{aw21n} - {m}_{aw1n} {H}_{1} ) - \\ \begin{matrix}\ddot{β} {m}_{aw1n} {a}_{1 n} {C}_{αγθ n} + {\ddot{z}}_{0} {m}_{aw1n} {C}_{αγθ n} {C}_{β} + {\dot{α}}^{2} {m}_{aw1n} {H}_{2} - \\ {\dot{β}}^{2} ( {m}_{an} {B}_{2} {e}_{1 n} {C}_{αγθ n} + {m}_{wn} {B}_{3} {e}_{3 n} {C}_{αγθ n} ) + g {m}_{aw1n} {C}_{α1γθ n} {C}_{β} - \\ {λ}_{1 n} {e}_{2 n} {S}_{θ n} - {λ}_{2 n} {e}_{2 n} {C}_{θ n} - {λ}_{3 n} {e}_{3 n} {C}_{α γθ n} {C}_{β} + \\ {k}_{zi} {e}_{0 i}^{2} \{ sin ( {γ}_{i} + {θ}_{i} ) + sin ( {γ}_{ii} + {θ}_{ii} ) \} cos ( {γ}_{n} + {θ}_{n} ) + \\ {k}_{ziii} {e}_{0 iii}^{2} \{ sin ( {γ}_{iii} + {θ}_{iii} ) + sin ( {γ}_{iv} + {θ}_{iv} ) \} cos ( {γ}_{n} + {θ}_{n} )\end{matrix}\end{matrix}}{- {m}_{aw21n} )} & ( 2.107 ) \\ \frac{ⅆ}{ⅆ t} ( \frac{\partial L}{\partial {\dot{z}}_{6 n}} ) - \frac{\partial L}{\partial {z}_{6 n}} = \frac{\partial F}{\partial {\dot{z}}_{6 n}} + {\sum }_{l , n} {λ}_{l n} {a}_{l n5} \\ \begin{matrix}l = 1 , 2 , 3 & n = i , ii , iii , iv\end{matrix} & ( 2.108 ) \\ {m}_{sn} {\ddot{z}}_{6 n} + \ddot{α} {m}_{sn} \{ {c}_{1 n} sin {η}_{n} + {b}_{2 n} cos ( {γ}_{n} + {η}_{n} ) \} + \dot{α} {\dot{η}}_{n} {m}_{sn} \{ {c}_{1} cos {η}_{n} - {b}_{2 n} sin ( {γ}_{n} + {η}_{n} ) \} - \ddot{β} {m}_{sn} {a}_{1 n} cos ( α + {γ}_{n} + {η}_{n} ) + \dot{β} ( \dot{α} + {\dot{η}}_{n} ) {m}_{sn} {a}_{1 n} sin ( α + {γ}_{n} + {η}_{n} ) + {\ddot{z}}_{0} {m}_{sn} cos ( α + {γ}_{n} + {η}_{n} ) cos β - ( \dot{α} + {\dot{η}}_{n} ) {\dot{z}}_{0} {m}_{sn} sin ( α + {γ}_{n} + {η}_{n} ) cos β - \dot{β} {\dot{z}}_{0} {m}_{sn} cos ( α + {γ}_{n} + {η}_{n} ) sin β - ⟨ {m}_{sn} {\dot{η}}_{n}^{2} {z}_{6 n} + {\dot{α}}^{2} {m}_{sn} [ {z}_{6 n} + \{ {c}_{1 n} cos {η}_{n} - {b}_{2 n} sin ( {γ}_{n} + {η}_{n} ) \} ] + {\dot{β}}^{2} {m}_{sn} \{ {z}_{6 n} cos ( α + {γ}_{n} + {η}_{n} ) + {c}_{1 n} cos ( α + {γ}_{n} ) + {b}_{2 n} sin α \} cos ( α + {γ}_{n} + {η}_{n} ) + {\dot{η}}_{n} \dot{α} {m}_{sn} \{ 2 {z}_{6 n} + {c}_{1 n} cos {η}_{n} - {b}_{2 n} sin ( {γ}_{n} + {η}_{n} ) \} + {\dot{η}}_{n} \dot{β} {m}_{sn} {a}_{1 n} sin ( α + {γ}_{n} + {η}_{n} ) + \dot{α} \dot{β} {a}_{1 n} {m}_{sn} sin ( α + {γ}_{n} + {η}_{n} ) - g {m}_{sn} cos ( α + {γ}_{n} + {η}_{n} ) cos β - {k}_{sn} ( {z}_{6 n} - {l}_{sn} ) + {\dot{z}}_{0} ( \dot{α} + {\dot{η}}_{n} ) {m}_{sn} sin ( α + {γ}_{n} + {η}_{n} ) cos β - \dot{β} {\dot{z}}_{0} {m}_{sn} cos ( α + {γ}_{n} + {η}_{n} ) sin β ⟩ = - {c}_{sn} {\dot{z}}_{6 n} - {λ}_{1 n} sin {η}_{n} - {λ}_{2 n} cos {η}_{n} ∴ & ( 2.109 ) \\ {m}_{sn} \{ {\ddot{z}}_{6 n} + \ddot{α} {E}_{2} - \ddot{β} {a}_{1 n} {C}_{αγ η n} = {\dot{η}}_{n}^{2} {z}_{6 n} - {\dot{α}}^{2} ( {z}_{6 n} + {E}_{1} ) - {\dot{β}}^{2} {B}_{1} {C}_{αγη n} - 2 {\dot{η}}_{n} \dot{α} {z}_{6 n} + g {C}_{αγη n} {C}_{β} \} + {k}_{sn} ( {z}_{6 n} - {l}_{sn} ) = - {c}_{sn} {\dot{z}}_{6 n} - {λ}_{1 n} {S}_{η n} - {λ}_{2 n} {C}_{η n} ∴ & ( 2.110 ) \\ {λ}_{2 n} = \frac{\begin{matrix}\begin{matrix}{m}_{sn} \{ {\ddot{z}}_{6 n} + \ddot{α} {E}_{2} - \ddot{β} {a}_{1 n} {C}_{αγ η n} - {\dot{η}}_{n}^{2} {z}_{6 n} - {\dot{α}}^{2} ( {z}_{6 n} + {E}_{1} ) - \\ {\dot{β}}^{2} {B}_{1} {C}_{αγη n} - 2 {\dot{η}}_{n} \dot{α} {z}_{6 n} + g {C}_{αγη n} {C}_{β} \} + {k}_{sn} ( {z}_{6 n} - {l}_{sn} ) +\end{matrix} \\ {c}_{sn} {\dot{z}}_{6 n} + {λ}_{1 n} {S}_{η n}\end{matrix}}{- {C}_{η n}} & ( 2.111 ) \\ \frac{ⅆ}{ⅆ t} ( \frac{\partial L}{\partial {\dot{z}}_{12 n}} ) - \frac{\partial L}{\partial {z}_{12 n}} = \frac{\partial F}{\partial {\dot{z}}_{12 n}} + {\sum }_{l , n} {λ}_{l n} {a}_{l n6} \\ \begin{matrix}l = 1 , 2 , 3 & n = i , ii , iii , iv\end{matrix} & \\ \begin{matrix}{k}_{wn} ( {z}_{12 n} - {l}_{wn} ) = - {c}_{wn} {\dot{z}}_{12 n} + {λ}_{3 n} cos α cos β \\ = - {c}_{wn} {\dot{z}}_{12 n} + {λ}_{3 n} {C}_{α} {C}_{β} ∴\end{matrix} & ( 2.112 ) \\ {λ}_{3 n} = \frac{{c}_{wn} {\dot{z}}_{12 n} + {k}_{wn} ( {z}_{12 n} - {l}_{wn} )}{{C}_{α}} & ( 2.113 )\end{matrix}$$

From the differentiated constraints it follows that:

\ddot{θ}ₙe₂ₙS₀ₙ+\dot{θ}ₙ²e₂ₙC_{θn}−\ddot{z}₆ₙS_{ηn}−\dot{z}₆ₙ\dot{η}ₙC_{ηn}−\ddot{η}ₙ(z₆ₙ−d₁ₙ)C_{ηn}−\dot{η}ₙ\dot{z}₆ₙC_{ηn}+\dot{η}ₙ²(z₆ₙ−d₁ₙ)S_{η}ₙ=0

\ddot{θ}ₙe₂ₙC_{θn}−\dot{θ}ₙ²e₂ₙS_{θn}−\ddot{z}₆ₙC_{ηn}+\dot{z}₆ₙ\dot{η}ₙS_{ηn}+\ddot{η}ₙ(z₆ₙ−d₁ₙ)S_{ηn}+\dot{η}ₙ\dot{z}₆ₙS_{ηn}+\dot{η}ₙ²(z₆ₙ−d₁ₙ)C_{ηn}=0 (2.114)

$$\begin{matrix}{\ddot{η}}_{n} = \frac{\begin{matrix}{\ddot{θ}}_{n} {e}_{2 n} {S}_{0 n} + {\dot{θ}}_{n}^{2} {e}_{2 n} {C}_{θ n} - {\ddot{z}}_{6 n} {S}_{η n} - \\ 2 {\dot{η}}_{n} {\dot{z}}_{6 n} {C}_{η n} + {\dot{η}}_{n}^{2} ( {z}_{6 n} - {d}_{1 n} ) {S}_{η n}\end{matrix}}{( {z}_{6 n} - {d}_{1 n} ) {C}_{η n}} & ( 2.115 ) \\ {\ddot{z}}_{6 n} = \frac{\begin{matrix}{\ddot{θ}}_{n} {e}_{2 n} {C}_{0 n} - {\dot{θ}}_{n}^{2} {e}_{2 n} {S}_{θ n} + {\ddot{η}}_{n} ( {z}_{6 n} - {d}_{1 n} ) {S}_{η n} + \\ 2 {\dot{η}}_{n} {\dot{z}}_{6 n} {S}_{η n} + {\dot{η}}_{n}^{2} ( {z}_{6 n} - {d}_{1 n} ) {C}_{η n}\end{matrix}}{{C}_{η n}} \\ \text{and} & ( 2.116 ) \\ {\dot{z}}_{12 n} = \frac{\begin{matrix}\{ \dot{α} {z}_{12 n} {S}_{α} - ( \dot{α} + {\dot{θ}}_{n} ) {e}_{3 n} {C}_{αγ θ n} + \dot{α} {c}_{2 n} {S}_{αγ n} - \\ \dot{α} {b}_{2 n} {C}_{a} \} {C}_{β -} {\dot{z}}_{0} + \dot{β} [ \{ {z}_{12 n} {C}_{α} + {e}_{3 n} {S}_{αγ θ n} + {c}_{2 n} {C}_{αγ n} + \\ {b}_{2 n} {S}_{α} \} {S}_{β} + {a}_{1 n} {C}_{β} ] + {\dot{R}}_{n} ( t )\end{matrix}}{{C}_{α} {C}_{β}} & ( 2.117 )\end{matrix}$$

Supplemental differentiation of equation (2.113) for the later entropy production calculation yields:

k_{wn}\dot{z}₁₂ₙ=−c_{wn}\ddot{z}₁₂ₙ+\dot{λ}₃ₙC_{α}C_{β}−\dot{α}λ₃ₙS_{α}C_{β}−\dot{β}λ₃ₙC_{α}S_{β} (2.118)

therefore

$${\ddot{z}}_{12 n} = \frac{{\dot{λ}}_{3 n} {C}_{α} {C}_{β} - \dot{α} {λ}_{3 n} {S}_{α} {C}_{β} - \dot{β} {λ}_{3 n} {C}_{α} {S}_{β} - {k}_{wn} {\dot{z}}_{12 n}}{{c}_{wn}} \qquad ( 2.119 )$$

or from the third equation of constraint:

$$\begin{matrix}{\ddot{z}}_{0} + \{ {\ddot{z}}_{12 n} cos α - {\dot{z}}_{12 n} \dot{α} cos α - \ddot{α} {z}_{12 n} sin α - \dot{α} {\dot{z}}_{12 n} sin α - {\dot{α}}^{2} {z}_{12 n} cos α + ( \ddot{α} + {\dot{θ}}_{n} ) {e}_{3 n} cos ( α + {γ}_{n} + {θ}_{n} ) - {( \dot{α} + {\dot{θ}}_{n} )}^{2} {e}_{3 n} sin ( α + {γ}_{n} + {θ}_{n} ) - \ddot{α} {c}_{2 n} sin ( α + {γ}_{n} ) - {\dot{α}}^{2} {c}_{2 n} cos ( α + {γ}_{n} ) + \ddot{α} {b}_{2 n} cos α - {\dot{α}}^{2} {b}_{2 n} sin α \} cos β - \dot{β} \{ {\dot{z}}_{12 n} cos α - \dot{α} {z}_{12 n} sin α + ( \dot{α} + {\dot{θ}}_{n} ) {e}_{3 n} cos ( α + {γ}_{n} + {θ}_{n} ) - \dot{α} {c}_{2 n} sin ( α + {γ}_{n} ) + \dot{α} {b}_{2 n} cos α \} sin β - \ddot{β} [ \{ {z}_{12 n} cos α + {e}_{3 n} sin ( α + {γ}_{n} + {θ}_{n} ) + {c}_{2 n} cos ( α + {γ}_{n} ) + {b}_{2 n} sin α \} sin β + {a}_{1 n} cos β ] - \dot{β} [ \{ {\dot{z}}_{12 n} cos α - \dot{α} {z}_{12 n} sin α + ( \dot{α} + {\dot{θ}}_{n} ) {e}_{3 n} cos ( α + {γ}_{n} + {θ}_{n} ) - ( \dot{α} + {\dot{γ}}_{n} ) {c}_{2 n} sin ( α + {γ}_{n} ) + \dot{α} {b}_{2 n} cos α \} sin β + \dot{β} \{ {z}_{12 n} cos α + {e}_{3 n} sin ( α + {γ}_{n} + {θ}_{n} ) + {c}_{2 n} cos ( α + {γ}_{n} ) + {b}_{2 n} sin α \} cos β - \dot{β} {a}_{1 n} sin β ] - {\ddot{R}}_{n} ( t ) = 0 & ( 2.120 ) \\ {\ddot{z}}_{12 n} = \frac{\begin{matrix}\begin{matrix}\begin{matrix}\begin{matrix}\begin{matrix}\begin{matrix}\begin{matrix}\begin{matrix}\begin{matrix}\begin{matrix}{\ddot{z}}_{0} + \{ - {\dot{z}}_{12 n} \dot{α} cos α - \ddot{α} {z}_{12 n} sin α - \dot{α} {\dot{z}}_{12 n} sin α - \\ {\dot{α}}^{2} {z}_{12 n} cos α + ( \ddot{α} + {\dot{θ}}_{n} ) {e}_{3 n} cos ( α + {γ}_{n} + {θ}_{n} ) -\end{matrix} \\ {( \dot{α} + {\dot{θ}}_{n} )}^{2} {e}_{3 n} sin ( α + {γ}_{n} + {θ}_{n} ) - \ddot{α} {c}_{2 n} sin ( α + {γ}_{n} ) -\end{matrix} \\ {\dot{α}}^{2} {c}_{2 n} cos ( α + {γ}_{n} ) + \ddot{α} {b}_{2 n} cos α - {\dot{α}}^{2} {b}_{2 n} sin α \} cos β -\end{matrix} \\ \dot{β} \{ {\dot{z}}_{12 n} cos α - \dot{α} {z}_{12 n} sin α + ( \dot{α} + {\dot{θ}}_{n} ) {e}_{3 n} cos ( α + {γ}_{n} + {θ}_{n} ) -\end{matrix} \\ \dot{α} {c}_{2 n} sin ( α + {γ}_{n} ) + \dot{α} {b}_{2 n} cos α \} sin β -\end{matrix} \\ \ddot{β} [ \{ {z}_{12 n} cos α + {e}_{3 n} sin ( α + {γ}_{n} + {θ}_{n} ) + {c}_{2 n} cos ( α + {γ}_{n} ) +\end{matrix} \\ {b}_{2 n} sin α \} sin β + {a}_{1 n} cos β ] -\end{matrix} \\ \dot{β} [ \{ {\dot{z}}_{12 n} cos α - \dot{α} {z}_{12 n} sin α + ( \dot{α} + {\dot{θ}}_{n} ) {e}_{3 n} cos ( α + {γ}_{n} + {θ}_{n} ) -\end{matrix} \\ ( \dot{α} + {\dot{γ}}_{n} ) {c}_{2 n} sin ( α + {γ}_{n} ) + \dot{α} {b}_{2 n} cos α \} sin β +\end{matrix} \\ \begin{matrix}\dot{β} \{ {z}_{12 n} cos α + {e}_{3 n} sin ( α + {γ}_{n} + {θ}_{n} ) + {c}_{2 n} cos ( α + {γ}_{n} ) + \\ {b}_{2 n} sin α \} cos β - \dot{β} {a}_{1 n} sin β ] - {\ddot{R}}_{n} ( t )\end{matrix}\end{matrix}}{- cos αcos β} & ( 2.121 )\end{matrix}$$

Equations for entropy production are developed below. Minimum entropy production (for use in the fitness function of the genetic algorithm) is expressed as:

$$\begin{matrix}\frac{{d}_{β} S}{d t} = \frac{\begin{matrix}- 2 {\dot{β}}^{2} [ \dot{α} {m}_{b} {A}_{1} {A}_{2} + {m}_{sn} {B}_{1} \{ {\dot{z}}_{6 n} {C}_{αγη n} - ( \dot{α} + \\ {\dot{η}}_{n} ) {z}_{6 n} {S}_{αγη n} - \dot{α} {A}_{4} \} + {m}_{an} {B}_{2} \{ ( \dot{α} + {\dot{θ}}_{n} ) {e}_{1 n} {C}_{αγθ n} - \\ \begin{matrix}\dot{α} {A}_{6} \} + {m}_{wn} {B}_{3} \{ ( \dot{α} + {\dot{θ}}_{n} ) {e}_{3 n} {S}_{αγθ n} - \dot{α} {A}_{6} \} - \\ {\dot{z}}_{0} ( {m}_{ba} + {m}_{sawan} ) {S}_{β} / 2 ]\end{matrix}\end{matrix}}{\begin{matrix}{m}_{saw2n} + {m}_{bal} + {m}_{b} {A}_{1}^{2} + \\ {m}_{sn} {B}_{1}^{2} + {m}_{sn} {B}_{1}^{2} + {m}_{an} {B}_{2}^{2} + {m}_{wn} {B}_{3}^{2}\end{matrix}} & ( 2.122 ) \\ \frac{{d}_{α} S}{d t} = \frac{\begin{matrix}- 2 {\dot{α}}^{2} \{ {m}_{sn} \dot{α} {\dot{z}}_{6 n} ( {z}_{6 n} + {E}_{1 n} ) + {m}_{sn} {z}_{6 n} {\dot{η}}_{n} {E}_{2 n} \\ + {\dot{θ}}_{n} {m}_{aw1n} {H}_{2 n}\end{matrix}}{{m}_{bbI} + {m}_{saw 1 n} + {m}_{sn} {z}_{6 n} ( {z}_{6 n} + 2 {E}_{1 n} ) - 2 {m}_{aw 1 n} {H}_{1 n}} & ( 2.123 ) \\ \frac{{d}_{{η}_{n}} S}{d t} = {\dot{η}}_{n}^{3} t g {η}_{n} - \frac{2 {\dot{η}}_{n}^{2} {\dot{z}}_{6 n}}{{z}_{6 n} - {d}_{1 n}} & ( 2.124 ) \\ \frac{{d}_{{z}_{6 n}} S}{d t} = 2 {\dot{η}}_{n} {\dot{z}}_{6 n}^{2} t g {η}_{n} & ( 2.125 ) \\ \frac{{d}_{{z}_{6 n}} S}{d t} = {\dot{z}}_{12 n}^{2} ( \dot{α} + \dot{α} tg α + 2 \dot{β} tg β ) & ( 2.126 )\end{matrix}$$

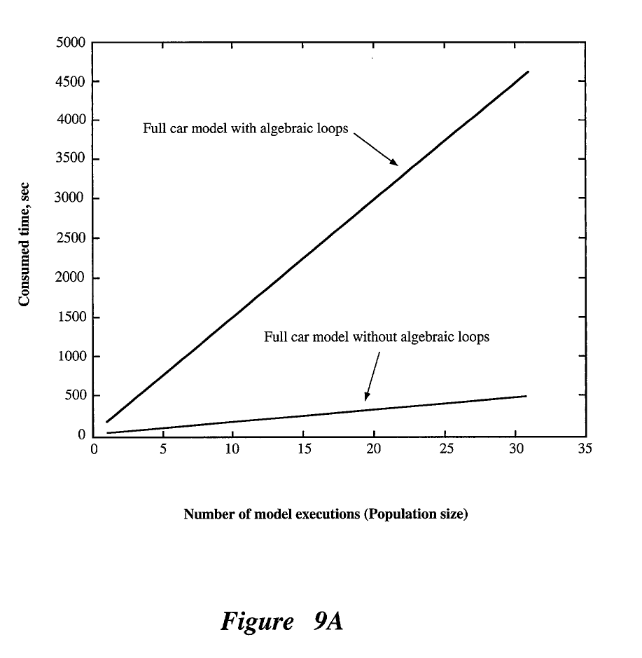

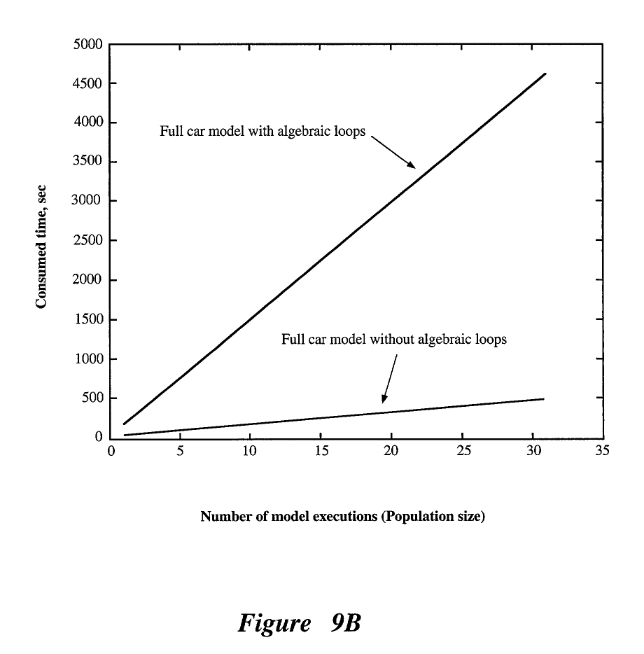

To simulate the suspension system, the suspension system equations are programmed into the equation block 201. As shown in FIG. 9A, with fixed control (e.g., with shock absorbers having a fixed damping coefficient, the suspension system simulated according to FIG. 3A (with algebraic loops) is more than nine times slower than the suspension system simulated according FIG. 4. As shown in FIG. 9B, with variable control (e.g., with shock absorbers having a variable damping coefficient, the suspension system simulated according to FIG. 3A (with algebraic loops) is approximately nine times slower than the suspension system simulated according FIG. 4.

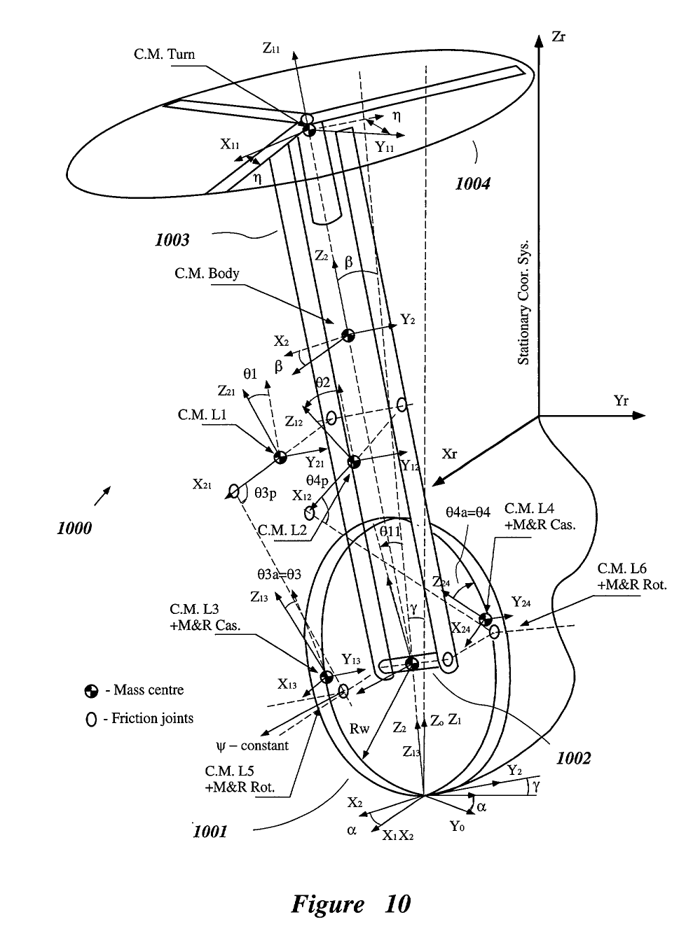

FIG. 10 shows the components and coordinate systems of a unicycle model 1000. The unicycle model 1000 includes a wheel 1001, having an axle 1001, a body 1003, and a rotor 1004. Link pairs L1, L3, and L2, L4 are connected between the body 1003 and the axle 1001. A first motor provides torque to control the angle between the links L1, L3. A second motor provides torque to control the angle between the links L1, L3.

Using the coordinate systems shown in FIG. 10, the equation of motion for the unicycle 1000 is give by:

$$\{ \begin{matrix}\ddot{α} \cdot A 0 \; 1 + \ddot{γ} \cdot A 0 \; 2 + \ddot{β} \cdot A 0 \; 3 + \ddot{θ} w \cdot A 04 + \ddot{θ} 1 \cdot A 0 \; 6 + \ddot{θ} 2 \cdot A 0 \; 7 + \ddot{θ} 3 \cdot A 0 \; 8 + \ddot{θ} 4 \cdot A 0 \; 9 + \ddot{η} \cdot A 10 + \\ + \dot{α} \cdot AA + \dot{γ} \cdot AG + \dot{β} \cdot AB + \dot{θ} w \cdot ATw + \dot{θ} 1 \cdot AT 1 + \dot{θ} 2 \cdot AT 2 + \dot{θ} 3 \cdot AT 3 + \dot{θ} 4 \cdot AT4 + AD = 0 \\ \\ \ddot{γ} \cdot G 0 \; 2 + \ddot{α} \cdot G 01 + \ddot{β} \cdot G 0 \; 3 + \ddot{θ} w \cdot ( G 0 \; 4 + G 0 \; 5 ) + \ddot{θ} 1 \cdot G 0 \; 6 + \ddot{θ} 2 \cdot G 0 \; 7 + \ddot{θ} 3 \cdot G 0 \; 8 + \ddot{θ} 4 \cdot G 0 \; 9 + \\ + \ddot{η} \cdot G 10 + \dot{γ} \cdot GG + \dot{α} \cdot GA + \dot{β} \cdot G B + \dot{θ} w \cdot ( GTw + Gs ) + \dot{θ} 1 \cdot GT 1 + \dot{θ} 2 \cdot GT 2 + \dot{θ} 3 \cdot GT 3 + \\ + \dot{θ} 4 \cdot GT 4 + BV = 0 \\ \\ \begin{matrix}\ddot{β} \cdot B 03 + \ddot{α} \cdot B 01 + \ddot{γ} \cdot B 02 + \ddot{θ} w \cdot B 04 + \ddot{θ} 1 \cdot B 06 + \ddot{θ} 2 \cdot B 0 \; 7 + \dot{β} \cdot BB + \dot{α} \cdot BA + \\ + \dot{γ} \cdot BG + \dot{θ} 1 \cdot BT 1 + \dot{θ} 2 \cdot BT 2 + BV + BD = {C}_{1} ( {λ}_{i} ) \\ \end{matrix} \\ \ddot{θ} w \cdot Tw 0 \; 4 + \ddot{α} Tw 0 \; 1 + \ddot{γ} \cdot Tw 0 \; 2 + \ddot{β} \cdot Tw 0 \; 3 + \ddot{θ} 1 \cdot Tw 0 \; 6 + \ddot{θ} 2 \cdot Tw 0 \; 7 + \ddot{θ} 3 \cdot Tw 0 \; 8 + \ddot{θ} 4 \cdot Tw 0 \; 9 + \\ \dot{α} \cdot TwA + \dot{γ} \cdot TwG + \dot{β} \cdot TwB + \dot{θ} w \cdot TwS ( TwTw ) + \dot{θ} 1 \cdot TwT 1 + \dot{θ} 2 \cdot TwT 2 + \dot{θ} 3 \cdot TwT 3 + \\ \dot{θ} 4 \cdot TwT 4 + TwV + TwD = {C}_{2} ( {λ}_{i} ) \\ \\ \ddot{θ} 1 \cdot T 10 \; 6 + \ddot{β} \cdot T 10 \; 3 + \ddot{θ} w \cdot T 10 \; 4 + \ddot{θ} 3 \cdot T 10 \; 8 + \dot{θ} 1 \cdot T 1 T 1 + \dot{β} \cdot T 1 B + \dot{θ} w \cdot T 1 S + \dot{θ} 3 \cdot T 1 T 3 = 0 \\ \ddot{θ} 2 \cdot T 20 \; 7 + \ddot{β} \cdot T 20 \; 3 + \ddot{θ} w \cdot T 204 + \ddot{θ} 4 \cdot T 20 \; 9 + \dot{θ} 2 \cdot T 2 T 2 + \dot{β} \cdot T 2 B + \dot{θ} w \cdot T 2 S + \dot{θ} 4 \cdot T 2 T 4 = 0 \\ \ddot{θ} 3 \cdot T 30 \; 8 + \ddot{β} \cdot T 30 \; 3 + \ddot{θ} w \cdot T 30 \; 4 + \ddot{θ} 1 \cdot T 30 \; 6 + \dot{θ} 3 \cdot T 3 T 3 + \dot{β} \cdot T 3 B + \dot{θ} w \cdot T 3 S + \dot{θ} 1 \cdot T 3 T 1 = 0 \\ \ddot{θ} 4 \cdot T 40 \; 9 + \ddot{β} \cdot T 40 \; 3 + \ddot{θ} w \cdot T 404 + \ddot{θ} 2 \cdot T 40 \; 7 + \dot{θ} 4 \cdot T 4 T 4 + \dot{β} \cdot T 4 B + \dot{θ} w \cdot T 4 S + \dot{θ} 2 \cdot T 4 T 2 = 0 \\ \\ \ddot{η} \cdot N 10 + \ddot{α} \cdot N 01 + \ddot{γ} \cdot N 02 + \dot{α} \cdot NA + \dot{γ} \cdot NG + \dot{β} \cdot NB + ND = {τ}_{3}\end{matrix}$$

The general equation of motion for alpha in the above unicycle equation of motion is:

\ddot{α}·A01+\ddot{γ}·A02+\ddot{β}·A03+\ddot{θ}w·A04+\ddot{θ}1·A06+\ddot{θ}2·A07+\ddot{θ}3·A08+\ddot{θ}4·A09+\ddot{η}·A10++\dot{α}·AA+\dot{γ}·AG+\dot{β}·AB+\dot{θ}w·ATw+\dot{θ}1·AT1+\dot{θ}2·AT2+\dot{θ}3·AT3+\dot{θ}4·AT4+AD=0

The coefficients of the alpha equation of motion are given by:

A01=AW01+AB01+AL01+AL201+AL301+AL401+ATt01;

where:

AW01=2[cos(γ)²(sin(θw)²II_{WShX}+cos(θw)²II_{WShZ})+sin(γ)²III_{WShYK}];

(Where III_{WShK}, II_{WShZ}, II_{WShX}, are the combined inertia moments of the wheel 1001 and the shaft 1002 around x, y, z axes.)

AB01=[sin(γ)²(M_{B}(R_{we5c})²+I_{By})+M_{B}(e5² sin(β)²)+cos(γ)²(I_{Bx} sin(β)²+I_{Bz} cos(β)²)];

(Where: R_{we5c}=Rw+e5 cos(β).)

AL101=AL101i+AL101m;

where:

AL101i=[cos(γ)²(I_{L1x} sin(ZU)²+I_{L1z} cos(ZU)²)+sin(γ)²I_{L1y}];

(Where ZU=β+θ1.)

AL101m=M_{L1}[sin(γ)²(Rw+e1 cos(β)−e2 sin(ZU))²+(e1 sin(β)+e2 cos(ZU))²++k1² cos(γ)²+k1 sin(2γ)(Rw+e1 cos(β)−e2 sin(ZU))];

AL201=AL201i+AL201m;

where:

AL201i=[cos(γ)²(I_{L2x} sin(ZZ)²+I_{L2z} cos(ZZ)²)+sin(γ)²I_{L2y}]; (Here: ZZ=β+θ2.)

AL201m=M_{L2}]sin(γ)²(Rw+e1 cos(β)−e² sin(ZZ))²+(e1 sin(β)+e2 cos(ZZ))²++k1² cos(γ)²−k1 sin(2γ)(Rw+e1 cos(β)−e2 sin(ZZ))];

AL301=AL301i+AL301m;

AL301i=cos(γ)²(I_{L3x} sin(PR)²+I_{L3z} cos(PR)²)+sin(γ)²I_{L3y}];

(Where PR=θ3+Ψ, Ψ=θw+ψ(const).)

AL301m=M_{L3} [(Δz sin(PR)+e3x cos(Ψ))+sin(γ)²(e3x sin(Ψ)−Δz cos(PR)−Rw)²++Δyk1² cos(γ)²−sin(2γ)Δyk1(Rw+(Δz cos(PR)−e3x sin(Ψ)))];

(Where Δyk1=Δy+k1+e3y−displacement by Y.)

AL401=AL401i+AL401m;

AL401i=[cos(γ)²(I_{L4x} sin(PL)²+I_{L4z} cos(PL)²)+sin(γ)²I_{L4y}];

(Where PR=θ4+Ψ, Ψ=θw+ψ(const).)

AL401m=M_{L4}[(e3x cos(Ψ)−Δz sin(PL))²+sin(γ)²(Rw+Δz cos(PL)+e3x sin(Ψ))²++Δyk1² cos(γ)²−sin(2γ)Δyk1(Rw+Δz cos(PL)+e3x sin(Ψ))];

ATt01=ATt01i+ATt01m;

ATt01m=M_{Tt}[sin(γ)²(R_{we6})²+sin(β)²e6²];

ATt01i=[sin(γ)²(sin(η)²I_{Ttx}+cos(η)²I_{Tty})+

sin(2η)sin(2γ)sin(β)(I_{Tty}−I_{Ttx})+cos(γ)²[sin(β)²(cos(η)²I_{Ttx}+sin(η)²I_{Tty})+cos(β)²I_{Ttz}]];

(Where R_{we6}=Rw+e6 cos(β),M_{Tt}=M_{Turntable}+Mₘₒₜₒᵣ_{_{—}}ᵣₒₜ.)

A02=AW02+AB02+AL102+AL202+AL302+AL402+ATt02;

where:

AW01=GW01=sin(2θw)cos(γ)[II_{WShZ}−II_{WShX}];

AB02=−[sin(β)cos(γ)(M_{B}e5(R_{we5c})+cos(β)(I_{Bx}−I_{Bz}))];

AL102=AL102+AL102m;

AL102i=1/2sin(2ZU)cos(γ)[I_{L1z}−I_{L1x}X];

AL102m=M_{L1}[cos(γ)(

e2² sin(2ZU)−

e1² sin(2β)−Rw(e1 sin(β)+e2 cos(ZU))−e1e2 cos(ZU2B)++k1 sin(γ)(e1 sin(β)+e2 cos(ZU))];

(Where ZU2B=2β+θ1.)

AL202=AL202i+AL202m;

AL202i=

sin(2ZZ)cos(γ)[I_{L2z}−I_{L2x}];

AL202m=M_{L2}[cos(γ)(

(e2² sin(2ZZ)−

e1² sin(2β)−Rw(e1 sin(β)+e2 cos(ZZ))−e1e2 cos(ZZ2B)−−k1 sin(γ)(e1 sin(β)+e2 cos(ZZ))];

(Where ZZ2B=2β+θ2.)

AL302=AL302i+AL302m;

AL302i=

sin(2PR)cos(γ)[I_{L3z}−I_{L3x}];

AL302m=M_{L3}[cos(γ)(

e3x² sin(2Ψ)−

Δz² sin(2PR)−Rw(Δz sin(PR)+e3x cos(Ψ))−Δze3x cos(P2R))+Δyk1 sin(γ)(Δz sin(PR)+e3x cos(Ψ))];

(Where P2R=θ3+2Ψ.)

AL402=AL402i+AL402m;

AL402i=

sin(2PL)cos(γ)[I_{L4z}−I_{L4x}];

AL402m=M_{L4}[cos(γ)(e3x² sin(2Ψ)−

Δz² sin(2PL)−Rw(Δz sin(PL)−e3x cos(Ψ))+Δze3x cos(P2L)++Δyk1 sin(γ)(e3x cos(Ψ)−Δz sin(PL))];

(Where P2L=θ4+2Ψ.)

ATt02=[sin(2η)sin(γ)cos(β)(I_{Ttx}−I_{Tty})−

sin(2β)cos(γ)(cos(η)²I_{TtX}+sin(η)²I_{Tty}−I_{Ttz})−−sin(β)cos(γ)M_{Tt[e}6(R_{we6})]];

A03=AB03+AL103+AL203+ATt03;

where:

AB03=sin(γ)[I_{By}+M_{B}e5(Rwcos(β)+e5)];

AL103=sin(γ)I_{L1y}+M_{L1}[sin(γ)(e1²+e2²−2e1e2 sin(θ2)+Rw(e1 cos(β)−e2 sin(ZU)))−k1 cos(γ)(e2 sin(ZU)−e1 cos(β))];

AL203=sin(γ)I_{L2y}+M_{L2}[sin(γ)(e1²+e2²−2e1e2 sin(θ2)+Rw(e1 cos(β)−e2 sin(ZZ)))++k1 cos(γ)(e2 sin(ZZ)−e1 cos(β))];

ATt03=[sin(γ)(sin(η)² I_{Ttx}+cos(η)²I_{Tty})+sin(2η)cos(γ)sin(β)(I_{Tty}−I_{Ttx})++sin(γ)M_{Tt}e6[(Rwcos(β)+e6)]];

A04=AW04+AB04+AL104+AL204+AL304+AL404+ATt04;

where:

AW04=2[sin(γ)III_{WShYK}]; AB04=M_{B}Rwsin(γ)R_{we5c};

AL104=M_{L1}[Rw² sin(γ)+Rwk1 cos(γ)+Rwsin(γ)(e1 cos(β)−e2 sin(ZU))];

AL204=M_{L2}[Rw² sin(γ)−Rwk1 cos(γ)+Rwsin(γ)(e1 cos(β)−e2 sin(ZZ))];

AL304=M_{L3}[sin(γ)(Rw²+Rw(Δz cos(PR)−e3x cos(Ψ)))+Rwcos(γ)Δyk1];

AL404=M_{L4}[sin(γ)(Rw²+Rw(Δz cos(PL)+e3x cos(Ψ))−Rwcos(γ)Δyk1];

ATt03=[M_{Tt} sin(γ)Rw[R_{we6}]];

A06=AL106;

AL106=sin(γ)I_{L1y}+M_{L1}[sin(γ)(e2²−e1e2 sin(θ1)−Rwe2 sin(ZU))−k1e2 cos(γ) sin(ZU)];

A07=AL207;

AL207=sin(γ)I_{L2y}+M_{L2}[sin(γ)(e2²−e1e2 sin(θ2)−Rwe2 sin(Z))+k1e2 cos(γ)sin(ZZ)];

A08=AL308;

AL308=sin(γ)I_{L3y}+M_{L3}[sin(γ)(Δz²+Δze3x sin(θ3)+RwΔz cos(PR))+Δyk1Δz cos(γ)cos(PR)];

A09=AL409;

AL409=sin(γ)I_{L4y}+M_{L4}[sin(γ)(Δz²−Δze3x sin(θ4)+Rwcos(PL))Δyk1Δz cos(γ)cos(PL)];

ATt010=I_{Ttz} cos(β)cos(γ);

AA=\dot{γ} AA2+\dot{β}·AA3+\dot{θ}w·AA4+\dot{θ}1·AA6+\dot{θ}2·AA7+\dot{θ}3·AA8+\dot{θ}4·AA9+\dot{η}·AA10;

where:

AA2=AW2A+AB2A+AL12A+AL22A+AL32A+AL42A+ATt2A;

AW2A=−2 sin(2γ)[(sin(θw)²II_{WShX}+cos(θw)²II_{WShZ})−III_{WShYK}];

AB2A=sin(2γ)[M_{B}(R_{we5c})²+I_{By}−(I_{Bx} sin(β)²+I_{Bz} cos(β)²)];

AL12A=AL12Ai+AL12Am;

AL12Ai=sin(2γ)[I_{L1y}−(I_{L1x} sin(ZU)²+I_{L1z} cos(ZU)²)];

AL12Am=M_{L1}[sin(γ)((Rw+e1 cos(β)−e2 sin(ZU))²−k1²)++2k1 cos(2γ)(Rw+e1 cos(β)−e2 sin(ZU))];

AL22A=AL22Ai+AL22Am;

AL22Ai=sin(2γ)[I_{L2y}−(I_{L2x} sin(ZZ)²+I_{L2z} cos(ZZ)²)];

AL22Am=M_{L2}[sin(γ)((Rw+e1 cos(β)−e2 sin(ZZ))²−k1²)−−2k1 cos(2γ)(Rw+e1 cos(β)−e2 sin(ZZ))];

AL32A=AL32Ai+AL32Am;

AL32Ai=sin(2γ)[I_{L3y}−(I_{L3x} sin(PR)²+I_{L3z} cos(PR)²)];

AL32Am=M_{L3} sin(2γ)((e3x sin(Ψ)−Δz cos(PR)−Rw)²−Δyk1²)++2 cos(2γ)Δyk1(Rw+(Δz cos(PR)−e3x sin(Ψ)))];

AL42A=AL42Ai+AL42Am;

AL42Ai=sin(2γ)[I_{L4y}−(I_{L4x} sin(PL)²+I_{L4z} cos(PL))];

AL42Am=M_{L4}[sin(2γ)((e3x sin(Ψ)+Δz cos(PL)+Rw)²−Δyk1²)−−2 cos(2γ)Δyk1(Rw+(Δz cos(PL)+e3x sin(Ψ)))];

ATt2A=ATt2Ai+ATt2Am;

ATt2Am=M_{Tt}[sin(2γ)(R_{we6})²];

ATt2Ai=[sin(2γ)((sin(η)²I_{Ttx}+cos(η)²I_{Tty})−[sin(β)²(cos(η)²I_{Ttx}+sin(η)²I_{Tty})+cos(β)²I_{Ttz}])++sin(2η)cos(2γ)sin(β)(I_{Tty}−I_{Ttx})];

AA3=AB3A+AL13A+AL23A+ATt3A;

where:

AB3A=2 sin(β)[cos(β)cos(γ)²(M_{B}e5²+(I_{Bx}−I_{Bz}))−M_{B}e5R_{we5c} sin(γ)²];

AL13A=AL13Ai+AL13Am;

AL13Ai=sin(2ZU)cos(γ)²[I_{L1x}−I_{L1z}];

AL13Am=M_{L1}[cos(γ)²(e1² sin(2β)+2e1e2 cos(ZU2B)−e2² sin(2ZU))−2 sin(γ)²Rw(e1 sin(β)+e2 cos(ZU−k1 sin(2γ)(e1 sin(β)+e2 cos(ZU))];

AL23A=AL23Ai+AL23Am;

AL23Ai=sin(2ZZ)cos(γ)²[I_{L2x}−I_{L2z}];

AL23Am=M_{L2}[cos(γ)²(e1² sin(2β)+2e1e2 cos(ZZ2B)−e2² sin(2ZZ))−2 sin(γ)²Rw(e1 sin(β)+e2 cos(ZZ)+k1 sin(2γ)(e1 sin(β)+e2 cos(ZZ))];

ATt3A=ATt3Ai+ATt3Am;

ATt3Ai=sin(2η)sin(2γ)cos(β)(I_{Tty}−I_{Ttx})+sin(2β)cos(γ)²(cos(η)²I_{Ttx}+sin(η)²I_{Tty}−I_{Ttz})

ATt3Am=2M_{Tt} sin(β)[cos(β)cos(γ)²e6²−e6Rwsin(γ)²];

AA4=AW4A+AL35A+AL45A;

where:

AW4A=2 sin(2θw)cos(γ)²[II_{WShx}−II_{WShZ})];

AL35A=AL35Ai+AL35Am;

AL35Ai=AL38Ai=sin(2PR)cos(γ)² μI_{L3x}−I_{L3z}];

AL35Am=M_{L3}[cos(γ)²(Δz² sin(2PR)−e3x² sin(2Ψ)+2Δze3x cos(P2R))−−2 sin(γ)²Rw(Δz sin(PR)+e3x cos(Ψ))−Δyk1 sin(2γ)(Δz sin(PR)+e3x cos(Ψ)];

AL45A=AL45Ai+AL45Am;

AL45Ai=AL49Ai=sin(2PL)cos(γ)²[I_{L4x}−I_{L4z}];

AL45Am=M_{L4}[cos(γ)²(Δz² sin(2PL)−e3x² sin(2Ψ)−2Δze3x cos(P2L))−−2Rwsin(γ)²(Δz sin(PL)−e3x cos(Ψ))−Δyk1 sin(2γ)(e3x cos(Ψ)−Δz sin(PL))];

AA6=AL16A;

where: AL16A=AL16Ai+AL16Am;

AL16Ai=sin(2ZU)cos(γ)²[I_{L1x}−I_{L1z}];

AL16Am=−M_{L1}[e2² sin(2ZU)cos(γ)²+e2 cos(ZU)(2 sin(γ)²(e1 cos(β)+Rw)+k1 sin(2γ))++2e1e2 sin(β)cos(ZU)];

AA7=AL27A;

AL27A=AL27Ai+AL27Am;

AL27Ai=sin(2ZZ)cos(γ)[I_{L2x}−I_{L2z}];

AL27Am=−M_{L1}[e2² sin(2ZZ)cos(γ)²+e2 cos(ZZ)(2 sin(γ)²(e1 cos(β)+Rw)−k1 sin(2γ))++2e1e2 sin(β)cos(ZZ)];

AA8=AL38A;

AL38A=AL38Ai+AL38Am;

AL38Ai=(see AL35Ai);

AL38Am=M_{L3}[cos(γ)²Δz² sin(2PR)+2Δze3x cos(Ψ)cos(PR)++2 sin(γ)²(Δze3x sin(Ψ)sin(PR)−RwΔz sin(PR))−Δyk1 sin(2γ)Δz sin(PR)];

AA9=AL49A;

AL49A=AL49Ai+AL49Am;

AL49Ai=(see AL45Ai);

AL49Am=M_{L3}[cos(γ)²Δz² sin(2PL)−2Δze3x cos(Ψ)cos(PL)−−2 sin(γ)²(Δze3x sin(Ψ)sin(PL)+RwΔz sin(PL))+Δyk1 sin(2γ)Δz sin(PL)];

AA10=ATt10A;

ATt10A=sin(2η)sin(γ)²(I_{Ttx}−I_{Tty})+cos(2η)sin(2γ)sin(β)(I_{Tty}−I_{Ttx})++cos(γ)² sin(β)² sin(2η)(I_{Tty}−I_{Ttx})

AG=\dot{γ}·AG1+\dot{β}·AG2+\dot{θ}w·AG3+\dot{θ}1·AG5+\dot{θ}2·AG6+\dot{θ}3·AG7+\dot{θ}4·AG8+\dot{η}·AG9;

where:

AG1=AW1G+AB1G+AL11G+AL21G+AL31G+AL41G+ATt1G;

AW1G=sin(2θw)sin(γ)[II_{WShX}−II_{WShZ}];

AB1G=[sin(β)sin(γ)(M_{B}e5(R_{we5c})+cos(β)(I_{Bx}−I_{Bz}))];

AL11G=AL11Gi+AL11Gm;

AL11Gi=sin(2ZU)sin(γ)[I_{L1x}−I_{L1z}];

AL11Gm=M_{L1}[−sin(γ)(e2² sin(2ZU)−e1² sin(2β)−Rw(e1 sin(β)+e2 cos(ZU))−e1e2 cos(ZU2B)++k1 cos(γ)(e1 sin(β)+e2 cos(ZU))];

AL21G=AL21Gi+AL202m;

AL21Gi=sin(2ZZ)sin(γ)[I_{L2x}−I_{L2z}];

AL21Gm=M_{L2}[sin(γ)(e1² sin(2β)−e2² sin(2ZZ)+Rw(e1 sin(β)+e2 cos(ZZ))+e1e2 cos(ZZ2B))−−k1 cos(γ)(e1 sin(β)+e2 cos(ZZ))];

AL31G=AL31Gi+AL31Gm;

AL31Gi=sin(2PR)sin(γ)[I_{L3x}−I_{L3z}];

AL31Gm=M_{L3}[−sin(γ)(e3x² sin(2Ψ)−Δz² sin(2PR)−Rw(Δz sin(PR)+e3x cos(Ψ))−Δze3x cos(P2R)+Δyk1 cos(γ)(Δz sin(PR)+e3x cos(Ψ))];

AL41G=AL41Gi+AL41Gm;

AL402i=sin(2PL)sin(γ)[I_{L4x}−I_{L4z}];

AL41Gm=M_{L4}[−sin(γ)(e3x² sin(1Ψ)−Δz² sin(2PL)−Rw(Δz sin(PL)−e3x cos(Ψ)+Δze3x cos(P2L)++Δyk1 cos(γ)(e3x cos(Ψ)−Δz sin(PL))];

ATt1G=[sin(2η)cos(γ)cos(β)(I_{Ttx}−I_{Tty})+sin(2β)sin(γ)(cos(η)²I_{Ttx}+sin(η)²I_{Tty}−I_{Ttz})++sin(β)sin(γ)M_{Tt}[e6(R_{we6})]];

AG2=AB2G+AL12G+AL22G+ATt2G;

AB2G=cos(γ)[2M_{B}(e5² sin(β)²)+(I_{Bz}−I_{Bx})cos(2β)+I_{By}];

AL12G=AL12Gi+AL12Gm;

AL12Gi=cos(γ)[I_{L1y}−(I_{L1x}−I_{L1z})cos(2ZU)];

AL12Gm=2M_{L1} cos(γ)(e1 sin(γ)+e2 cos(ZU))²;

AL22G=AL22Gi+AL22Gm;

AL22Gi=cos(γ)[I_{L2y}−(I_{L2x}−I_{L2z})cos(2ZZ)];

AL22Gm=2M_{L2} cos(γ)(e1 sin(β)+e2 cos(ZZ))²;

ATt2G=cos(γ)[(sin(η)²I_{Ttx}+cos(η)²I_{Tty})−cos(2β)[(cos(η)²I_{Ttx}+sin(η)²I_{Tty})−I_{Ttz}]++2M_{Tt}[e6² sin(β)²]];

AG3=AW3G+AB3G+AL13G+AL23G+AL33G+AL34G+AL43G+AL44G+ATt3G

where:

AW3G=2 cos(γ)[cos(2θw)(II_{WShZ}−II_{WShX})+III_{WShYK];}

AB3G=M_{B}Rwcos(γ)(R_{we5c});

AL13G=M_{L1}[cos(γ)(Rw²+Rw(e1 cos(β)−e2 sin(ZU)))−Rwk1 sin(γ)];

AL23G=M_{L2}[cos(γ)(Rw²+Rw(e1 cos(β)−e2 sin(ZZ)))+Rwk1 sin(γ)];

AL33G=M_{L3}[cos(γ)(Rw²+Rw(Δz cos(PR)−e3x sin(Ψ)))−Rw sin(γ)Δyk1];

AL34G=AL34Gi+AL34Gm;

AL34Gi=AL37Gi=cos(γ)[I_{L3y}−cos(2PR)(I_{L3x}−I_{L3z})];

AL34Gm=M_{L3} cos(γ)(e3x cos(Ψ)+Δz sin(PR))²

AL43G=M_{L4}[cos(γ)(Rw²+Rw(Δz cos(PL)+e3x sin(Ψ)))+Rwsin(γ)Δyk1];

AL44G=AL44Gi+AL44Gm;

AL44Gi=AL48Gi=cos(γ)[I_{L4y}−cos(2PL)(I_{L4x}−I_{L4z})];

AL44Gm=M_{L4} cos(γ)(e3x cos(Ψ)−Δz sin(PL))²;

ATt3G=[M_{Tt} cos(γ)Rw[R_{we6}]];

AG5=AL15G;

AL15G=2M_{L1} cos(γ)(e1e2 cos(ZU)sin(β)+e2² cos(ZU)²)+cos(γ)[[I_{L1z}−I_{L1x}]cos(2ZU)+I_{L1y}]

AG6=AL26G;

AL26G=2M_{L2} cos(γ)(e1e2 cos(ZZ)sin(β)+e2² cos(ZZ)²)+cos(γ)[[I_{L2z}−I_{L2x}]cos(2ZZ)+I_{L2y}];

AG7=AL37G;

AL37G=AL34Gi+2M_{L3} cos(γ)[Δz² sin(PR)²−Δze3x cos(Ψ)sin(PR)];

AG8=AL48G;

AL48G=AL4Gi+2M_{L4} cos(γ)[Δz² sin(PL)²−Δze3x cos(Ψ)sin(PL)];

AG9=ATt9G;

ATt9G=sin(γ)cos(β)(cos(2η)(I_{Ttx}−I_{Tty})−I_{Ttz})+sin(2β)cos(γ)sin(2η)(I_{Ttx}−I_{Tty});

AB=\dot{β}·AB1+\dot{θ}w·AB2+\dot{θ}1·AB4+\dot{θ}2·AB5+\dot{η}AB8;

where:

AB1=AB1B+AL11B+AL21B+ATt1B;

AB1B=−sin(γ)M_{B}e5Rwsin(β);

AL11B=M_{L1}(e1 sin(β)+e2 cos(ZU))[−Rwsin(γ)−k1 cos(γ)];

AL21B=M_{L2}(e1 sin(β)+e2 cos(ZZ))[−Rwsin(γ)+k1 cos(γ)];

ATt1B=sin(2η)cos(γ)cos(β)(I_{Tty}−I_{Ttx})−M_{Tt}e6 sin(γ)Rwsin(β);

AB2=AB2B+AL12B+AL22B+ATt2B;

AB2B=−sin(γ)M_{B}e5Rwsin(β); ATt2B=−M_{Tt}e6 sin(γ)Rwsin(β);

AL12B=−M_{L1} sin(γ)Rw(e1 sin(β)+e2 cos(ZU)); AL22B=−M_{L2} sin(γ)Rw(e1 sin(β)+e2 cos(ZZ))

AB4=AL14B;

AL14B=−2e2M_{L1}[e1 sin(γ)cos(θ1)−cos(ZU)(k1 cos(γ)+Rwsin(γ))];

AB5=AL25B;

AL25B=2e2M_{L2}[cos(ZZ)(k1 cos(γ)−Rwsin(γ))−e1 sin(γ)cos(θ2)];

AB8=ATt8B;

ATt8B=sin(γ)sin(2η)(I_{Ttx}−I_{Tty})+cos(γ)sin(β)(cos(2η)(I_{Tty}−I_{Ttx})−I_{Ttz});

ATw=\dot{θ}w·ATw2+\dot{θ}1·ATw3+\dot{θ}2·ATw4+\dot{θ}3·ATw5+\dot{θ}4·ATw6;

where:

ATw2=AL32Tw+AL31S+AL42Tw+AL41S;

AL32Tw=−M_{L3} sin(γ)Rw(Δz sin(PR)+e3x cos(Ψ);

AL42Tw=M_{L4} sin(γ)Rw(−Δz sin(PL)+e3x cos(Ψ));

AL31S=−M_{L3} (Δz sin(PR)+e3x cos(Ψ))[cos(γ)Δyk1+sin(γ)Rw]

AL41S=M_{L4}(e3x cos(Ψ)−Δz sin(PL))[sin(γ)Rw−cos(γ)Δyk1]

ATw3=AL13Tw;

AL13Tw=−M_{L1} sin(γ)Rwe2 cos(ZU);

ATw4=AL24Tw;

AL24Tw=−M_{L2} sin(γ)Rwe2 cos(Z);

ATw5=AL35Tw+AL34S;

AL35Tw=−M_{L3} sin(γ)RwΔz sin(PR);

AL34S=2ΔzM_{L3}(sin(γ)(e3x cos(θ3)−Rwsin(PR))−cos(γ)Δyk1 sin(PR));

ATw6=AL46Tw+AL45S;

AL46Tw=−M_{L3} sin(γ)RwΔz sin(PL);

AL45S=2ΔzM_{L4}(cos(γ)Δyk1 sin(PR)−sin(γ)(e3x cos(θ4)+Rwsin(PL)));

AT1=\dot{θ}1·AL11T1;

where: AL11T1=−e2M_{L1}(cos(ZU)[Rwsin(γ)+k1 cos(γ)]+e1 sin(γ)cos(θ1));

AT2=\dot{θ}2·AL21T2;

where: AL11T1=e2M_{L1}(cos(ZU)[k1 cos(γ)−Rwsin(γ)]−e1 sin(γ)cos(θ2));

AT3=\dot{θ}3·AL31T3;

where: AL34S=ΔzM_{L3}(sin(γ)(e3x cos(θ3)−Rwsin(PR))−cos(γ)Δyk1 sin(PR));

AT4=\dot{θ}4·AL41T4;

where: AL41T4=ΔzM_{L4}(cos(γ)Δyk1 sin(PR)−sin(γ)(e3x cos(θ4)+Rwsin(PL)));

AD=Dw_{cor}\dot{α};

Dw_{cor}—coefficient of viscous friction between flow and wheel's cord.

The general equation of motion for gamma in the unicycle equation of motion is:

$$\begin{matrix}\ddot{γ} \cdot G 0 \; 2 + \ddot{α} \cdot G 01 + \ddot{β} \cdot G 0 \; 3 + \ddot{θ} w \cdot ( G 0 \; 4 + G 0 \; 5 ) + \ddot{θ} 1 \cdot G 0 \; 6 + \ddot{θ} 2 \cdot G 0 \; 7 + \ddot{θ} 3 \cdot G 0 \; 8 + \ddot{θ} 4 \cdot G 0 \; 9 + \\ + \ddot{η} \cdot G 10 + \dot{γ} \cdot GG + \dot{α} \cdot GA + \dot{β} \cdot G B + \dot{θ} w \cdot ( GTw + Gs ) + \dot{θ} 1 \cdot GT 1 + \dot{θ} 2 \cdot GT 2 + \dot{θ} 3 \cdot GT 3 + \\ + \dot{θ} 4 \cdot GT 4 + BV = 0\end{matrix}$$

The coefficients of the gamma equation of motion are given by:

G01=GW01+GB01+GL101+GL201+GL301+GL401+GTt01;

where:

GW01=AW01; GB01=AB02; GL101=AL102; GL301=AL302; GL401=AL402; GTt01=ATt02;

G02=GW02+GB02+GL102+GL202+GL302+GL402+GTt02;

where:

GW02=2(cos(θw)²II_{WShX}+II_{WShZ} sin(θw)²);

GB02=M_{B}(R_{we5c})²+(cos(β)²I_{Bx}+sin(β)²I_{Bz});

GL102=M_{L1}((Rw+e1 cos(β)−e2 sin(ZU))²+k1²)+(cos(ZU)²I_{L1x}+sin(ZU)²I_{L1z});

GL202=M_{L2}((Rw+e1 cos(β)+e2 sin(ZZ))²−k1²)+(I_{L2x} cos(ZZ)²+I_{L2z} sin(ZZ)²);

GL302=M_{L3}((e3x sin(Ψ)−Δz cos(PR)−Rw)²+Δyk1²)+(cos(PR)²I_{L3x}+sin(PR)²I_{L3z});

GL402=M_{L4}((e3x sin(Ψ)+Δz cos(PL)+Rw)²+Δyk1²)+(cos(PL)²I_{L4x}+sin(PL)²I_{L4z});

GTt02=cos(β)²(cos(η)²I_{Ttx}+sin(η)²I_{Tty})+sin(η)²I_{Ttz}+M_{Tt}[sin(2γ)(R_{we6})²];

G03=GL103+GL203+GTt03;

where:

GL103=M_{L1}k1(e1 sin(β)+e2 cos(ZU)); GL203=M_{L2}k1(e1 sin(β)+e2 cos(ZZ));

GTt03=sin(2η)cos(β)(I_{Tty}−I_{Ttx});

G04(G05)=GL305+GL405;

where:

GL305(GL304)=M_{L3}Δyk1(Δz sin(PR)+e3x cos(Ψ);

GL405(GL404)=M_{L4}Δyk1(e3x cos(Ψ)−Δz sin(PL));

G06=GL106; G07=GL207; G08=GL308; G09=GL409; G110=GTt010;

where:

GL106=M_{L1}k1e2 cos(ZU); GL207=M_{L2}k1e2 cos(ZZ); GL308=M_{L3}Δyk1Δz sin(PR);

GL409=−M_{L4}Δyk1Δz sin(PL); GTt010=sin(β)I_{Ttz};

GA=\dot{α}·GA1+\dot{β}·GA3+\dot{θ}w·GA4+\dot{θ}1·GA6+\dot{θ}2·GA7+\dot{θ}3·GA8+\dot{θ}4·GA9+\dot{η}·GA10;

where:

GA1=GW1A+GB1A+GL11A+GL21A+GL31A+GL41A+GTt1A=AA2;

GA3=GB3A+GL13A+GL23A+GTt3A;

where:

GB3A=−cos(γ)[2 cos(β)(M_{B}e5(R_{we5c})+cos(2β)(I_{Bx}−I_{Bz})+I_{By})];

GL13A=cos(γ)[cos(ZU)[I_{L1z}−I_{L1x}]−I_{L1y}]+2M_{L1}[k1 sin(γ)(e1 cos(β)−e2 sin(ZU))++cos(γ)(Rw(e2 sin(ZU)−e1 cos(β))−(e2 sin(ZU)−e1 cos(β))²)];

GL23A=cos(γ)cos(2ZZ)[I_{L2z}−I_{L2x}]−I_{L2y}]+2M_{L2}[k1 sin(γ)(e2 sin(ZZ)−e1 cos(β))++cos(γ)(Rw(e2 sin(ZZ)−e1 cos(β))−(e2 sin(ZZ)−e1 cos(β))²)];

GTt3A=−[2 cos(β)cos(γ)M_{Tt}[e6(R_{we6})]−sin(2η)sin(γ)sin(β)(I_{Tty}−I_{Ttx})++cos(γ)[sin(η)²I_{Ttx}+I_{Tty} cos(η)²+cos(η)(cos(η)²I_{Ttx}+sin(η)²I_{Tty}−I_{Ttz})]];

GA4=GW4A+GB4A+GL14A+GL24A+GL34A+GL44A+(GL35A+GL45A)+GTt4A;

where:

GW4A=2 cos(γ)[cos(2θw)(II_{WShZ}−II_{WShX})−III_{WShYK}]; GB4A=−M_{B}Rwcos(γ)(R_{we5c});

GL14A=−M_{L1}[cos(γ)(Rw+Rw(e1 cos(β)−e2 sin(ZU)))−Rwk1 sin(γ)];

GL24A=−M_{L2}[cos(γ)(Rw+Rw(e1 cos(β)−e2 sin(ZZ)))+Rwk1 sin(γ);

GL34A=−M_{L3}[cos(γ)(Rw+Rw(Δz cos(PR)−e3x sin(Ψ))−Rwsin(γ)Δyk1];

GL44A=−M_{L4}[cos(γ)(Rw²+Rw(Δz cos(PL)+e3x sin(Ψ)))+Rwsin(γ)Δyk1];

GL35A=GL35Ai+GL35Am;

GL35Ai=GL38Ai=cos(γ)[cos(2PR)(I_{L3z}−I_{L3x})−I_{L3y}];

GL35Am=2M_{L3}[cos(γ)(Rw[e3x sin(Ψ)−Δz cos(PR)]−[e3x sin(Ψ)−Δz cos(PR)]²)+sin(γ)Δyk1[Δz cos(PR)−e3x sin(Ψ)]];

GL45A=GL45Ai+GL45Am;

GL45Ai=GL49Ai=cos(γ)[cos(2PL)(I_{L4z}−I_{L4x})−I_{L4y}];

GL45Am=−2M_{L4}[cos(γ)(Rw[e3x sin(Ψ)+Δz cos(PL)]+[e3x sin(Ψ)+Δz cos(PL)]²)+sin(γ)Δyk1[Δz cos(PL)+e3x sin(Ψ)]];

GTt4A=−[M_{Tt} cos(γ)Rw[R_{we6}]];

GA6=GL16A; GA7=GL27A; GA8=GL38A; GA9=GL49A; GA10=GTt10A;

where:

GL16A=cos(γ)[cos(ZU)[I_{L1z}−I_{L1x}]−I_{L1y}]+²M_{L1}[−k1 sin(γ)e2 sin(ZU)++cos(γ)(e2Rwsin(ZU)−e2² sin(ZU)²+e2 sin(ZU)e1 cos(β))];

GL27A=cos(γ)[cos(2ZZ)[I_{L2z}−I_{L2x}]−I_{L2y}]+2M_{L2}[k1 sin(γ)e2 sin(ZZ)++cos(γ)(Rwe2 sin(ZZ)−e2² sin(ZZ)²+e2 sin(ZZ)e1 cos(β))];

GL38Am=GL35Ai+2M_{L3}[cos(γ)(e3x sin(Ψ)Δz cos(PR)−RwΔz cos(PR)−Δz² cos(PR)²)+sin(γ)Δyk1Δz cos(PR)];

GL49Am=GL45Ai−2M_{L4}[cos(γ)(RwΔz cos(PL)+e3x sin(Ψ)Δz cos(PL)+Δz² cos(PL)²)+sin(γ)Δyk1Δz cos(PL)];

GTt10A=sin(γ)cos(β)[cos(2η)(I_{Ttx}−I_{Tty})+I_{Ttz}]+sin(2β)cos(γ)sin(2η)(I_{Ttx}−I_{Tty})

GG=\dot{β}·GG2+\dot{θ}w·GG3+\dot{θ}1·GG5+\dot{θ}2·GG6+\dot{θ}3·GG7+\dot{θ}4·GG8+\dot{η}·GG9;

where:

GG2=GB2G+GL12G+GL22G+GTt2G;

GB2G=−2[sin(β)(M_{B}e5(R_{we5c})+cos(β)(I_{Bx}−I_{Bz}))];

GL12G=M_{L1}(e2² sin(2ZU)−e1² sin(2β)−2Rw(e1 sin(β)+e2 cos(ZU))−2e1e2 cos(ZU2B))−−sin(2ZU)[I_{L1x}−I_{L1z}];

GL22G=−M_{L2}(e1² sin(2β)−e2² sin(2ZZ)+2Rw(e1 sin(β)+e2 cos(ZZ))+2e1e2 cos(ZZ2B))−−sin(2ZZ)[I_{L2x}−I_{L2z}];

GTt2G=−sin(2β)(cos(η)²I_{Ttx}+sin(η)²I_{Tty}−I_{Ttz})−M_{Tt} sin(β)[e6(R_{we6})];

GG3=GW3G+GL34G+GL44G;

GW3G=−sin(2θw)[II_{WShX}−II_{WShZ}];

GL34G=2M_{L3}(e3x² sin(2Ψ)−Δz² sin(2PR)−Rw(Δz sin(PR)+e3x cos(Ψ))−Δze3x cos(P2R)−−sin(2PR)[I_{L3x}−I_{L3z}];

GL44G=2M_{L4}(e3x² sin(2Ψ)−Δz² sin(2PL)−Rw(Δz sin(PL)−e3x cos))+Δze3x cos(P2L)−sin(2PL)[I_{L4x}−I_{L4z}];

GG5=GL15G; GG6=GL26G; GG7=GL37G; GG8=GL48G; GG9=GTt9G;

GL15G=M_{L1}(e2² sin(2ZU)−2e1e2 cos(ZU)cos(β)−2e2Rwcos(ZU))−−sin(2ZU)[I_{L1x}−I_{L1z}];

GL26G=M_{L2}(e2² sin(2ZZ)−2e1e2 cos(ZZ)cos(β)−2e2Rwcos(ZZ))−−sin(2ZZ)[I_{L2x}−I_{L2z}];

GL37G=2M_{L3}Δze3x sin(PR)sin(Ψ)−Δz² sin(2PR)−RwΔz sin(PR)−−sin(2PR)[I_{L3x}−I_{L3z}];

GL44G=−2M_{L4}(Δz² sin(2PL)+Δze3x sin(PL)sin(Ψ)−RwΔz sin(PL))−−sin(2PL)[I_{L4x}−I_{L4z}];

GTt2G=cos(β)² sin(2η)(I_{Tty}−I_{Ttx});

GB=\dot{β}·GB1+\dot{θ}1·GB4+\dot{θ}2·GB5+\dot{η}·GB8;

where:

GB1=GL11B+GL21B+GTt1B;

GL11B=M_{L1}k1(e1 cos(β)−e2 sin(ZU)); GL21B=M_{L2}k1(e2 sin(ZZ)−e1 cos(β));

GTt03=sin(2η)sin(β)(I_{Tty}−I_{Ttx});

GB4=GL14B; GB5=GL25B; GB8=GTt8B;

GL14B=−M_{L1}k1e2 sin(ZU); GL25B=M_{L2}k1e2 sin(ZZ);

GTt8G=−cos(β)(I_{Ttx}−I_{Tty}]cos(η)−I_{Ttz});

GTw+GS=\dot{θ}w·(GL31S+GL41S)+\dot{θ}3·GL34S+\dot{θ}4·GL35S;

where:

GL31S=M_{L3}Δyk1[Δz cos(PR)−e3x sin(Ψ)]; GL34S=2M_{L3}Δyk1Δz cos(PR);

GL41S=−M_{L4}Δyk1[Δz cos(PL)+e3x sin(Ψ)]; GL41S=−2M_{L4}Δyk1Δz cos(PL);

GT1=\dot{θ}1·GL11T1; GT2=\dot{θ}2·GL21T2; GT3=\dot{θ}3·GL31T3; GT4=\dot{θ}4·GL41T4;

where:

GL11T1=−M_{L1}k1e2 sin(ZU); GL21T2=M_{L2}k1e2 sin(ZZ); GL31T3=M_{L3}Δyk1Δz cos(PR);

GL41T4=−M_{L4}Δyk1Δz cos(PL);

GV=GWV+GBV+GL1V+GL2V+GL3V+GL4V+GTtV;

where:

GWV=−M_{w}gRwsin(γ); GBV=−M_{B}ge5 sin(γ)(Rw+e5 cos(β));

GL1V=M_{L1}g (sin(γ)(e2 sin(ZU)−e1 cos(β)−Rw)−k1 cos(γ));

GL2V=−M_{L2}g(sin(γ)(e2 sin(ZZ)−e1 cos(β)−Rw)−k1 cos(γ));

GL3V=−M_{L3}g(sin(γ)(Δz sin(PR)−e3x sin(Ψ)+Rw)−Δyk1 cos(γ));

GL4V=M_{L4}g(Δyk1 cos(γ)−sin(γ)(Δz cos(PL)+e3x sin(Ψ)+Rw))

GTtV=−M_{Tt}g sin(γ)R_{we6};

The general beta equation of motion are given by:

\ddot{β}·B03+\ddot{α}·B01+\ddot{γ}·B02+\ddot{θ}w·B04+\ddot{θ}1·B06+\ddot{θ}2·B07+\dot{β}·BB+\dot{α}·BA++\dot{γ}·BG+\dot{θ}1·BT1+\dot{θ}2·BT2+BV+BD=C₁(λ₁)

The coefficients of the beta equation of motion are given by:

B01=BB01+BL101+BL201+BTt01;

where:

BB01=AB03; BL101=AL103; BL201=AL203; BTt01=ATt03; B02=BL102+BL202+BTt02;

BL102=M_{L1}k1 sin(2γ)(e1 sin(β)+e2 cos(ZU));

BL202=−M_{L2}k1 sin(2γ)(e1 sin(β)+e2 cos(ZZ);

BTt02=sin(2η)cos(β)(I_{Ttx}−I_{Tty});

B03=BB03+BL103+BL203+BTt03;

BB03=I_{By}+M_{B}e5²; BL103=I_{L1y}+M_{L1}(e1²+e2²−2e1e2 sin(θ1));

BL203=I_{L2y}+M_{L2}(e1²+e2²−2e1e2 sin(θ2)); ATt03=M_{Tt}e6²+(sin(η)²I_{Ttx}+cos(η)²I_{Tty});

B04=BB04+BL104+BL204+BTt04;

BB03=M_{B}e5Rwcos(β); BL104=M_{Tt}Rw(e1 cos(β)−e2 sin(ZU));

BL204=M_{L2}Rw(e1 cos(β)−e2 sin(ZZ)); BTt04=M_{Tt}e6Rwcos(β);

B06=BL106; B07=BL207;

BL106=I_{L1y}+M_{L1}(e2²−e1e2 sin(θ1)); BL207=I_{L2y}+M_{L2}(e2²−e1e2 sin(θ2));

BA=\dot{α}·BA1+\dot{γ}·BA2+\dot{θ}w·BA4+\dot{θ}1·BA6+\dot{θ}2·BA7+\dot{η}·BA10;

where:

BA1=BB1A+BL11A+BL21A+BTt1A;

BB1A=−AB3A; BL11A=−AL13A; BL21A=−AL23A; BTt1A=−ATt3A;

BA2=BB2A+BL12A+BL22A+BTt2A;

BB2A=cos(γ)[2M_{B}e5 cos(β)(R_{we5c})+I_{By}+cos(2β)(I_{Bx}−I_{Bz})];

BL12A=cos(γ)[I_{L1y}+cos(2ZU)(I_{L1x}−I_{L1z})]+2M_{L1}[sin(γ)k1(e2 sin(ZU)−e1 cos(β))++cos(γ)((e1 cos(β)−e2 sin(ZU))²+Rw(e1 cos(β)−e2 sin(ZU)))];

BL22A=cos(γ)[I_{L1y}+cos(2ZZ)(I_{L1x}−I_{L1z})]+2M_{L1}[sin(γ)k1(e1 cos(β)−e2 sin(ZZ))++cos(γ)((e1 cos(β)−e2 sin(ZZ))²+Rw(e1 cos(β)−e2 sin(ZZ)))];

BTt2A=[cos(γ)[2 cos(β)² (cos(η)²I_{Ttx}+sin(η)²I_{Tty})+cos(2η)(I_{Tty}−I_{Ttx})−cos(2β)I_{Ttz}]−−sin(2η)sin(γ)sin(β)(I_{Tty}−I_{Ttx})]+2M_{Tt} cos(β)cos(γ)e6R_{we6};

BA4=BB4A+BL14A+BL24A+BTt4A;

BB4A=sin(γ)M_{B}e5Rwsin(β); BL14A=M_{L1}Rwsin(γ)(e1 sin(β)+e2 cos(ZU));

BL24A=M_{L2}Rwsin(γ)(e1 sin(β)+e2 cos(ZZ)); BTt4A=M_{Tt}e6 sin(γ)Rwsin(β);

BA6=BL16A; BA7=BL27A;

BL16A=−2M_{L1}e1e2 cos(θ1)sin(γ); BL27A=−2M_{L2}e1e2 cos(θ2)sin(γ);

BA10=BTt10A;

BTt10A=sin(γ)sin(2η)(I_{Ttx}−I_{Tty})+cos(γ)sin(β) (cos(2η)(I_{Tty}−I_{Ttx})+I_{Ttz});

BG=\dot{γ}·BG1+\dot{η}·BG9;

where:

BG1=BB1G+BL11G+BL21G+BTt1G;

BB1G=[sin(β)(M_{B}e5(R_{we5c})+cos(β)(I_{Bx}−I_{Bz}))];

BL11G=−M_{L1}(e2² sin(2ZU)−e1² sin(2β)−Rw(e1 sin(β)+e2 cos(ZU))−e1e2 cos(ZU2B)++sin(2ZU)[I_{L1x}−I_{L1z}];

BL21G=−M_{L2}(e2² sin(2ZZ)−e1² sin(2β)−Rw(e1 sin(β)+e2 cos(ZZ))−e1e2 cos(ZZ2B)++sin(2ZZ)[I_{L2x}−I_{L2z}];

ATt02=sin(2β)cos(γ)(cos(η)²I_{Ttx}+sin(η)²I_{Tty}−I_{Ttz})+sin(β)M_{Tt}[e6(R_{we6})];

BG9=BTt9G;

BTt9G=cos(β)(cos(2η)(I_{Ttx}−I_{Tty})−I_{Ttz});

BB=\dot{θ}1·BB4+\dot{θ}2·BB5+\dot{η}·BB8;

where:

BB4=BL14B; BB5=BL25B; BB8=BTt8B;

BL14B=−2M_{L1}e1e2 cos(θ1); BL25B=−2M_{L2}e1e2 cos(θ2); BTt8B sin(2η)(I_{Ttx}−I_{Tty});

BT1=\dot{θ}1·BL11T1; BT2=\dot{θ}2·BL21T2;

where:

BL11T1=−M_{L1}e1e2 cos(θ1); BL21T2=−M_{L2}e1e2 cos(θ2);

BV=BBV+BL1V+BL2V+BTtV;

where:

BBV=−M_{B}ge5 sin(β) cos(γ); BL1V=−M_{L1}g cos(γ)(e1 sin(β)+e2 cos(ZU));

BL2V=−M_{L2}g cos(γ)(e1 sin(β)+e2 cos(ZZ)); BTtV=−M_{Tt}g sin(β)cos(γ)e6;

$$BD = \frac{ⅆ}{ⅆ \dot{β}} [ {{D}_{gir} ( \dot{β} - \dot{θ} w )}^{2} ] ;$$

Where Dgir is a friction coefficient between the body 1003 and the wheel 1001.

C₁(λᵢ)=λ₁·a_{1,3}+λ₂·a_{2,3}+λ₃·a_{3,3}+λ₄·a_{4,3};

a_{1,3}=e1 cos(β)−2e2 sin(ZU); a_{2,3}=−(e1 sin(β)+2e2 cos(ZU));

a_{3,3}=e1 cos(β)−2e2 sin(ZZ); a_{4,3}=e1 sin(β)+2e2 cos(ZZ));

The general theta_{wheel} equation of motion is given by:

$$\begin{matrix}\ddot{θ} w \cdot Tw 0 \; 4 + \ddot{α} Tw 0 \; 1 + \ddot{γ} \cdot Tw 0 \; 2 + \ddot{β} \cdot Tw 0 \; 3 + \ddot{θ} 1 \cdot Tw 0 \; 6 + \ddot{θ} 2 \cdot Tw 0 \; 7 + \ddot{θ} 3 \cdot Tw 0 \; 8 + \ddot{θ} 4 \cdot Tw 0 \; 9 + \\ \dot{α} \cdot TwA + \dot{γ} \cdot TwG + \dot{β} \cdot TwB + \dot{θ} w \cdot TwS ( TwTw ) + \dot{θ} 1 \cdot TwT 1 + \dot{θ} 2 \cdot TwT 2 + \dot{θ} 3 \cdot TwT 3 + \\ \dot{θ} 4 \cdot TwT 4 + TwV + TwD = {C}_{2} ( {λ}_{i} )\end{matrix}$$

The coefficients of the theta_{wheel} equation of motion are given by:

Tw01=TwW01+TwB01+TwL101+TwL201+TwL301+SL301+TwL401+SL401+Twt01;

where:

TwW01=AW04; TwB01=AB04; TwL101=AL104; TwL201=AL204; TwL301=AL304; TwL401=AL404;

SL301=M_{L3}[sin(γ)(Δz²+e3x²+2Δze3x sin(θ3)+Rw(Δz cos(PR)−e3x sin(Ψ)))++cos(γ)Δyk1(Δz cos(PR)−e3x sin(Ψ)]+sin(γ)I_{L3y};

SL401=M_{L4}[sin(γ)(Δz²+e3x²−2Δze3x sin(θ4)+Rw(Δz cos(PL)−e3x sin(Ψ)))−−cos(γ)Δyk1(Δz cos(PL)−e3x sin(Ψ))]+sin(γ)I_{L4y};

TwTt01=ATt03;

Tw02=SL302+SL402;

where:

SL302=M_{L3}Δyk1(Δz sin(PR)+e3x cos(Ψ));

SL402=M_{L4}Δyk1(e3x cos(Ψ)−Δz sin(PL));

Tw03=TwB03+TwL103+TwL203+TwTt03;

where:

TwB03=M_{B}e5Rwcos(β);

TwL103=M_{L1}Rw(e1 cos(β)−e2 sin(ZU));

TwL203=M_{L2}Rw(e1 cos(β)−e2 sin(ZZ);

Twt03=M_{Tt}e6Rwcos(β);

Tw04=TwW04+TwB04+TwL104+TwL204+TwL304+2TwL305+SL305+TwL404++2TwL405+SL405+TwTt04;

where:

TwW04=2III_{WShYK}; TwB04=M_{B}Rw²; TwL104=M_{L1}Rw²; TwL204=M_{L2}Rw²;

TwL304=M_{L3}Rw²; TwL44=M_{L4}Rw²; TwTt04=M_{Tt}Rw²;

SL305=I_{L3y}+M_{L3}(Δz²+2Δze3x sin(θ3)+e3x²);

SL405=I_{L4y}+M_{L4}(Δz²−2Δze3x sin(θ4)+e3x²);

Tw06=TwL106; Tw07=TwL207; Tw08=TwL308+SL308; Tw09=TwL409+SL409;

where:

TwL106=−M_{L1}e2 sin(ZU)Rw; TwL203=−M_{L2}e2 sin(ZZ)Rw;

TwL308=M_{L3}Δz cos(PR)Rw; TwL409=M_{L4}Δz cos(PL)Rw;

SL308=I_{L3y}+M_{L3}(Δz²+Δze3x sin(θ3)); SL409=I_{L4y}+M_{L4}(Δz²−Δze3x sin(θ4));

TwA=\dot{α}·TwA1+\dot{γ}·TwA2+\dot{β}·TwA3+\dot{θ}1·TwA6+\dot{θ}2·TwA7+\dot{θ}3·TwA8+\dot{θ}4·TwA9;

where:

TwA1=TwW1A+SL31A+SL41A—AA4;

TwA2=TwW2A+TwB2A+TwL12A+TwL22A+TwL32A+SL32A+TwL42A++SL42A+TwTt2A;

where:

TwW2A=2 cos(γ)[III_{WShYK}−cos(2θw)(II_{WShZ}−II_{WShX})];

TwB2A=M_{B}Rwcos(γ)(R_{we5c});

TwL12A=M_{L1}[cos(γ)(Rw²+Rw(e1 cos(−e2 sin(ZU)))−Rwk1 sir)];

TwL22A=M_{L2}[cos(γ)(Rw²+Rw(e1 cos(β)−e2 sin(Z)))+Rwk1 sin(γ)j;

TwL32A=M_{L3}[cos(γ)(Rw²+Rw(Δz cos(PR)−e3x sin(Ψ)))−Rwsin(γ)Δyk1];

TwL42A=M_{L4}[cos(γ)(Rw²+Rw(Δz cos(PL)+e3x sin(Ψ)))+Rwsin(γ)Δyk1];

SL32A=2M_{L3} cos(γ)((e3x cos(Ψ)+Δz sin(PR))+Rw(Δz cos(PR)−e3x sin(Ψ)))−−sin(γ)Δyk1(Δz cos(PR)−e3x sin(Ψ))]+cos(γ)[I_{L3y}−cos(2PR)(I_{L3z}−I_{L3x})

SL42A=2M_{L4}[cos(γ)((e3x cos(Ψ)−Δz sin(PL))²+Rw(Δz cos(PL)+e3x sin(Ψ)))++sin(γ)Δyk1(Δz cos(PL)+e3x sin(Ψ))]+cos(γ) [I_{L4y}−cos(2PL)(I_{L4z}−I_{L4x})];

TwTt2A=[M_{Tt}cos(γ)Rw[R_{we6}]];

TwA3=TwB3A+TwL13A+TwL23A+TwTt3A=AB2;

TwA6=TwL16A=AL13Tw; TwA7=TwL27A=AL24Tw;

TwA8=TwL38A(=AL35Tw)+SL38A; TwA9=TwL49A(=AL46Tw)+SL49A;

SL38A=2ΔzM_{L3} sin(γ)e3x cos(θ3); SL49A=²ΔzM_{L4} sin(γ)e3x cos(θ4);

TwG=\dot{γ}·(TwW1G +SL31G+SL41G);

where:

TwW1G+SL31G+SL41G=−GG3;

TwB=\dot{β}·TWB1+\dot{θ}1·TwB4+\dot{θ}2·TwB5;

where:

TwB1=TwB1B+TwL11B+TwL21B+TwTt1B;

TwB11B=−M_{B}e5Rwsin(β); TwTt11B=−M_{Tt}e6Rwsin(β);

TwL11B=−RwM_{L1}(e1 sin(β)+e2 cos(ZU)); TwL21B=−RwM_{L2}(e1 sin(β)+e2 cos(ZZ));

TwB4=TwL14B; TwB5=TwL25B;

TwL14B=−2RwM_{L1}e2 cos(ZU); TwL25B=−2RwM_{L2}e2 cos(ZZ);

TwS=\dot{θ}w·(TwL31S+TwL41S)+\dot{θ}3·(TwL34S+TwL44S)+\dot{θ}4·(TwL35S+TwL45S);

where:

TwL31S=−M_{L3}Rw(Δz sin(PR)+e3x cos(Ψ)); TwL41S=M_{L4}Rw(e3x cos)−Δz sin(PL));

TwL34S=−2RwM_{L3}Δz sin(PR); TwL34S=2ΔzM_{L3}e3x cos(θ3);

TwL45S=−2RwM_{L4}Δz sin(PL); TwL45S=−2ΔzM_{L4}e3x cos(θ4);

TwT1=\dot{θ}1·TwL11T1; TwT2=\dot{θ}2·TwL21T2;

TwT3=\dot{θ}3·(TwL31T3+SL31T3); TwT4=\dot{θ}4·(TwL41T4+SL41T4);

where:

TwL11T1=−RwM_{L1}e2 cos(ZU); TwL21T2=−RwM_{L2}e2 cos(ZZ);

TwL31T3=−RwM_{L3}Δz sin(PR); SL31T3=ΔzM_{L3}e3x cos(θ3);

TwL41T4=−RwM_{L4}Δz sin(PL); SLA5S=−ΔM_{L4}e3x cos(θ4);

TwV=SL3V+SL4V;

where:

SL3V=−M_{L3}g cos(γ)(Δz sin(PR)+e3x cos(Ψ)); SL4V=M_{L4}g cos(γ)(e3x cos(Ψ)−Δz sin(PL));

$$TwD = \frac{ⅆ}{ⅆ \dot{θ} w} [ {{D}_{gir} ( \dot{β} - \dot{θ} w )}^{2} ] ;$$

where: Dgir−friction coefficient between body and wheel.

C₂(λᵢ)=λ₁·a_{1,5}+λ₂·a_{2,5}+λ₃·a_{3,5}+λ₄·a_{4,5};

a_{1,5}=e3x sin(Ψ)−e4L cos(PR); a_{2,5}=e3x cos(Ψ)+e4L sin(PR);

a_{3,5}=−e3x sin(Ψ)+e4L cos(PL); a_{4,5}=e4L sin(PL)−e3x cos);

The general theta₁ equation of motion is, from holonomic constraints, given by:

\ddot{θ}1·T106+\ddot{β}·T103+\ddot{θ}w·T104+\ddot{θ}3·T108+\dot{θ}1·T1T1+\dot{β}·T1B+\dot{θ}w·T1S+\dot{θ}3·TzT3=0

The coefficients of the theta, equation of motion are given by:

T103=(e1 sin(β)+2e2 cos(ZU));

T104=−(e3x cos(Ψ)+e4L sin(PR));

T106=2e2 cos(ZU);

T108=−e4L sin(PR);

T1B=\dot{β}·(e1 cos(β)−2e2 sin(ZU))−\dot{θ}1·4e2 sin(ZU);

T1S=−\dot{Ψ}·(e4L cos(PR)−e3x sin(Ψ))−\dot{θ}3·(2e4L cos(PR));

Tz1T1=−\dot{θ}1·2e2 sin(ZU); T1T3=−\dot{θ}3·(e4L cos(PR));

The general theta₂ equation of motion is, from holonomic constraints, given by:

\ddot{θ}2·T207+\ddot{β}·T203+\ddot{θ}w·T204+\ddot{θ}4·T209+\dot{θ}2·T2T2+\dot{β}·T2B+\dot{θ}w·T2S+\dot{θ}4·T2T4=0

The coefficients of the theta₂ equation of motion are given by:

T203=(e1 sin(β)+2e2 cos(ZZ));

T204=−(e4L sin(PL)−e3x cos(Ψ))

T207=2e2 cos(ZZ);

T209=−e4L sin(PL);

T2B=\dot{β}·(e1 cos(β)−2e2 sin(ZZ))−\dot{θ}2·4e2 sin(ZZ);

T2S=−\dot{Ψ}·(e4L cos(PL)+e3x sin(Ψ))−\dot{θ}4·(2e4L cos(PL));

T2T2=−\dot{θ}2·2e2 sin(ZZ); T1T4=−\dot{θ}4·(e4L cos(PL));

The general theta₃ equation of motion is, from holonomic constraints, given by:

\ddot{θ}3·T308+\ddot{β}·T303+\ddot{θ}w·T304+\ddot{θ}1·T306+\dot{θ}3·T3T3+T3B+\dot{θ}w·T3S+\dot{θ}1·T3T1=0

The coefficients of the theta₃ equation of motion are given by:

T303=−(e1 cos(β)−2e2 sin(ZU));

T304=−(e3x sin(Ψ)−e4L sin(PR));

T306=2e2 sin(ZU);

T38=e4L cos(PR);

T3B=\dot{β}·(e1 sin(β)+2e2 cos(ZU))+\dot{θ}1·4e2 cos(ZU);

T3S=−\dot{Ψ}·(e4L sin(PR)+e3x cos(Ψ))−\dot{θ}3·(2e4L sin(PR));

T3T1=\dot{θ}1·2e2 cos(ZU); T3T3=−\dot{θ}3·(e4L sin(PR));

The general theta₄ equation of motion is, from holonomic constraints, given by:

\ddot{θ}4·T409+\ddot{β}·T403+\ddot{θ}w·T404+\ddot{θ}2·T407+\dot{θ}4·T4T4+\dot{β}·T4B+\dot{θ}w·T4S+\dot{θ}2·T4T2=0

The coefficients of the theta₄ equation of motion are given by:

T403=−(e1 cos(β)−2e2 sin(ZZ));

T404=(e4L cos(PL)+e3x sin(Ψ));

T407=2e2 sin(ZZ);

T409=e4L cos(PL); T4B=\dot{β}·(e1 sin(β)+2e2 cos(ZZ))+\dot{θ}2·4e2 cos(ZZ);

T4S=Ψ·(e3x cos(Ψ)−e4L sin(PL))−\dot{θ}4·(2e4L sin(PL));

T4T2=\dot{θ}2·2e2 cos(ZZ); T1T4=−\dot{θ}4·(e4L sin(PL));

The general eta equation of motion is given by:

\ddot{η}·N10+\ddot{α}·N01+\ddot{γ}·N02+\dot{α}·NA+\dot{γ}·NG+\dot{β}·NB+ND=τ₃;

The coefficients of the eta equation of motion are given by:

N01=NTt01; N02=NTt02; N10=NTt10;

where:

NTt01=I_{Ttz} cos(γ)cos(β); NTt01=I_{Ttz} sin(β); NTt01=I_{Ttz};

NA=\dot{α}·NA1+\dot{γ}·NA2+\dot{β}·NA3;

where:

NA1=−sin(2η)(sin(γ)²−cos(γ)² sin(β)²)−cos(2η)sin(2γ)sin(β)](I_{Ttx}−I_{Tty});

NA2=−[I_{Ttz} cos(β)sin(γ)+(cos(2η)sin(γ)cos(β)+sin(2β)cos(γ)sin(2η))(I_{Ttx}−I_{Tty})];

NA3=−[I_{Ttz} sin(β)cos(γ)+(sin(γ)sin(2η)−cos(2η)cos(γ)sin(β))(I_{Ttx}−I_{Tty})];

NG=\dot{γ}·NG1+\dot{β}·NG2;

where:

NG1=−cos(β)² sin(2η)(I_{Tty}−I_{Ttx}); NG2=cos(β)[I_{Ttz}−cos(β)[I_{Ttx}−I_{Tty})];

NB=\dot{β}·NB1; where: NB1=sin(2η)(I_{Tty}−I_{Ttx});

$$ND = \frac{ⅆ}{ⅆ \dot{η}} [ {{D}_{Ttgir} ( \dot{η} )}^{2} ] ;$$

where: D_{Ttgir}—friction coefficient of turntable's motor. τ₃—turntable's torque;

The general equations for lambda are given by:

$$\begin{matrix}{λ}_{1} = \frac{TH 3 \cdot {a}_{2 , 6} - TH 1 \cdot {a}_{2 , 8}}{{a}_{1 , 8} \cdot {a}_{2 , 6} - {a}_{2 , 8} \cdot {a}_{1 , 6}} ; {λ}_{2} = \frac{TH 1 \cdot {a}_{1 , 8} - TH 3 \cdot {a}_{1 , 6}}{{a}_{1 , 8} \cdot {a}_{2 , 6} - {a}_{2 , 8} \cdot {a}_{1 , 6}} ; \\ {λ}_{3} = \frac{TH 2 \cdot {a}_{4 , 9} - TH 4 \cdot {a}_{4 , 7}}{{a}_{4 , 9} \cdot {a}_{3 , 7} - {a}_{3 , 9} \cdot {a}_{4 , 7}} ; {λ}_{4} = \frac{TH 4 \cdot {a}_{3 , 7} - TH 2 \cdot {a}_{3 , 9}}{{a}_{4 , 9} \cdot {a}_{3 , 7} - {a}_{3 , 9} \cdot {a}_{4 , 7}} ;\end{matrix}$$

The coefficients of the lambda equations are given by:

a_{1,3}=e1 cos(β)−2e2 sin(ZU); a_{1,5}=e3x sin(Ψ)−e4L cos(PR);

a_{2,3}=−(e1 sin(β)+2e2 cos(ZU)); a_{2,5}=e3x cos(Ψ)+e4L sin(PR);

a_{3,3=e}1 cos(β)−2e2 sin(ZZ); a_{3,5}=−e3x sin(Ψ)+e4L cos(PL);

a_{4,3}=−(e1 sin(β)+2e2 cos(ZZ)); a_{4,5}=e4L sin(PL)−e3x cos(Ψ);

a_{1,6}=−2e2 sin(ZU); a_{1,8}=−e4L cos(PR);

a_{2,6}=−2e2 cos(ZU); a_{2,8}=e4L sin(PR);

a_{3,7}=−2e2 sin(ZZ); a_{3,9}=−e4L cos(PL);

a_{4,7}=−2e2 cos(ZZ); a_{4,9}=e4L sin(PL);

TH1=\ddot{α}·T101+\ddot{γ}·T102+\ddot{β}·T103+\ddot{θ}w·T104+\ddot{θ}1·T106+\dot{α}·T1A+\dot{γ}·T1G+\dot{β}·T1B+TIV+TID;

where:

T101=AL106; T102=GL106; T103=BL106; T104=TwL106; T106=I_{L1y}+M_{L1}e2²;

T1A=\dot{α}·T1A1+\dot{γ}·T1A2+\dot{β}·T1A3+\dot{θ}w·T1A4;

where:

T1A1=M_{L1}[cos(γ)²e2² sin(2ZU)+cos(ZU)e2(2 sin(γ)²[e1 cos(β)+Rw]+k1 sin(2γ))++(e1 sin(β)e2 sin(ZU))−sin(2ZU)cos(γ)²[I_{L1x}−I_{L1z}];

TA2=cos(γ)[I_{L1y}−cos(2ZU)[I_{L1z}−I_{L1x}]]+2M_{L1}[k1 sin(γ)e2 sin(ZU)++cos(γ)(e2² sin(ZU)²−e2 sin(ZU)Rw−e2 sin(ZU)e1 cos(β)];

T1A3=2M_{L1}e1 sin(γ)e2 cos(θ1); T1A4=RwM_{L1} sin(γ)e2 cos(ZU);

T1G=\dot{γ}·T1G1; T1B=\dot{β}·T1B1;

T1G1=M_{L1}(e2² sin(2ZU)−2e2 cos(ZU)(Rw+e1 cos(β))+sin(2ZU)[I_{L1x}−I_{L1z}];

T1B1=M_{L1}e1e2 cos(θ1);

T1V=−M_{L1}g cos(γ)e2 cos(ZU);

T1D=D_{L1}_{_{—}}_{B}\dot{θ}1;

D_{L1}_{_{—}}_{B}—coefficient of viscous friction in joint between link L1 and body.

TH2=\ddot{α}·T201+\ddot{γ}·T202+\ddot{β}·T203+\ddot{θ}w·T204+\ddot{θ}2·T207+\dot{α}·T2A++\dot{γ}·T2G+\dot{β}·T2B+T2V+T2D;

where:

T201=AL207; T202=GL207; T203=BL207; T204=TwL207; T207=I_{L2y}+M_{L2}e2²;

T2A=\ddot{α}·T2A1+\dot{γ}·T2A2+\dot{β}·T2A3+\dot{θ}w·T2A4;

where:

T2A1=M_{L2}[cos(γ)²e2² sin(2ZZ)+cos(ZZ)e2(2 sin(γ)²[e1 cos(β)+Rw]−k1 sin(2γ))++(e1 sin(β)e2 sin(ZZ)]−sin(2ZZ)cos(γ)²[I_{L2x}−I_{L2z}];

T2A2=cos(γ)[I_{L2y}+cos(2ZZ)[I_{L2z}−I_{L2x}]]+2M_{L1}[−k1 sin(γ)e2 sin(ZZ)++cos(γ)(e2² sin(Z2)²−e2 sin(Z2)Rw−e2 sin(Z2)e1 cos(β))];

T2A3=2M_{L2}e1 sin(γ)e2 cos(θ2); T2A4=RwM_{L2} sin(γ)e2 cos(ZZ);

T2G=\dot{γ}·T2G1; T2B=\dot{β}·T2B1;

T2G1=−M_{L2}(e2 sin(2ZZ)−2e2 cos(ZZ)(Rw+e1 cos(β)))+sin(2ZZ)[I_{L2x}−I_{L2z}];

T2B1=M_{L2}e1e2 cos(θ2);

T2V=−M_{L2}g cos(γ)e2 cos(ZZ);

T2D=D_{L2}_{_{—}}_{B}\dot{θ}2;

Where D_{L2}_{_{—}}_{B} is a coefficient of viscous friction in joint between link L2 and the body.

TH3=\ddot{α}·T301+\ddot{γ}·T302+\ddot{β}·T303+\ddot{θ}w·(T304+T305)+\ddot{θ}3·T308+\dot{α}·T3A++\dot{γ}·T3G+\dot{θ}·T3S+T3V+T3D−τ₁;

where:

T301=AL308; T302=GL308; T303=BL308; T304=TwL308; T305=SL308; T308=I_{L3y}+M_{L3}Δz²;

T3A=\dot{α}·T3A1+\dot{γ}·T3A2+\dot{β}·T3A3+\dot{θ}w·(T3A4+T3A5);

where:

TA1=−sin(2PR)cos(γ)²[I_{L3x}−I_{L3z}]−M_{L3}[cos(γ)²(Δz² sin(2PR)+Δz sin(Ψ)e3x sin(PR)−+Δz cos(θ3)e3x−sin(γ)²RwΔz sin(PR)−Δyk1 sin(2γ)Δz sin(PR)];

T3A2=cos(γ)[[I_{L3x}−I_{L3z}]cos(2PR)+I_{L3y}]−2M_{L3}[sin(γ)Δyk1Δz cos(PR)−−cos(γ)(Δz² cos(PR)²+Δz cos(PR)(Rw−sin(Ψ)e3x))];

T3A4=M_{L3}Δz sin(γ)Rwsin(PR); T3A5=−2ΔzM_{L3} sin(γ)e3x cos(θ3);

T3G=\dot{γ}·T3G1; T3S=\dot{θ}w·T3S1;

T3G1=−M_{L3}Δz sin(PR)e3x sin(Ψ)−Δz sin(2PR)−Δz sin(PR)Rw)+sin(2PR)[I_{L3x}−I_{L3z}];

T3S1=−M_{L3}Δz cos(θ3)e3x;

T3V=−M_{L3}g cos(γ)Δz sin(PR);

T3D=D_{L3}_{_{—}}_{L1}·\dot{θ}3;

D_{L3}_{_{—}}_{L1} is a coefficient of viscous friction in a joint between the links L3 and L1.

τ₁ is a torque of the right link's motor.

TH4=\ddot{α}·T401+\ddot{γ}·T402+\ddot{β}·T403+\ddot{θ}w·(T404+T405)+\ddot{θ}4·T409+\dot{α}·T4A++\dot{γ}·T4G+\dot{θ}·T4S+T4V+T4D+τ₂;

where:

T401=AL409; T402=GL409; T403=BL409; T404=TwL409; T405=SL409; T409=I_{L4y}+M_{L4}Δz²;

T4A=\dot{α}·T4A1+\dot{γ}·T4A2+\dot{β}T4A3+\dot{θ}w·(T4A4+T4A5);

where:

T4A1=−sin(2PL)cos(γ)²[I_{L4x}−I_{L4z}]−M_{L4}[cos(γ)²(Δz² sin(2PL)+Δz sin(Ψ)e3x sin(PL))−−Δz cos(θ4)e3x−sin(γ)²RwΔz sin(PL)+Δyk1 sin(2γ)Δz sin(PL)];

T4A2=cos(γ)[[I_{L3x}−I_{L3z}]cos(2PL)+I_{L3y}]+2M_{L3}[sin(γ)Δyk1Δz cos(PL)++cos(γ)(Δz² cos(PL)²+Δz cos(PL)(Rw+sin(Ψ)e3x))];

T4A4=M_{L4}Δz sin(γ)Rwsin(PL); T4A5=2ΔzM_{L4} sin(γ)e3x cos(θ4);

T4G=\dot{γ}·T4G1; T4S=\dot{θ}w·T4S1;

T4G1=M_{L4}(Δz² sin(2PL)+Δz sin(PL)e3x sin(Ψ)+Δz sin(PL)Rw)+sin(2PL)[I_{L3x}−I_{L3z}];

T4S1=M_{L4}Δz cos(θ4)e3x,

T4V=−M_{L4}g cos(γ)Δz sin(PL);

T4D=D_{L4}_{_{—}}_{L2}\dot{θ}4;

D_{L4}_{_{—}}_{L2} is a coefficient of viscous friction in a joint between the links L4 and L2.

τ₂ is a torque of the left link's motor.

The general equations for C₁ . . . C₆ are given by:

C₁=λ₁·a_{1,3}+λ₂·a_{2,3}+λ₃·a_{3,3}+λ₄·a_{4,3}; C₂=λ₁·a_{1,5}+λ₂·a_{2,5}+λ₃·a_{3,5}+λ₄·a_{4,5}; C₃=λ₁·a_{1,6}+λ₂·a_{2,6}; C₄=λ₃·a_{3,7}+λ₄·a_{4,7}; C₅=λ₁·a_{1,8}+λ₂·a_{2,8}; C₆=λ₃·a_{3,9}+λ₄·a₄·a_{4,9};

The general equations of controlled torques is given by:

τ₁=−τ₂=−k₁β−K₂\dot{β}; τ₃=K₃γ+K₄\dot{γ};

Where K₁, K₂, K₃, and K₄ are the fuzzy gain coefficients of a PD controller obtained by soft computing techniques (e.g., a fuzzy controller).

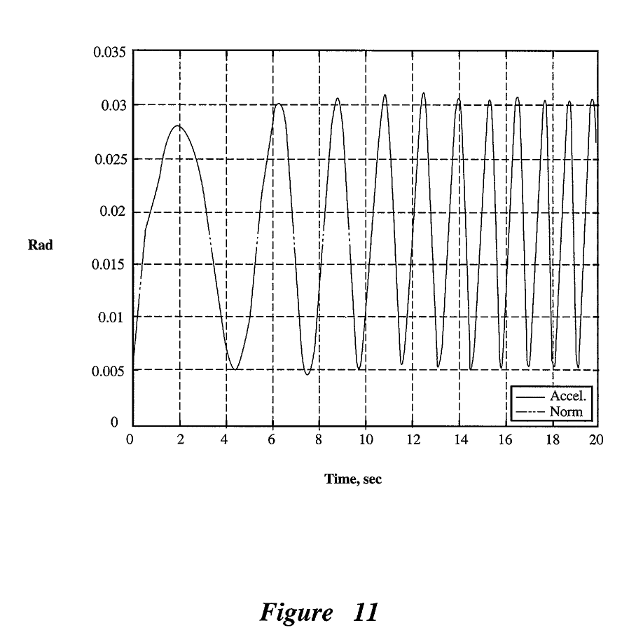

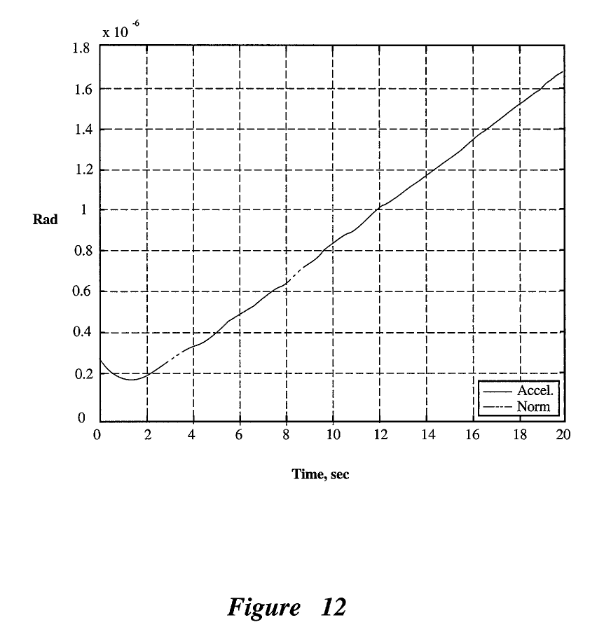

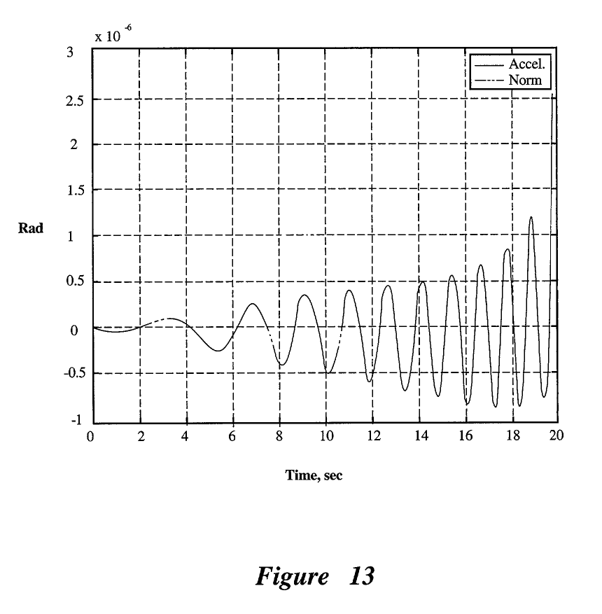

FIG. 11 is a representative plot showing comparison of the alpha angle for a simulation based on the above unicycle equations of motion for simulations with and without algebraic loops. FIG. 12 is a representative plot showing comparison of the beta angle for a simulation based on the above unicycle equations of motion for simulations with and without algebraic loops. FIG. 13 is a representative plot showing comparison of the gamma angle for a simulation based on the above unicycle equations of motion for simulations with and without algebraic loops. In FIGS. 11-13, the simulation results computed with and without algebraic loops lie roughly on top of one another. Thus, as revealed by FIGS. 11-13, the simulations with and without algebraic loops produce basically the same results, the benefits of removing the algebraic loops being a significant speed improvement. Depending on the equations being simulated the improvement can be up to a factor of 200 or more.

The forming filter structure for the generation of the nonlinear stochastic processes with selectecd stochastic characteristics is described in U.S. patent application Ser. No. 10/033,370, titleled INTELLIGENT MECHATRONIC CONTROL SYUSPEHNSION SYSTEM BASED ON SOFT COMPUTING, which is hereby incorporated by reference in its entirety.

In one embodiment, the systems shown in FIGS. 3A, 3B, 4, 6, and 7, can be used to model a non-linear forming filter, described as follows.

α₀\ddot{x}+α₁x²\dot{x}+α₂x³+α₃x(x\ddot{x}+\dot{x}²)+α₄\dot{x}+ω²x=ξ(t)

Where x is a coordinate, \dot{x} is a velocity, \ddot{x} is an acceleration, ξ(t) is white noise, αᵢ, i=0, . . . , 4 are model parameters. In one embodiment, α₀=0.01 α₁=0.5, α₂=0.0, and α₃=0.2, α₄=0.2.

FIG. 14 shows position, velocity, and acceleration results of non-gaussian colored stochastic process generation using a filter with algebraic loops. FIG. 15 shows position, velocity, and acceleration results of non-gaussian colored stochastic process generation using a filter without algebraic loops. FIG. 16 shows phase portraits of generated stochastic processes and the relation between outputs of different filters. FIG. 17 shows temporal complexity estimation of the stochastic process generation.

Although the present invention has been described with reference to a specific embodiment, other embodiments will occur to those skilled in the art. It is to be understood that the embodiment described above has been presented by way of example, and not limitation, and that the invention is defined by the appended claims.

What is claimed is:

1. An efficient method for numerical integration for use in simulation of non-linear differential equations with essential non-linearities including higher-order derivatives: comprising:
providing one or more input variables to a system of equations;
computing one or more outputs from said system of equations using said input variables;
integrating at least one selected output to produce an integrated output;
differentiating said integrated output to produce a reconstructed selected output; and
providing said reconstructed selected output as a next input to said system of equations.

2. A method for stochastic simulation of non-linear differential equations with non-linearities including higher order derivatives, comprising:
defining a system of non-linear differential equations having an algebraic loop wherein an output variable of at least one equation is also an input to said at least one equation, said output variable corresponding to an n-th derivative of a quantity represented by said output variable;
defining a simulation system that removes said algebraic loop by:
integrating said output variable to produce an integrated output variable, said integrated output variable corresponding to an (n−1)-th derivative of said quantity represented by said output variable;
providing said integrated output variable to an input of said at least one equation; and
differentiating said integrated output variable and providing an output of said integration to an input of said at least one equation; and
using an Euler-type method to numerically evaluate said simulation system.

3. The method of claim 2, further comprising: providing one or more inputs to a control system; computing a control output from said one or more inputs to said control system; and providing said control output to at least one onput of said system of equations.

4. The method of claim 2, further comprising: generating a control signal using a controller, said controller receiving input from a first information signal, said first information signal comprising at least one variable from said system of equations; computing an entropy from said information signal; computing a teaching signal using said entropy; teaching said controller using said teaching signal.

5. The method of claim 4, further comprising: using said teaching signal to train a neural network.

6. The method of claim 5, wherein said teaching signal is computed by a genetic analyzer.

7. The method of claim 6, wherein a fitness function of said genetic analyzer is based on said information signal.

8. The method of claim 6, wherein a fitness function of said genetic analyzer is configured to reduce an entropy of said first information signal.

9. The method of claim 5 wherein said neural network is a fuzzy neural network.

10. The method of claim 5, wherein said neural network is a fuzzy neural network trained by said teaching signal.

11. The method of claim 5, wherein computing said teaching signal comprises running a genetic analyzer having a fitness function that reduces an entropy of said system of equations.

12. A simulation system for simulating control of a plant described as a system of non-linear differential equations, comprising:
a plant simulation module configured to compute one more plant outputs from a system of equations based on one or more plant variables, wherein output variables from said system of equations that also appear as inputs to said system of equations are first integrated and then differentiated before being provided as inputs to said system of equations;
means for generating a teaching signal by computing said teaching signal to produce control that reduces an entropy of said plant;
means for generating a gain schedule as directed by said teaching signal; and
control means to generate a control signal using at least one of said plant variables and said gain schedule.

13. The control system of claim 12, wherein said means for generating a gain schedule comprises a genetic analyzer.

14. An apparatus for simulating control of a plant described as a system of non-linear differential equations, comprising:
a plant simulation module configured to compute one more plant outputs from a system of equations based on one or more plant variables, wherein output variables from said system of equations that also appear as inputs to said system of equations are first integrated and then differentiated before being provided as inputs to said system of equations; and
a multiplexer configured to provide said inputs to said system of equations according to a simulation algorithm.

15. The apparatus of claim 14, wherein said simulation algorithm is a first-order Euler algorithm.

16. The apparatus of claim 14, wherein said simulation algorithm is a Runge-Kutta algorithm.

17 The apparatus of claim 14, further comprising:
an analyzer for generating a teaching signal by computing said teaching signal to produce control that reduces an entropy of said plant;
a fuzzy logic classifier module for generating a gain schedule as directed by said teaching signal; and
a control module to generate a control signal using at least one of said plant variables and said gain schedule.

18. The control system of claim 17, wherein said means for generating a gain schedule comprises a genetic analyzer.

19. A self-organizing method for simulating control of a nonlinear plant described by one or more differential equations, comprising: obtaining a difference between a time differentiation (dSᵤ/dt) of the entropy of a plant and a time differentiation (dS_{c}/dt) of the entropy provided to the plant from a low-level controller that controls the plant; evolving a control rule by evolution in a genetic algorithm, said genetic algorithm using said difference as a fitness function; removing algebraic loops from said simulation by integrating outputs from said system of equations that also appear as inputs to said system of equations to produce integrated outputs, differentiating said integrated outputs to produce reconstructed inputs, providing said reconstructed inputs to said system of equations, simulating operating of said non-linear plant by computing new inputs for said system of equations from previous outputs of said system of equations according to the method of Euler or the Runge-Kutta method.

20. The method of claim 19, further comprising: analyzing one or more nonlinear operation characteristics of said physical plant by using a Lyapunov function; and correcting said control rule based on an evolution.

21. The method of claim 19, further comprising: evolving a control rule relative to a variable of said low-level controller by using a genetic algorithm, said genetic algorithm using fitness function that reduces a difference between a time differentiation of an entropy of said plant (dSᵤ/dt) and a time differentiation (dS_{c}/dt) of an entropy provided to said plant from said low-level controller; and correcting a variable of said low-level controller based on said evolved control rule.

22. A control apparatus adapted to control a non-linear plant, comprising: a simulator configured to use a system of non-linear differential equations to simulate operation of a non-linear plant according to the method of Euler, wherein outputs from said system of equations that also appear as inputs to said system of equations are first integrated and then differentiated before being provided as inputs to said system of equations; an entropy calculator that calculates an entropy production amount based on a difference between a time differentiation of entropy of said plant (dSᵤ/dt) and a time differentiation (dS_{c}/dt) of an entropy provided to said plant from a low-level controller that controls said plant; a genetic algorithm module that obtains an adaptation function in which said difference is minimized; and a fuzzy logic classifier configured to determine a fuzzy rule by using a learning process, said fuzzy logic controller configured to use an output from said genetic algorithm as a teaching signal, said fuzzy logic controller further configured to form a control rule that sets a variable gain of said controller by following said fuzzy rule.

23. The apparatus of claim 22, wherein said fuzzy logic classifier comprises: a fuzzy neural network configured to form a look-up table for said fuzzy rule by using said learning process; and a fuzzy controller configured to generating a variable gain schedule for said controller that controls said plant.

24. The apparatus of claim 22, wherein said low-level controller is a linear controller.

25. The apparatus of claim 22, wherein said low-level controller is a PID controller.

26. An apparatus for simulation of non-linear differential equations with non-linearities including higher order derivatives, comprising:
an equation module for computing a system of non-linear differential equations wherein an output variable of at least one equation is also an input to said at least one equation, said output variable corresponding to an n-th derivative of a quantity represented by said output variable;
an integrator module configured to integrate said output variable to produce an integrated output variable, said integrated output variable corresponding to an (n-1)-th derivative of said quantity represented by said output variable;
a differentiator module configured to differentiate said integrated output variable to reconstruct said output variable as a reconstructed output variable; and
a multiplexer configured to receive said integrated output vairable and said reconstructed output variable and to compute new inputs for said equation module according to a solution method.

27. The apparatus of claim 26, wherein said solution method is an Euler method.

28. The apparatus of claim 26, wherein said solution method is a Runge-Kutta method.

29. The apparatus of claim 26, wherein said system of non-linear differential equations describes a unicycle.

30. The apparatus of claim 26, wherein said system of non-linear differential equations comprises a simulation model of a unicycle.

31. The apparatus of claim 26, wherein said system of non-linear differential equations comprises a simulation model of a suspension system.

32. The apparatus of claim 26, wherein said system of non-linear differential equations comprises a simulation model of a suspension system in the presence of a stochastic road signal.
